(19) United States
(12) Patent Application Publication
(10) Pub. No.: US 2018/0097622 A1
(43) Pub. Date: Apr. 5, 2018

(54) DATA TRANSMISSION METHOD AND COMPUTER PROGRAM

(71) Applicant: Semiconductor Energy Laboratory Co., Ltd., Atsugi-si (JP)

(72) Inventor: Yoshiyuki KUROKAWA, Sagamihara (JP)

(73) Assignee: Semiconductor Energy Laboratory Co., Ltd.

(21) Appl. No.: 15/711,040

(22) Filed: Sep. 21, 2017

(30) Foreign Application Priority Data
Sep. 30, 2016 (JP) 2016-193839
Sep. 30, 2016 (JP) 2016-193843
Sep. 30, 2016 (JP) 2016-193849
Sep. 30, 2016 (JP) 2016-193850

(51) Int. Cl. H04L 9/08; H04L 5/00; H04W 4/00

(52) U.S. Cl. CPC H04L 9/0822; H04L 2001/125; H04W 4/003; H04L 5/0044

(57) ABSTRACT

Provided are a novel data transmission method and a novel computer program. A mobile terminal (the device 14a) includes the display unit 114 in which the liquid crystal layer 115 and the EL layer 116 are stacked with a reflective layer positioned therebetween. The device 14a transmits information of the device 14a, such as unique information, location information, and time information, to the server 11 when data (e.g., a virtual image) is requested. The server 11 encrypts data using an encryption key that is generated from the unique information of the device 14a, and then transmits it to the device 14a. The device 14a receives the encrypted data, and decrypts it using a decryption key generated from the unique information of the device 14a. The device 14a displays an image of decrypted data (a first image) using the liquid crystal layer 115, and displays an image of other data (a second image, e.g., an image of a real space) using the EL layer 116. Therefore, the device 14a can display a superimposed image of the first image and the second image. Other embodiments are also claimed.

### BACKGROUND OF THE INVENTION

### 1. Field of the Invention

An electronic device system and a method of driving the system, a method of using the system, a service using the system, and the like are disclosed.

### 2. Description of the Related Art

Data transmission and reception between mobile terminals and information providers through a computer network (hereinafter referred to as a network) such as the Internet are widely spread. A mobile terminal is provided with a camera, a liquid crystal (LC) display device, or an electroluminescent (EL) display device. The location information of the mobile terminal can be obtained by a global positioning system (GPS) or the like.

Examples of the information providers include news vendors, game operators, e-commerce merchants, Internet securities companies, and Internet banks. The information providers often provide their dedicated application software to mobile terminal users. The users install the application software on their mobile terminals, and thus can get information from the information providers.

These information providers need to charge, refund, or make remittance based on data provided to mobile terminal users or buying and selling between a provider and a user. Thus, it is necessary to prevent a third party from intercepting data when the data is transmitted and received. In general, even if a third party intercepts data, the data is encrypted and cannot be decoded.

For example, Patent Document 1 discloses a technology in which a public key (for encryption) is transmitted to an information provider while a decryption key (a private key) is concealed, and data encrypted by the information provider using the public key is obtained through a network and is decrypted using the private key.

Note that the concept of data transmission and reception through a network is sometimes different from the concept of wired communication or wireless communication in circuit switching, for example. In the circuit switching, a transmitter and a receiver make one-to-one connection; thus, it is a precondition that data is transmitted to a specific receiver, and reception is a passive action.

Through a network, however, one transmitter and one receiver are not necessarily linked, and there is no guarantee that data is surely delivered to a desired receiver. In addition, a receiver sometimes cannot receive data if the receiver does not actively attempt to obtain the data.

In the description of transmission and reception through a network, the expression used in the description of the conventional circuit switching is conventionally used. Thus, in the description of transmission and reception through a network, “data is transmitted to A” can be interpreted as “A is enabled to obtain data”. Similarly, “A receives data” can be interpreted as “A obtains data”.

### REFERENCE

### Patent Document

[Patent Document 1] U.S. Pat. No. 4,405,829

### SUMMARY OF THE INVENTION

A mobile terminal driving method that can inhibit data leakage and an electronic device system based on the driving method, a method of using the electronic device system, a service using the electronic device system, and the like are disclosed.

A data transmission method including a step of generating encrypted data using an encryption key that is generated using unique information of a mobile terminal and a step of transmitting the encrypted data to the mobile terminal is disclosed.

The data transmission method may include a step of generating a decryption key from the unique information and a step of decrypting the encrypted data using the decryption key in the mobile terminal to obtain first data. In the data transmission method, a user of the mobile terminal may be charged in accordance with the encrypted data.

A computer program including a step of making a mobile terminal generate a first encryption key and a first decryption key using the unique information of the mobile terminal, a step of making the mobile terminal transmit the unique information of the mobile terminal to a server, a step of making the mobile terminal receive first encrypted data, and a step of making the mobile terminal decrypt the first encrypted data using the first decryption key to generate first data is disclosed. The first encrypted data is encrypted using a second encryption key generated using the unique information in the server.

The above-described computer program may further include a step of making the mobile terminal generate second encrypted data using the first encryption key and a step of making the mobile terminal transmit the second encrypted data to the server. The second encrypted data may be decrypted in the server, using a second decryption key generated using the unique information.

A data transmission method including a step of generating encrypted data using an encryption key that is generated using location information of a mobile terminal and a step of transmitting the encrypted data to the mobile terminal is disclosed.

The data transmission method may further include a step of generating a decryption key from the location information and a step of decrypting the encrypted data using the decryption key in the mobile terminal to obtain first data. In the data transmission method, a user of the mobile terminal may be charged in accordance with the encrypted data.

A computer program including a step of making a mobile terminal generate a first encryption key and a first decryption key using the location information of the mobile terminal, a step of making the mobile terminal transmit the location information of the mobile terminal to a server, a step of making the mobile terminal receive first encrypted data, and a step of making the mobile terminal decrypt the first encrypted data using the first decryption key to generate first data. The first encrypted data is encrypted using a second encryption key generated using the location information in the server is disclosed.

The above-described computer program may further include a step of making the mobile terminal generate second encrypted data using the first encryption key and a step of making the mobile terminal transmit the second encrypted data to the server. The second encrypted data may be decrypted in the server, using a second decryption key generated using the location information.

A data transmission method including a step of generating encrypted data using an encryption key that is generated using time information obtained by a server and a step of transmitting the encrypted data to a mobile terminal is disclosed.

The data transmission method may include a step of generating a decryption key from second time information obtained by a mobile terminal and a step of decrypting the encrypted data using the decryption key in the mobile terminal to obtain first data. In the data transmission method, a user of the mobile terminal may be charged in accordance with the encrypted data.

A computer program executing a step of making a mobile terminal generate a first encryption key and a first decryption key using time information obtained by the mobile terminal, a step of making the mobile terminal receive first encrypted data, and a step of making the mobile terminal decrypt the first encrypted data using the first decryption key to generate first data is disclosed. The first encrypted data is encrypted in a server, using a second encryption key generated using second time information obtained by the server is disclosed.

The above-described computer program may further execute a step of making the mobile terminal generate second encrypted data using the first encryption key and a step of making the mobile terminal transmit the second encrypted data to the server. The second encrypted data may be decrypted in the server, using a second decryption key generated using the second time information.

In the above-described data transmission method or the above-described computer program, the mobile terminal has a stacked structure of two or more display layers. In a first period, the first data may be displayed using one of the display layers and the second data (the second data is different from the first data) may be displayed using the other or another of the display layers. Here, the encrypted data (or data accompanying the encrypted data) may include a code that specifies which of the display layers displays the first data.

In the above data transmission method or the above computer program, the mobile terminal may include a controller, a register unit, a memory, and an image processing unit; the memory may be configured to store image data; the image processing unit may be configured to process the image data; the register unit may be configured to store a parameter for processing in the image processing unit; the memory may be configured to retain the image data while power supply to the memory is stopped; the register unit may be configured to retain the parameter while power supply to the register unit is stopped; and the controller may be configured to control power supply to the register unit, the memory, and the image processing unit.

A data transmission method including: a step of receiving an encryption key; a step of generating encrypted data using the encryption key; and a step of transmitting the encrypted data to a mobile terminal is disclosed. In the data transmission method, the mobile terminal includes a stacked structure of two or more display layers, first data is displayed using one of the display layers in a first period, second data is displayed using the other or another of the display layers in the first period, and the first data is generated in such a manner that the encrypted data is decrypted in the mobile terminal, and is different from the second data.

In the above-described data transmission method, the encryption key may reflect the unique information of the mobile terminal. The above-described data transmission method may further include a step of generating a decryption key and a step of decrypting the encrypted data using the decryption key in the mobile terminal. In the above data transmission method, a user of the mobile terminal may be charged in accordance with the encrypted data. In the above data transmission method, the encrypted data or data accompanying the encrypted data may include a code that specifies which of the display layers displays the first data.

A computer program executing a step of making a mobile terminal generate a first encryption key and a first decryption key, a step of making the mobile terminal transmit the first encryption key, a step of making the mobile terminal receive first encrypted data, and a step of making the mobile terminal decrypt the first encrypted data using the first decryption key to generate first data is disclosed. In the computer program, the first encrypted data is encrypted using the first encryption key in a server, the mobile terminal includes a stacked structure of two or more display layers, first data is displayed using one of the display layers in a first period, second data is displayed using the other or another of the display layers in the first period, and the first data is different from the second data.

The above-described computer program may further execute a step of making the mobile terminal receive a second encryption key, a step of making the mobile terminal generate second encrypted data using the second encryption key, and a step of making the mobile terminal transmit the second encrypted data to the server. The second encrypted data may be decrypted in the server, using a second decryption key generated by the server.

In the above computer program, the first encryption key and the first decryption key may reflect unique information of the mobile terminal. The mobile terminal may further execute a step of generating a random number, a step of generating a new first encryption key and a new second decryption key which reflect the random number and the unique information, a step of encrypting the new first encryption key using the new second encryption key to generate third encrypted data, a step of transmitting the third encrypted data, a step of receiving fourth encrypted data, and a step of decrypting the fourth encrypted data using the new second decryption key. The fourth encrypted data is generated in the server, using the new first encryption key.

In the above computer program, the first encrypted data or data accompanying the first encrypted data may include a code that specifies which of the display layers displays the first data.

In the above data transmission method or the above computer program, the mobile terminal may include a controller, a register unit, a memory, and an image processing unit; the memory may be configured to store image data; the image processing unit may be configured to process the image data; the register unit may be configured to store a parameter for processing in the image processing unit; the memory may be configured to retain the image data while power supply to the memory is stopped; the register unit may be configured to retain the parameter while power supply to the register unit is stopped; and the controller may be configured to control power supply to the register unit, the memory, and the image processing unit.

According to the above, data is encrypted using an encryption key generated from unique information of a mobile terminal, and is decrypted using a decryption key generated from the unique information of the mobile terminal. Thus, if the unique information of the mobile terminal cannot be obtained, the data cannot be decoded. Therefore, even if a third party intercepts the data, the possibility that the data is decoded is sufficiently low.

According to the above, data is encrypted using an encryption key generated from location information of a mobile terminal, and is decrypted using a decryption key generated from the location information of the mobile terminal. Thus, if the location information of the mobile terminal cannot be obtained, the data cannot be decoded. Therefore, even if a third party intercepts the data, the possibility that the data is used in a place where the data should not be used is sufficiently low.

According to the above, data is encrypted using an encryption key generated from time information, and is decrypted using a decryption key generated from the time information. Thus, the data cannot be decrypted in a time other than a predetermined time. Therefore, the possibility that the data is used in a time when the data should not be used is sufficiently low.

According to the above, encrypted data can be transmitted and received between a server and a mobile terminal that includes a stacked structure of two or more display layers. In addition, the mobile terminal can display a superimposed image of a first image and a second image. For the other effects, the following description can be referred to.

### BRIEF DESCRIPTION OF THE DRAWINGS

FIG. 1A shows an example of a block diagram of an electronic device system and FIG. 1B shows a procedure for using application software.

FIG. 2 shows an example of a flowchart of data transmission from a server and data reception by a user.

FIG. 3 shows an example of a flowchart of user login.

FIG. 4A shows an example of a system in which a server transmits data and

FIG. 4B shows an example of system in which a user receives data.

FIG. 5A shows an example of a system in which a user transmits data and FIG. 5B shows an example of a system in which a server receives data.

FIG. 6 shows an example of a flowchart of updating of an encryption key.

FIG. 7 shows an example of a flowchart of data transmission from a server and data reception by a user.

FIG. 8 shows an example of a flowchart of updating of an encryption key.

FIG. 9 shows an example of a block diagram of a mobile terminal.

FIG. 10 shows an example of a block diagram of a mobile terminal.

FIG. 11 shows an example of a block diagram of a mobile terminal.

FIGS. 12A and 12B show an example of a register unit.

FIG. 13 shows an operation example of a register unit.

FIGS. 14A to 14C each show an example of a mobile terminal.

FIG. 15 shows an example of a flowchart of data transmission from a server and data reception by a user.

FIG. 16 shows an example of a flowchart of data transmission from a server and data reception by a user.

FIG. 17 shows an example of a flowchart of data transmission from a server and data reception by a user.

FIGS. 18A to 18D are schematic diagrams and a state transition diagram showing a structure example of a display device.

FIGS. 19A to 19C are a circuit diagram and timing charts showing a structure example of a display device.

FIG. 20 is a perspective view showing an example of a display device.

FIG. 21 is a cross-sectional view showing an example of a display device.

FIG. 22 is a cross-sectional view showing an example of a display device.

FIG. 23 is a cross-sectional view showing an example of a display device.

### DETAILED DESCRIPTION OF THE INVENTION

Embodiments will be described below with reference to drawings. However, the embodiments can be implemented in many different modes, and it will be readily appreciated by those skilled in the art that modes and details thereof can be changed in various ways without departing from the spirit and scope of the present invention. Thus, the present invention should not be interpreted as being limited to the following description of the embodiments. Furthermore, a technology described in one embodiment can be applied to any of the other embodiments as appropriate.

Note that in the structures of the invention described below, the same portions or portions having similar functions are denoted by the same reference numerals in different drawings, and description of such portions is not repeated. Furthermore, the same hatch pattern is applied to similar functions, and these are not denoted by particular reference numerals in some cases.

Note that in the drawings used in this specification, the thicknesses of films, layers, and substrates, the sizes of regions, and the like are exaggerated for simplicity in some cases. Therefore, the sizes of the components are not limited to the sizes in the drawings and relative sizes between the components.

Note that the ordinal numbers such as “first” and “second” in this specification and the like are used for convenience and do not denote the order of steps, the stacking order of layers, or the like. Therefore, for example, description can be made even when “first” is replaced with “second” or “third”, as appropriate. In addition, the ordinal numbers in this specification and the like are not necessarily the same as those which specify one embodiment of the present invention.

In this specification and the like, hybrid display (hybrid mode) is a method for displaying a letter and/or an image using reflected light and self-emitted light together in one panel that complement the color tone or light intensity of each other. Alternatively, hybrid display is a method for displaying a letter and/or an image using light from a plurality of display elements in one pixel or one subpixel. Note that when a hybrid display performing hybrid display is locally observed, a pixel or a subpixel performing display using any one of the plurality of display elements and a pixel or a subpixel performing display using two or more of the plurality of display elements are included in some cases. In this specification and the like, hybrid display satisfies any one or a plurality of the above-described descriptions.

Furthermore, a hybrid display includes a plurality of display elements in one pixel or one subpixel. Note that as an example of the plurality of display elements, a reflective element that reflects light and a self-luminous element that emits light can be given. Note that the reflective element and the self-luminous element can be controlled independently. The hybrid display has a function of displaying a letter and/or an image using one or both of reflected light and self-emitted light in a display portion.

### Embodiment 1

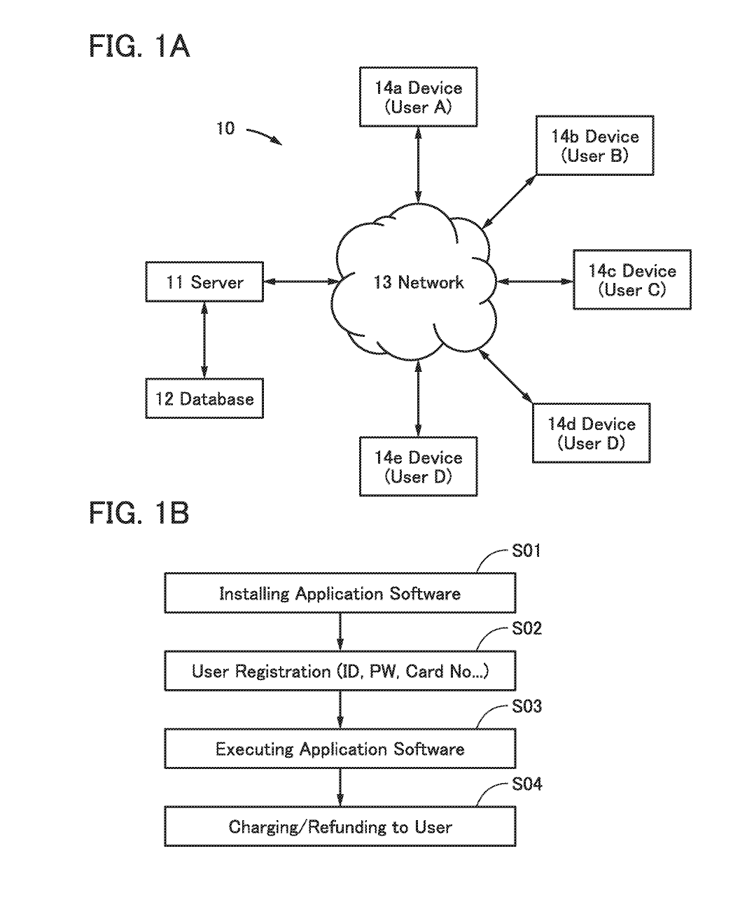

FIG. 1A shows a structure of an electronic device system described in this embodiment. In an electronic device system 10, a server 11 is connected to mobile terminals (devices 14a to 14e) of a plurality of users (users A to D in FIG. 1A) through a network 13. Note that the user D has the device 14d and the device 14e.

The server 11 is operated by an information provider, and receives necessary data from a database 12. In the database, data necessary for executing application software is stored, for example. Furthermore, although not shown, the server 11 receives data from another provider through the network 13 and provides the data to a user in some cases. The details of the devices 14a to 14e are described in Embodiment 5.

FIG. 1B shows a procedure for using application software. A user installs application software provided by an information provider on the user's mobile terminal (device) (a step S01 of installing) before receiving data from the server 11.

Furthermore, the user provides information that identifies the user to the information provider in order to use the application software. The information provider determines whether the provided information is proper, and when the information satisfies the requirements, the user is registered (a step S02 of user registration). By the registration, an ID and a password which are necessary for login are determined.

The user discloses, for example, the user's credit card number to the information provider for this registration. Credit card numbers and passwords are information that should not be known by third parties. Accordingly, these are encrypted and transmitted to the server 11.

Then, the user executes the application software (a step S03 of executing application software). As a result of application software execution, the user receives data from the information provider, purchases a virtual item that is necessary for a game, buys goods on a shopping website, sells disused articles on an auction site, trades securities, makes remittance to a bank, or receives payment. As a result of such an action, the information provider charges or refunds to the user (a step S04 of charging/refunding).

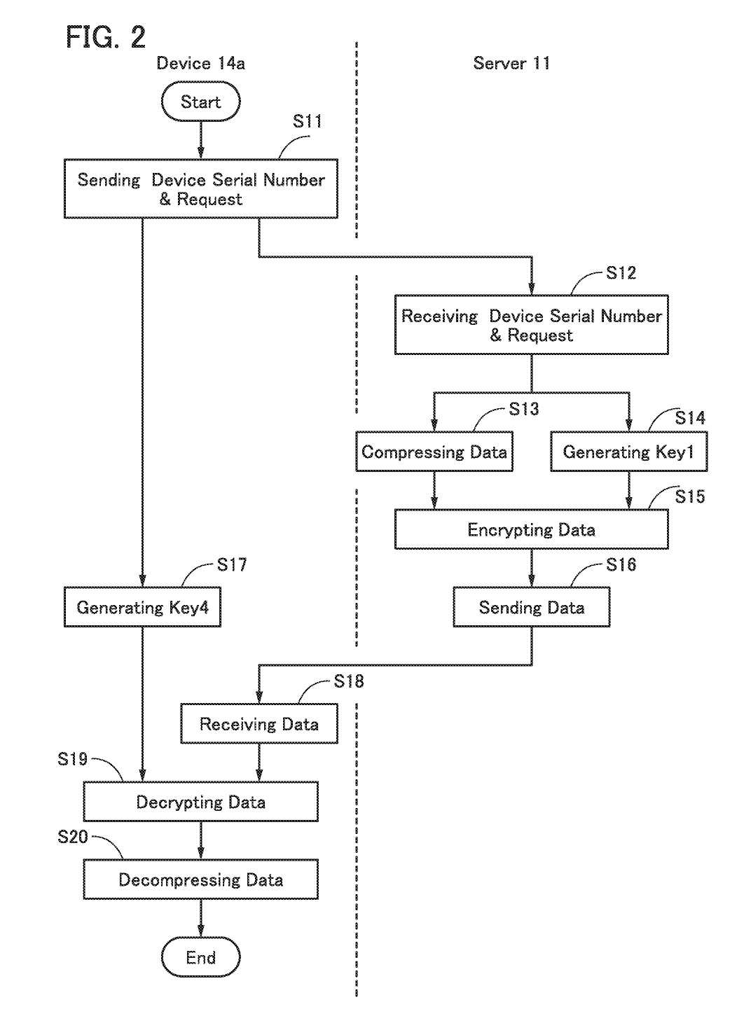

The data is provided by the information provider to the user through the network 13, and thus needs to be encrypted in order not to be decoded by third parties. A procedure in which a user's device (the device 14a in the following example) receives data from the server 11 is described with reference to FIG. 2.

First, the device 14a transmits its serial number (e.g., a manufacturing number or an individual identification number) and a data request to the server 11 (a step S11 of transmitting a serial number). The serial number is an example of information that identifies the device 14a (unique information). Instead of the serial number, other information that identifies the device 14a may be used. In addition to or instead of the serial number, other information may be transmitted. For example, other information may be the location information and the serial number of the device 14a.

For example, other information may be a random number generated by the device 14a at a certain time (for example, the time when the application software is installed). This random number may be stored in the device 14a, for example. Alternatively, the random number may be erased after an encryption key Key3 and a decryption key Key4, which are described later, are generated because it becomes unnecessary after the generation of the encryption key Key3 and the decryption key Key4.

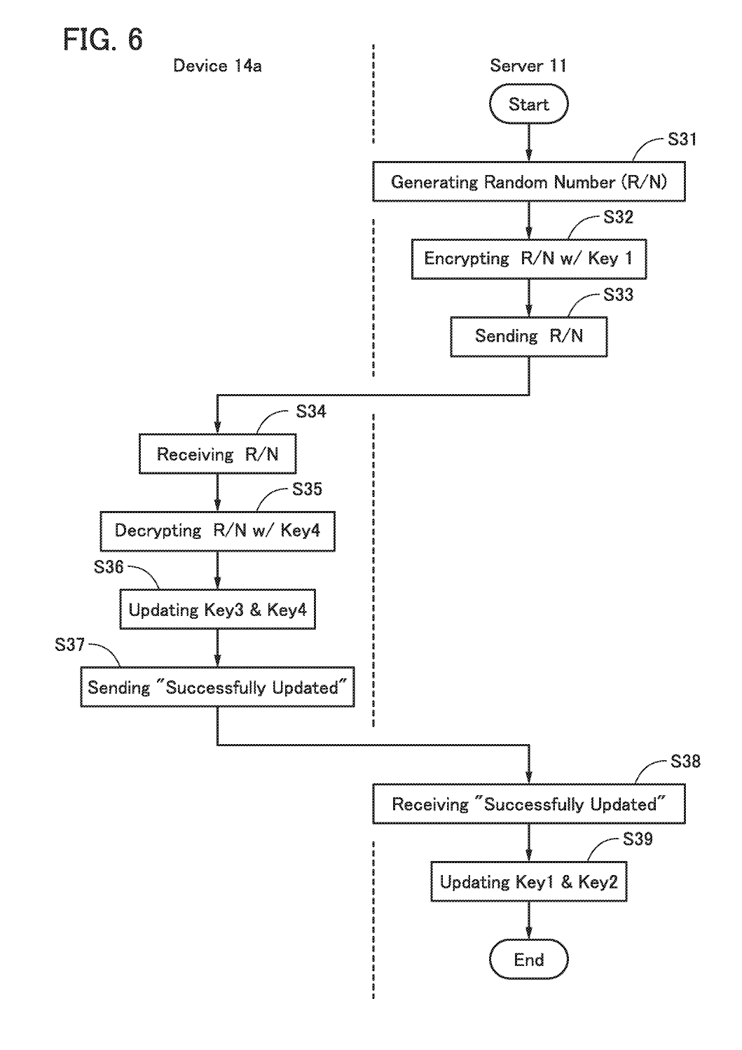

The server 11 receives the serial number through the network 13 (a step S12 of receiving a serial number). The server 11 compresses data to be transmitted to the device 14a (a step S13 of compressing data). The data may be a random number (see a step S31 of generating a random number in FIG. 6) described in Embodiment 2. Before or after this step, or in parallel with this step, the server 11 generates an encryption key Key1 using the serial number (a step S14 of generating an encryption key).

Data encrypted using the encryption key Key1 needs to be decrypted using the decryption key Key4 generated by the device 14a. The decryption key Key4 is generated by the application software installed on the device 14a, and thus, the encryption key Key1 generated by the server needs to correspond to the application software.

Next, the server 11 encrypts data using the compressed data and the encryption key Key1 (a step S15 of encrypting data). Note that encryption is not necessarily performed on the whole data; for example, when compressed data is encrypted, only part (header) of the data which defines the compression format (e.g., a compression method such as tile division) may be encrypted.

In that case, only part of data is encrypted, which can reduce a load on arithmetic processing for encryption. Even through the other part of data remains plain text, if the header is not decrypted, how the data is compressed cannot be determined, which provides substantially the same effect as the effect obtained by encrypting the whole data.

The server 11 transmits the encrypted data through the network 13 (a step S16 of transmitting data).

On the other hand, the device 14a generates the decryption key Key4 using the serial number (a step S17 of generating a decryption key). Here, the decryption key Key4 is required to decrypt data that has been encrypted using the encryption key Key1 generated by the server 11. The application software specifies an algorithm and other conditions for generating a decryption key, so that the decryption key Key4 can be generated uniquely from the serial number.

The device 14a receives the encrypted and compressed data through the network 13 (a step S18 of receiving data), decrypts the data using the decryption key Key4 (a step S19 of decrypting data), and executes decompression (a step S20 of decompressing data). Through these steps, data can be obtained from the server 11.

The application software is publicly available to third parties; accordingly, it is possible that a third party obtains and analyzes the application software to find an encryption method. However, since the encryption key Key1 and the decryption key Key4 are generated using the serial number of the device, it is impossible to generate the decryption key Key4 if the serial number of a specific device is not known. Therefore, even when a third party who does not know the serial number of a device intercepts data transmitted to only the device of the specific user, it is practically impossible for the third party to decrypt the data.

Although FIG. 2 shows a procedure in which the server 11 transmits data and the device 14a receives the data, encryption may be performed in a similar manner when the device 14a transmits data and the server 11 receives the data. At this time, the application software generates the encryption key Key3 for transmitting data to the server 11, using information that identifies the device 14a (e.g., the serial number of the device). Furthermore, the server generates a decryption key Key2 using the information that identifies the device 14a.

The device 14a encrypts data to be transmitted to the server 11 using the encryption key Key3 generated by the application software. The server 11 decrypts the data transmitted by the device 14a using the decryption key Key2. Here, the data transmitted by the device 14a is encrypted using, for example, the encryption key Key3 generated using the serial number of the device 14a; accordingly, the decryption key Key2 also needs to be generated using the serial number of the device 14a. Since the server 11 receives the serial number of the device 14a in the step S12 of receiving a serial number in FIG. 2, this serial number is used for the generation of the decryption key Key2.

Therefore, even when a third party who does not know the serial number of a device intercepts data transmitted from the device of the specific user, it is practically impossible for the third party to decrypt the data, in a manner similar to that in the case where the server 11 transmits data.

Note that the application software may generate the encryption key Key3 and the decryption key Key4, using a numerical value prepared for the application software (or data accompanying it) or the like, in addition to the information that identifies the device. A plurality of algorithms for generating the encryption key Key3 and the decryption key Key4 may be prepared and one algorithm may be selected from them. As an example of the data accompanying the software, a number sequence that is added to (or inserted into) a numerical sequence of the serial number of the device is prepared.

The generation of the encryption key Key1, the decryption key Key2, the encryption key Key3, and the decryption key Key4 is not necessarily conducted for each data transmission and data reception. For example, keys generated in advance may be stored in the server 11, and when data is transmitted or received, the encryption key Key1 and the decryption key Key2 for a device of each user may be searched for and used.

In the above example, the encryption key Key1 and the decryption key Key2 are generated using the serial number of the mobile terminal. Therefore, the encryption key Key1 and the decryption key Key2 inevitably differ from mobile terminal to mobile terminal.

The server 11 (or the database 12) stores in advance the encryption keys Key1 for transmitting data to individual users and the decryption keys Key2 for decrypting data transmitted by the users, for example, by the mechanism of a lookup table.

For example, the server 11 may obtain the serial number of a user's mobile terminal in the step of installing application software (the step S01 of installing in FIG. 1B) or the step of user registration (the step S02 of user registration in FIG. 1B), may use the serial number to generate the encryption key Key1 for transmitting data to a user and the decryption key Key2 for decrypting data transmitted by the user, and may store these keys.

Similarly, at the step of installing the application software, the user's device may generate, using its serial number, the encryption key Key3 for transmitting data to the server 11 and the decryption key Key4 for decrypting data transmitted by the server 11 and may store these keys.

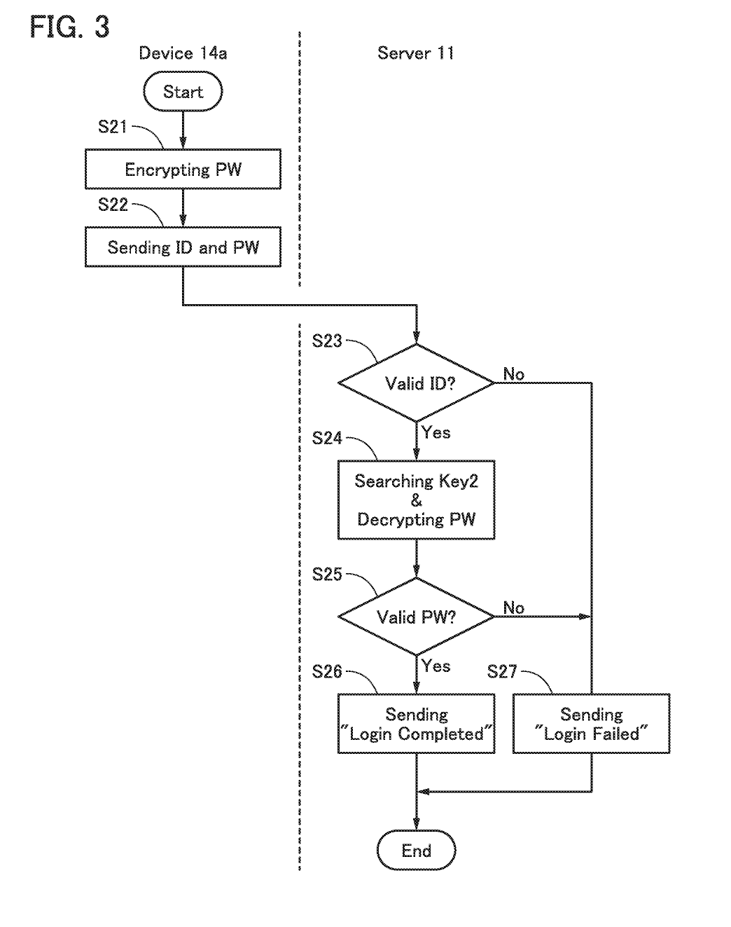

A procedure in which a user uses the application software is described with reference to FIG. 3. First, the user enters a password into the device 14a. The device 14a encrypts the password using the encryption key Key3 (a step S21 of encrypting PW), and transmits the ID and the password to the server 11 (a step S22 of transmitting ID/PW). In this process, for example, the ID is transmitted to the server 11 without being encrypted.

The server 11 first determines whether the ID is valid (a step S23 of verifying an ID). If the ID is not registered, the server 11 transmits notice “login failed” to the device 14a (a step S27 of transmitting notice of “login failed”).

When the ID is valid, the server 11 searches for the decryption key Key2 that corresponds to the ID, and decrypts the password using the decryption key Key2 (a step S24 of searching for a decryption key and decrypting PW). Note that in this step, the encryption key Key1 for transmitting data to the device 14a may be searched for.

Next, the server 11 determines whether the password corresponds to the ID (a step S25 of verifying PW). When the password corresponds to the ID, the server 11 transmits notice “login completed” to the device 14a (a step S26 of transmitting notice of “login completed”). If the password does not correspond to the ID, the server 11 transmits notice “login failed” to the device 14a (the step S27 of transmitting notice of “login failed”).

A reason why the password does not correspond to the ID is that an incorrect password is entered; however, even when a correct password is entered, if the encryption key Key3 in the device is not correct, the server 11 cannot decrypt the password properly. As a result, the server 11 determines that the password does not correspond to the ID. For example, when a third party transmits an ID and a password with a device different from a device of a rightful user, the third party fails to log in. In this manner, unauthorized login can be prevented.

In addition, even without malice, a user like the user D who has a plurality of devices (the device 14d and the device 14e) cannot log in with an unregistered device.

In the case where the password is determined to correspond to the ID, after the determination, data transmitted by the server 11 and data transmitted by the device 14a (which include accompanying data that is necessary to use application software) are encrypted using the respective encryption keys (Key 1 and Key3). Data received by the server 11 and data received by the device 14a are decrypted using the respective decryption keys (Key2 and Key4). Data cannot be substantially decoded when the serial number of the device 14a is not known, so that data can be transmitted and received in a highly secure environment.

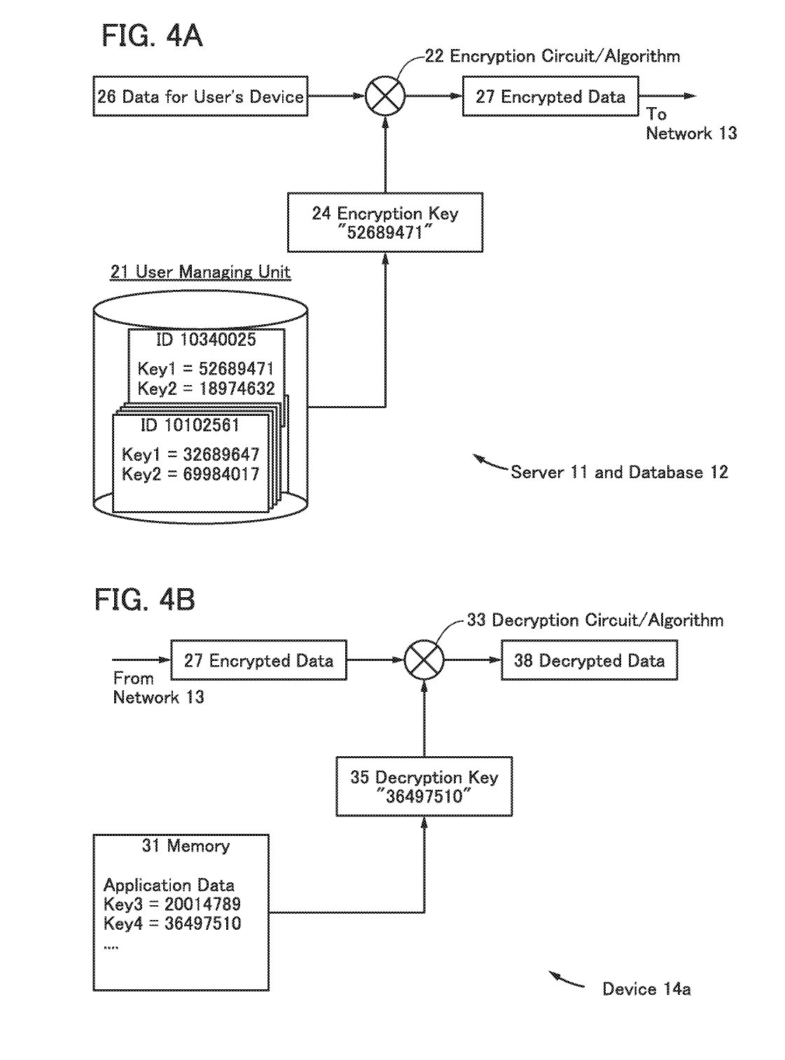

FIG. 4A illustrates a system in which the server 11 encrypts data and transmits it to the device 14a. The server 11 (or the database 12) includes a user managing unit 21. In the user managing unit 21, IDs of registered users and encryption keys Key1 and decryption keys Key2 which correspond to the IDs are stored.

For example, when the device 14a of a user whose ID is 10340025 requests data, the server 11 can call the encryption key Key1 (here, 52689471) and the decryption key Key2 (18974632), which correspond to the ID 10340025, from the user managing unit 21.

Data 26 to be transmitted to the user is encrypted using an encryption key 24 (52689471) by an encryption circuit 22 (or an encryption algorithm) to become encrypted data 27, which is transmitted to the network 13.

FIG. 4B shows a system in which data that the device 14a receives from the server 11 is decrypted. In a memory 31 of the device 14a, the encryption key Key3 (here, 20014789) and the decryption key Key4 (here, 36497510), which are generated using the unique information (e.g., a serial number) of the device by the application software, are stored in addition to data (application data) for executing the application software.

For example, when receiving the encrypted data 27 through the network 13, the device 14a decrypts the encrypted data 27 using a decryption key Key35 (36497510) in a decryption circuit 33 (or a decryption algorithm) and thus obtains decrypted data 38.

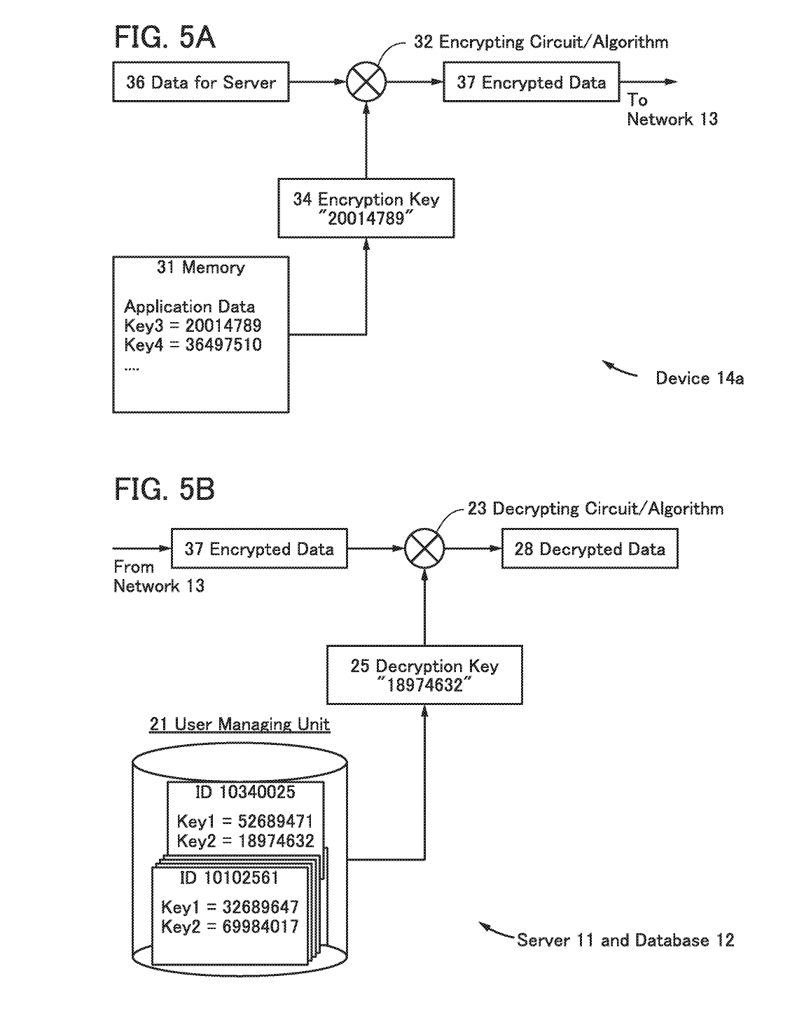

FIG. 5A illustrates a system in which the device 14a encrypts data and transmits it to the server 11. In the device 14a, data 36 to be transmitted to the server 11 is encrypted in an encryption circuit 32 (or an encryption algorithm) using an encryption key Key34 (20014789) stored in the memory 31 to generate encrypted data 37, and the device 14a transmits it to the network 13.

FIG. 5B shows a system in which data that the server 11 receives from the device 14a is decrypted. The server 11 can call the decryption key Key2 (18974632) with reference to the user's ID (Ser. No. 10/340,025).

The encrypted data 37 that is received by the server 11 through the network 13 is decrypted using a decryption key Key25 (18974632) by a decryption circuit 23 (or a decryption algorithm), so that decrypted data 28 can be obtained.

### Embodiment 2

According to the method described in Embodiment 1, a user's device transmits the unique information such as a serial number of the user's device. Since the unique information is transmitted through the network 13, it is necessary to protect the information from being known by a third party. For example, the unique information may be encrypted through commonly used cryptographic technology (e.g., Transport Layer Security (TLS)).

However, there is no guarantee that the commonly used cryptographic technology does not have vulnerability. Even in the case where transmission is performed through TSL, there is a possibility that unique information is decoded and as a result, an encryption key and a decryption key are obtained by a third party. To prevent this, it is preferable to update the encryption key and the decryption key periodically. In general, it takes quite a while to decode encrypted data; accordingly, the encryption key and the decryption key are preferably updated at an interval shorter than the time assumed to be needed for the decoding.

Specifically, in the step of installing application software, the device 14a generates the encryption key Key3 and the decryption key Key4. At almost the same time, the server 11 generates the encryption key Key1 and the decryption key Key2. After that, user registration is performed, and then updating of the encryption key Key1, the decryption key Key2, the encryption key Key3, and the decryption key Key4 is performed on the basis of a procedure shown in FIG. 6.

First, the server 11 generates a random number (the step S31 of generating a random number), encrypts the random number using the encryption key Key1 that is not updated (a step S32 of encrypting a random number), and transmits the encrypted random number (a step S33 of transmitting a random number).

The device 14a receives the encrypted random number (a step S34 of receiving a random number), and decrypts it using the decryption key Key4 that is not updated (a step S35 of decrypting a random number). Then, the device 14a adds the random number to the serial number of the device 14a in a predetermined manner. For example, the decrypted random number is added to the end or beginning of the serial number. Alternatively, the decrypted random number is inserted between specific digits of the serial number (e.g., between the fifth and sixth digits from the beginning).

With use of a numerical sequence obtained in this manner, a new encryption key Key3 and a new decryption key Key4 are generated (a step S36 of updating encryption and decryption keys). Then, the device 14a transmits notice “successfully updated” to the server 11 (a step S37 of transmitting notice of “successfully updated”). This notice may be transmitted in plain text.

When the server 11 receives the notice “successfully updated” (a step S38 of receiving notice of “successfully updated”), the server 11 adds a random number to the serial number of the device 14a in a predetermined manner (which differs from the manner used in the device 14a in many cases) to generate a new encryption key Key1 and a new decryption key Key2 (a step S39 of updating encryption and decryption keys). Note that the step S39 of updating encryption and decryption keys may be performed before the server 11 receives the notice “successfully updated”.

After that, the server 11 may transmit notice “successfully updated” to the device 14a. After the updating of the encryption key Key1, the decryption key Key2, the encryption key Key3, and the decryption key Key4, data is transmitted and received between the server 11 and the device 14a using the encryption key Key1, the decryption key Key2, the encryption key Key3, and the decryption key Key4 which are updated.

Although FIG. 6 shows the example in which the server 11 generates a random number and encrypts and transmits it to the device 14a, the device 14a may generate a random number and encrypt and transmit it to the server 11. Furthermore, the updating shown in FIG. 6 may be performed while a user connects to the network (a user logs in), at a certain interval (e.g., at an interval of 10 minutes).

It is quite possible that a user does not log in for a long period of time. In that case, when transmission and reception of the random number as shown in FIG. 6 cannot be performed between the server 11 and the device 14a, updating of the encryption key Key1, the decryption key Key2, the encryption key Key3, and the decryption key Key4 cannot also be performed. The longer time passes from the last login, the higher the possibility that a third party obtains the encryption key Key1, the decryption key Key2, the encryption key Key3, and the decryption key Key4 on the basis of communication record becomes.

For this reason, in the case where a user connects to the network 13 even if the user does not log in, application program may make a mobile terminal execute updating shown in FIG. 6 in the background.

As another solving means, the encryption key Key1, the decryption key Key2, the encryption key Key3, and the decryption key Key4 may be generated again from the beginning in the case where a certain time has passed from the last updating of the encryption key Key1, the decryption key Key2, the encryption key Key3, and the decryption key Key4. In that case, for example, use of the serial number of the device 14a has a problem; accordingly, the application software (or the server 11) makes the device 14a generate a random number and the random number is used as unique information that identifies the device 14a. The steps after this are similar to those shown in FIG. 2. Note that the serial number in FIG. 2 should be replaced with the random number generated by the device 14a.

### Embodiment 3

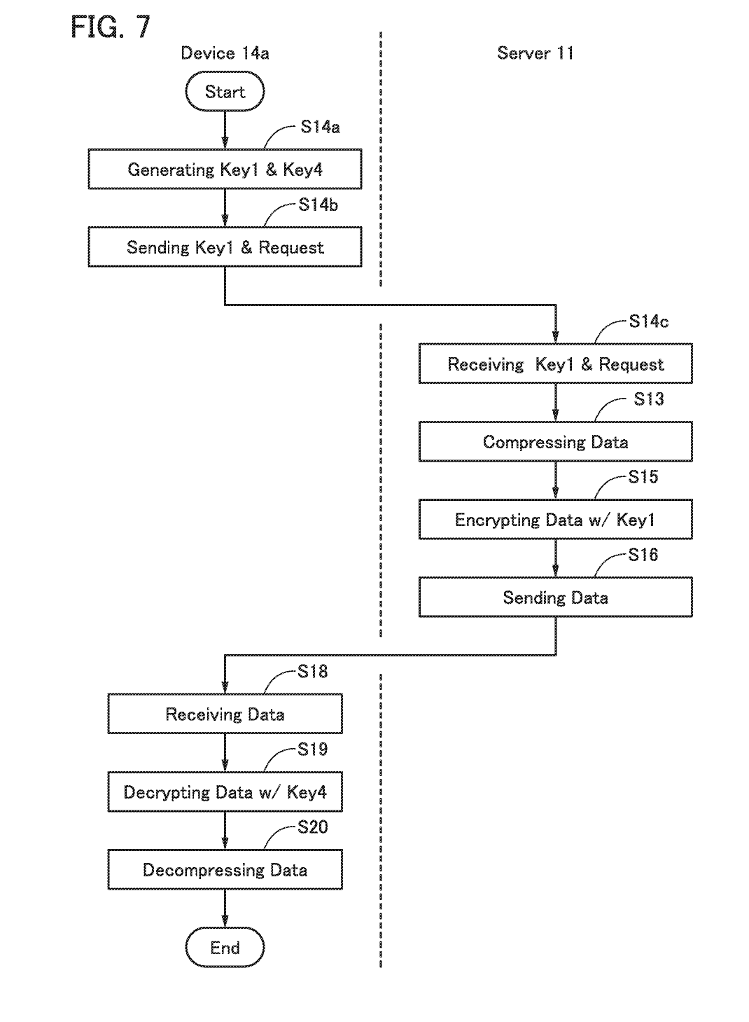

In this embodiment, another example of encryption and decryption is described with reference to FIG. 7. Embodiment 1 may be referred to, as appropriate.

First, when application software is executed, the device 14a generates the encryption key Key1 and the decryption key Key4 (a step S14a of generating an encryption key and a decryption key). As described later, data encrypted using the encryption key Key1 needs to be decrypted using the decryption key Key4. The encryption key Key1 and the decryption key Key4 are not the same.

For example, the serial number of the device 14a (e.g., a manufacturing number or an individual identification number) may be used for the generation of the encryption key Key1 and the decryption key Key4. The serial number is an example of information that identifies the device 14a (unique information). Instead of the serial number, other information that identifies the device 14a may be used.

For example, other information may be a random number generated by the device 14a at a certain time (for example, the time when the application software is installed). After that, this random number may be stored in the device 14a, for example. Alternatively, the random number may be erased after the generation of the encryption key Key1 and the decryption key Key4 because it becomes unnecessary.

Next, the device 14a transmits the encryption key Key1 and data request to the server 11 (a step S14b of transmitting an encryption key and a request). On the other hand, the device 14a conceals the decryption key Key4. That is, the decryption key Key4 is a private key. Therefore, the server 11 can generate encrypted data using the encryption key Key1, but cannot decrypt the encrypted data because the decryption key Key4 is concealed. Note that although being transmitted to the server 11, the encryption key Key1 is not a public key in a strict sense because it is not open to many and unspecified third parties.

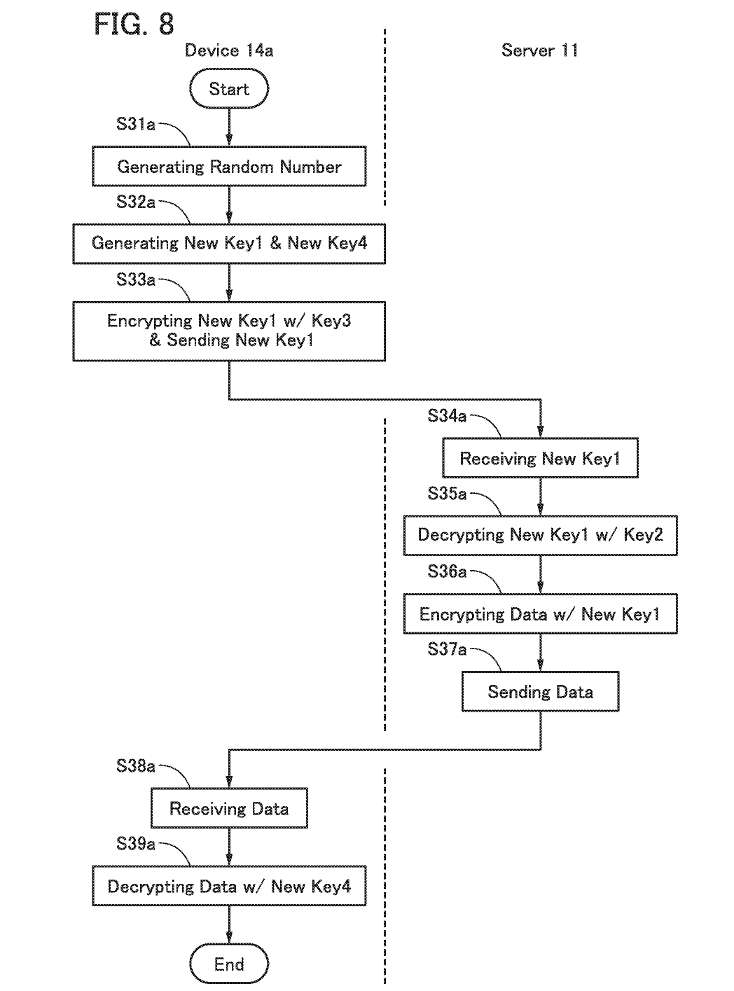

The server 11 receives the encryption key Key1 and the data request through the network 13 (a step S14c of receiving an encryption key and a request). The server 11 compresses data to be transmitted to the device 14a (the step S13 of compressing data). The data may be a random number (see a step S31a of generating a random number in FIG. 8) described in Embodiment 4.

Next, the server 11 encrypts data using the compressed data and the encryption key Key1 (the step S15 of encrypting data). Note that encryption is not necessarily performed on the whole data; for example, when compressed data is encrypted, only part (header) of the data which defines the compression format (e.g., a compression method such as tile division) may be encrypted.

In that case, only part of data is encrypted, which can reduce a load on arithmetic processing for encryption. Even through the other part of data remains plain text, if the header is not decrypted, how the data is compressed cannot be determined, which provides substantially the same effect as the effect obtained by encrypting the whole data.

The server 11 transmits the encrypted data through the network 13 (the step S16 of transmitting data).

The device 14a receives the encrypted and compressed data through the network 13 (the step S18 of receiving data), decrypts the data using the decryption key Key4 (the step S19 of decrypting data), and executes decompression (the step S20 of decompressing data). Through these steps, data can be obtained from the server 11.

Although FIG. 7 shows a procedure in which the server 11 transmits data and the device 14a receives the data, encryption may be performed in a similar manner when the device 14a transmits data and the server 11 receives the data. In that case, the server 11 generates the encryption key Key3 for transmitting data by the device 14a to the server 11 and the decryption key Key2 and transmits the encryption key Key3 to the device 14a. The encryption key Key3 and the decryption key Key2 are not the same.

In that case, for example, the encryption key Key3 and the decryption key Key2 may be generated using a character string of the encryption key Key1 or the like. Data encrypted using the encryption key Key3 needs to be decrypted using the decryption key Key2. The encryption key Key3 is open to the device 14a. In contrast, the decryption key Key2 is concealed by the server 11. Therefore, the device 14a can generate encrypted data using the encryption key Key3, but cannot decrypt the encrypted data because the decryption key Key2 is concealed.

The device 14a encrypts data to be transmitted to the server 11 using the encryption key Key3 transmitted by the server 11. The server 11 decrypts the data transmitted by the device 14a using the decryption key Key2.

Note that the application software may generate the encryption key Key1 and the decryption key Key4, using a numerical value prepared for the application software (or data accompanying it) or the like, in addition to the information that identifies the device. A plurality of algorithms for generating the encryption key Key1 and the decryption key Key4 may be prepared and one algorithm may be selected from them. As an example of the data accompanying the software, a number sequence that is added to (or inserted into) a numerical sequence of the serial number of the device is prepared.

The generation of the encryption key Key1, the decryption key Key2, the encryption key Key3, and the decryption key Key4 is not necessarily conducted for each data transmission and data reception. For example, keys generated in advance may be stored in the server 11, and when data is transmitted or received, the encryption key Key1 and the decryption key Key2 for a device of each user may be searched for and used.

In the above example, the encryption key Key1 is generated in each mobile terminal. Therefore, in many cases, the encryption key Key1 inevitably differs from mobile terminal to mobile terminal. Furthermore, in the case where the encryption key Key3 and the decryption key Key2 are generated using the encryption key Key1, when the encryption keys Key1 are different between mobile terminals, the respective decryption keys Key2 are also different. That is, in most cases, when mobile terminals are different, the encryption keys Key1 are different and the decryption keys Key2 are also different.

The server 11 (or the database 12) stores in advance the encryption keys Key1 for transmitting data to individual users and the decryption keys Key2 for decrypting data transmitted by the users, for example, by the mechanism of a lookup table.

For example, the server 11 may obtain the encryption key Key1 in the step of installing application software (the step S01 of installing in FIG. 1B) or the step of user registration (the step S02 of user registration in FIG. 1B), may use this to generate the decryption key Key2 for decrypting data transmitted by a user, and may store the key.

Similarly, at the step of installing the application software, the user's device may obtain the encryption key Key3 for transmitting data to the server 11 from the server 11, may generate the decryption key Key4 for decrypting data transmitted by the server 11, and may store these keys.

A procedure in which a user uses the application software is described with reference to FIG. 3. First, the user enters a password into the device 14a. The device 14a encrypts the password using the encryption key Key3 (a step S21 of encrypting PW), and transmits the ID and the password to the server 11 (a step S22 of transmitting ID/PW). In this process, for example, the ID is transmitted to the server 11 without being encrypted.

The server 11 first determines whether the ID is valid (the step S23 of verifying an ID). If the ID is not registered, the server 11 transmits notice “login failed” to the device 14a (the step S27 of transmitting notice of “login failed”).

When the ID is valid, the server 11 searches for the decryption key Key2 that corresponds to the ID, and decrypts the password using the decryption key Key2 (the step S24 of searching for a decryption key and decrypting PW). Note that in this step, the encryption key Key1 for transmitting data to the device 14a may be searched for.

Next, the server 11 determines whether the password corresponds to the ID (the step S25 of verifying PW). When the password corresponds to the ID, the server 11 transmits notice “login completed” to the device 14a (the step S26 of transmitting notice of “login completed”). If the password does not correspond to the ID, the server 11 transmits notice “login failed” to the device 14a (the step S27 of transmitting notice of “login failed”).

A reason why the password does not correspond to the ID is that an incorrect password is entered; however, even when a correct password is entered, if the encryption key Key3 in the device is not correct, the server 11 cannot decrypt the password properly. As a result, the server 11 determines that the password does not correspond to the ID. For example, when a third party transmits an ID and a password with a device different from a device of a rightful user, the third party fails to log in. In this manner, unauthorized login can be prevented.

In addition, even without malice, a user like the user D who has a plurality of devices (the device 14d and the device 14e) cannot log in with an unregistered device.

In the case where the password is determined to correspond to the ID, after the determination, data transmitted by the server 11 and data transmitted by the device 14a (which include accompanying data that is necessary to use application software) are encrypted using the respective encryption keys (Key 1 and Key3). Data received by the server 11 and data received by the device 14a are decrypted using the respective decryption keys (Key2 and Key4). Data cannot be substantially decoded when these decryption keys are not known, so that data can be transmitted and received in a highly secure environment.

FIG. 4A illustrates a system in which the server 11 encrypts data and transmits it to the device 14a. The server 11 (or the database 12) includes the user managing unit 21. In the user managing unit 21, IDs of registered users and encryption keys Key1 and decryption keys Key2 which correspond to the IDs are stored.

For example, when the device 14a of a user whose ID is 10340025 requests data, the server 11 can call the encryption key Key1 (here, 52689471) and the decryption key Key2 (18974632), which correspond to the ID 10340025, from the user managing unit 21.

The data 26 to be transmitted to the user is encrypted using the encryption key 24 (52689471) by the encryption circuit 22 (or an encryption algorithm) to become the encrypted data 27, which is transmitted to the network 13.

FIG. 4B shows a system in which data that the device 14a receives from the server 11 is decrypted. In a memory 31 of the device 14a, the encryption key Key3 (here, 20014789) generated by the application software and the decryption key Key4 (here, 36497510) received from the server 11 are stored in addition to data (application data) for executing the application software.

For example, when receiving the encrypted data 27 through the network 13, the device 14a decrypts the encrypted data 27 using a decryption key Key35 (36497510) in a decryption circuit 33 (or a decryption algorithm) and thus obtains decrypted data 38.

FIG. 5A illustrates a system in which the device 14a encrypts data and transmits it to the server 11. In the device 14a, data 36 to be transmitted to the server 11 is encrypted in an encryption circuit 32 (or an encryption algorithm) using an encryption key Key34 (20014789) stored in the memory 31 to generate encrypted data 37, and the device 14a transmits it to the network 13.

FIG. 5B shows a system in which data that the server 11 receives from the device 14a is decrypted. The server 11 can call the decryption key Key2 (18974632) with reference to the user's ID (Ser. No. 10/340,025).

The encrypted data 37 that is received by the server 11 through the network 13 is decrypted using the decryption key Key25 (18974632) by a decryption circuit 23 (or a decryption algorithm), so that the decrypted data 28 can be obtained.

### Embodiment 4

According to the method described in Embodiment 3, encrypted data cannot be decrypted when the decryption key Key2 and the decryption key Key4 are not known; therefore, a highly secure communication environment can be constructed.

However, there is a possibility that a third party obtains the decryption key Key2 and the decryption key Key4 by some attack. To prevent this, it is preferable to update the decryption key Key2 and the decryption key Key4 periodically. Note that in general, when the decryption key Key2 and the decryption key Key4 are updated, the corresponding encryption key Key1 and the corresponding encryption key Key3 need to be updated. In general, it takes quite a while to decode encrypted data; accordingly, the encryption key and the decryption key are preferably updated at an interval shorter than the time assumed to be needed for the decoding.

Specifically, in the step of installing application software, the device 14a generates the encryption key Key1 and the decryption key Key4. At almost the same time, the server 11 generates the encryption key Key3 and the decryption key Key2. After that, user registration is performed, and then updating of the encryption key Key1, the decryption key Key2, the encryption key Key3, and the decryption key Key4 is performed on the basis of a procedure shown in FIG. 8.

First, the device 14a generates a random number (a step S31a of generating a random number). With use of a numerical sequence obtained in this manner, the device 14a generates a new encryption key Key1 and a new decryption key Key4 (a step S32a of updating encryption and decryption keys).

Then, the device 14a encrypts the new encryption key Key1 using the encryption key Key3 and transmits it to the server 11 (a step S33a of encrypting and transmitting a new encryption key). The server 11 receives the new encryption key

Key1 (a step S34a of receiving a new encryption key) and decrypts it using the decryption key Key2 (a step S35a of decrypting a new encryption key). In that case, the server 11 may also update the encryption key Key3 and the decryption key Key2. After that, the server 11 encrypts data to be transmitted to the device 14a using the new encryption key Key1 (a step S36a of encrypting data) and transmits it to the device 14a (a step S37a of transmitting data).

At this time, the data transmitted to the device 14a may be data requested by the device 14a or may be the encryption key Key3 that is updated by the server 11 in association with updating of the encryption key Key1.

The device 14a receives the encrypted data (a step S38a of receiving data) and decrypts it using the new decryption key Key4 (a step S39a of decrypting data). After the updating of the encryption key Key1, the decryption key Key2, the encryption key Key3, and the decryption key Key4, data is transmitted and received between the server 11 and the device 14a using the encryption key Key1, the decryption key Key2, the encryption key Key3, and the decryption key Key4 which are updated.

The updating shown in FIG. 8 may be performed while a user connects to the network (a user logs in), at a certain interval (e.g., at an interval of 10 minutes). Meanwhile, it is quite possible that a user does not log in for a long period of time. In that case, updating of the encryption key Key1, the decryption key Key2, the encryption key Key3, and the decryption key Key4 cannot be performed. The longer time passes from the last login, the higher the possibility that a third party obtains the decryption key Key2 and the decryption key Key4 becomes.

For this reason, in the case where a user connects to the network 13 even if the user does not log in, application program may make the device 14a execute updating shown in FIG. 8 in the background.

As another solving means, the encryption key Key1, the decryption key Key2, the encryption key Key3, and the decryption key Key4 may be generated again from the beginning in the case where a certain time has passed from the last updating of the encryption key Key1, the decryption key Key2, the encryption key Key3, and the decryption key Key4. In that case, for example, the application software (or the server 11) makes the device 14a generate a random number, and generates the encryption key Key1 and the decryption key Key4 on the basis of the random number. The steps after this are similar to those shown in FIG. 7.

Note that the device 14a holds encrypted data that the device 14a obtains from the server 11 before the updating of the encryption key Key1, the decryption key Key2, the encryption key Key3, and the decryption key Key4 in some cases. In that case, the data cannot be decrypted using the updated decryption key Key4. For this reason, the device 14a may decrypt the encrypted data that the device 14a holds using the decryption key Key4 that is not updated and then may encrypt it using the updated encryption key Key1.

### Embodiment 5

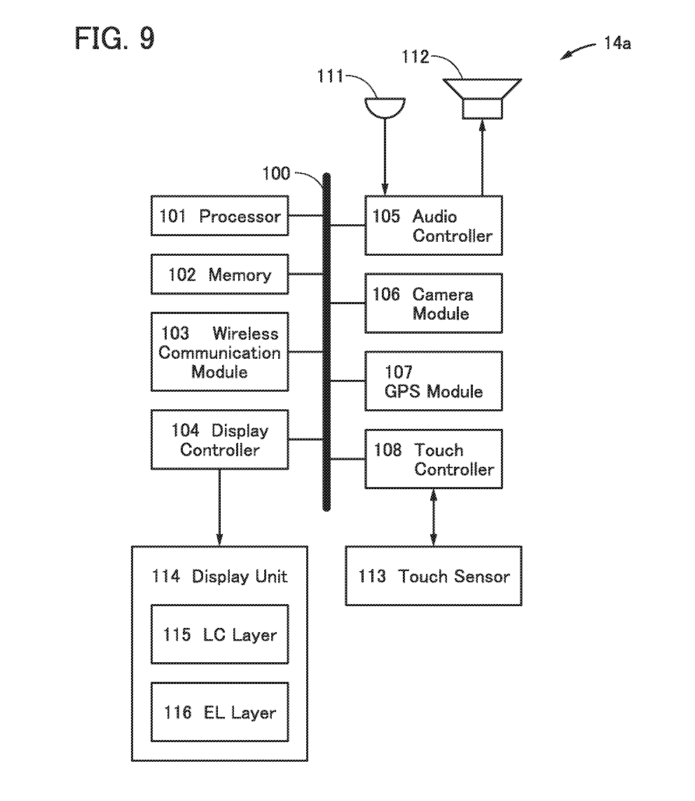

In this embodiment, a structure example of the device 14a is described. As shown in FIG. 9, the device 14a includes a processor 101, a memory 102, a wireless communication module 103, a display controller 104, an audio controller 105, a camera module 106, a GPS module 107, and a touch controller 108. Mutual data transmission and reception can be performed between these components through a bus 100.

An acoustic signal can be input to the audio controller 105 from a microphone 111, and the audio controller 105 outputs the acoustic signal to a speaker 112.

Signal transmission and reception are performed between the touch controller 108 and a touch sensor 113. For example, a drive signal is output from the touch controller 108 to the touch sensor 113, and a detection signal is input from the touch sensor 113 to the touch controller 108. In the case where the touch sensor 113 is a capacitive touch sensor, a drive line and a sense line of the touch sensor 113 intersect, and the drive signal is input to the drive line. The potential of the sense line (the detection signal) is changed by capacitive coupling between the drive line and the sense line, in accordance with the drive signal. The degree of the potential change varies when a conductive material exists in an intersect portion of the drive line and the sense line.

The display controller 104 transmits an image signal to a display unit 114. In the display unit 114, display layers with different properties are stacked. For example, a reflective display layer and a non-reflective display layer may be stacked.

As the reflective display layer, a liquid crystal layer that includes a reflective layer inside or outside the layer, microelectromechanical systems (MEMS) that includes a reflective layer inside or outside the layer, or an electronic ink layer can be used, for example. As the non-reflective display layer, an EL layer, a liquid crystal layer including a light source such as a backlight, or a micro light-emitting diode (micro LED) layer can be used, for example. An active element and a passive element which perform display using these layers may be adjacently provided.

Described below is an example in which a liquid crystal layer 115 and an EL layer 116 are stacked in the display unit 114. Here, a reflective layer is provided between the liquid crystal layer 115 and the EL layer 116. A plurality of openings is provided in the reflective layer, and light emitted from the EL layer 116 can reach the liquid crystal layer 115 through the openings. The liquid crystal layer 115 and the EL layer 116 may be provided with a transistor, a wiring, an electrode, a capacitor, and the like which control a signal for display. Note that a specific region including the liquid crystal layer 115 is also called a reflective liquid crystal display layer, and a specific region including the EL layer 116 is also called an EL display layer. The details of the display unit 114 are described later.

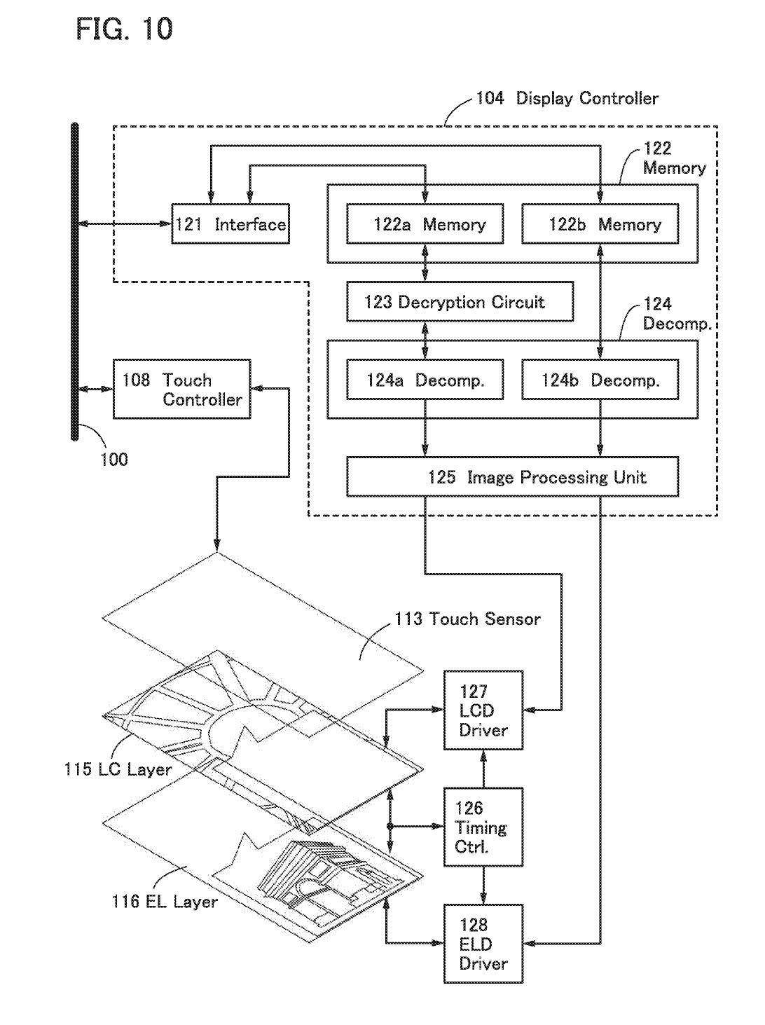

FIG. 10 shows the display controller 104, the touch controller 108, the touch sensor 113, and the liquid crystal layer 115 and the EL layer 116 (which are included in the display unit 114) and their peripheral circuits (a timing controller 126, a display driver (an LCD driver 127) of an LC display (LCD), and a display driver (an ELD driver 128) of an EL display (ELD)). The timing controller 126 has a function of generating a timing signal that is used in the LCD driver 127, the ELD driver 128, or the like.

The display controller 104 includes an interface 121, a memory 122a, a memory 122b, a decryption circuit 123, a decompression circuit 124a, a decompression circuit 124b, and an image processing unit 125.

Note that the “memory 122a” and the “memory 122b” are functional expression and do not necessarily exist as individual memories. For example, a certain portion of one memory matrix serves as the memory 122a in a certain time and serves as the memory 122b in another time in some cases. Therefore, the memory 122a and the memory 122b are collectively expressed as a memory 122 in some cases.

Similarly, the “decompression circuit 124a” and the “decompression circuit 124b” are also functional expression and do not necessarily exist as two individual circuits. For example, when the compression methods of data of the memory 122a and data of the memory 122b are the same, one decompression circuit can decompress data from the memory 122a in a certain time and can decompress data from the memory 122b in another time. Alternatively, when a plurality of decompression circuits is prepared in accordance with compression methods, one of the decompression circuits decompresses data from the decryption circuit 123 in a certain time and decompresses data from the memory 122b in another time in some cases. Therefore, the decompression circuit 124a and the decompression circuit 124b are collectively expressed as a decompression circuit 124 in some cases.

Data transmission and reception are performed between the display controller 104 and the bus 100 through the interface 121. For example, data to be displayed on the display unit 114 is input from a circuit or a module which supplies a signal (hereinafter referred to as a host), such as the processor 101, to the interface 121 through the bus 100. The data that passes through the interface 121 is transmitted to the memory 122a or the memory 122b.

Note that each of the memory 122 (the memory 122a and the memory 122b) and the timing controller 126 may be a memory (hybrid memory) in which a silicon semiconductor transistor and an oxide semiconductor transistor are used. This memory is disclosed in United States Published Patent Application No. 2015/0325282.

Note that the decryption circuit 123 and the decompression circuit 124b (or the decompression circuit 124) may be provided between the interface 121 and the memory 122. Note that in order that data after being decompressed is stored in the memory 122, larger capacity is needed. Note that decryption may be performed in the processor 101 or another circuit.

For example, considered here is the case where an image of a virtual space (e.g., a map of Arc de Triomphe in Paris) transmitted by the server 11 is displayed using the liquid crystal layer 115, and an image of a real space (e.g., a photograph or video of Arc de Triomphe taken with a camera provided in the device 14a) transmitted by the camera module 106 is displayed using the EL layer 116.

Each image is transmitted to the display controller 104 through the processor 101. In addition to the image of a virtual space and the image of a real space, for example, data that specifies where the image is displayed in the liquid crystal layer 115 and data that specifies where the image is displayed in the EL layer 116 are also transmitted to the display controller 104. The display controller 104 receives such data through the interface 121.

The image of a virtual space transmitted by the server 11 has already been encrypted and compressed when it is input to the display controller 104. The encrypted and compressed image of a virtual space is called first data. In addition, the image of a real space transmitted by the camera module 106 may have already been compressed when it is input to the display controller 104. Data compression can reduce the transmission capacity, leading to a reduction in power consumption. The compressed image of a real space is called second data. Embodiment 1 and FIG. 2 can be referred to for data transmission, data reception, data encryption, generation of an encryption key and a decryption key, and the like which are performed before the image is input to the display controller 104.

The first data is received by the device 14a, input to the display controller 104, temporarily stored in the memory 122a, and subjected to decryption in the decryption circuit 123. Then, the first data is subjected to decompression in the decompression circuit 124a. As a result, the image of a virtual space can be obtained.

The second data is temporarily stored in the memory 122b, and in the case where the second data is compressed, decompression is performed in the decompression circuit 124b. Thus, the image of a real space is output by the decompression circuit 124b. Note that in the case where data that is not compressed is input to the decompression circuit 124a and the decompression circuit 124b, decompression is not performed in the decompression circuit 124a and the decompression circuit 124b.

The image of a virtual space and the image of a real space are subjected to image correction, such as a gamma correction, toning, or dimming, in the image processing unit 125. Then, these images are transmitted to the LCD driver 127 and the ELD driver 128 in accordance with a timing signal generated by the timing controller 126, and electrical actions (change in the degree of polarization or the intensity of light emission) occur in the liquid crystal layer 115 and the EL layer 116. Such an action can be visually recognized directly or indirectly. As a result, the image of a virtual space and the image of a real space which are overlapped can be visually recognized in the display unit 114.

Furthermore, a signal obtained by the touch sensor 113 is transmitted to the host through the touch controller 108 and the bus 100, and reflected in information relating to the image of a real space or the image of a virtual space. Alternatively, the signal obtained by the touch sensor 113 can be transmitted to the display controller 104, and reflected in the image of a real space, the image of a virtual space, or another image.

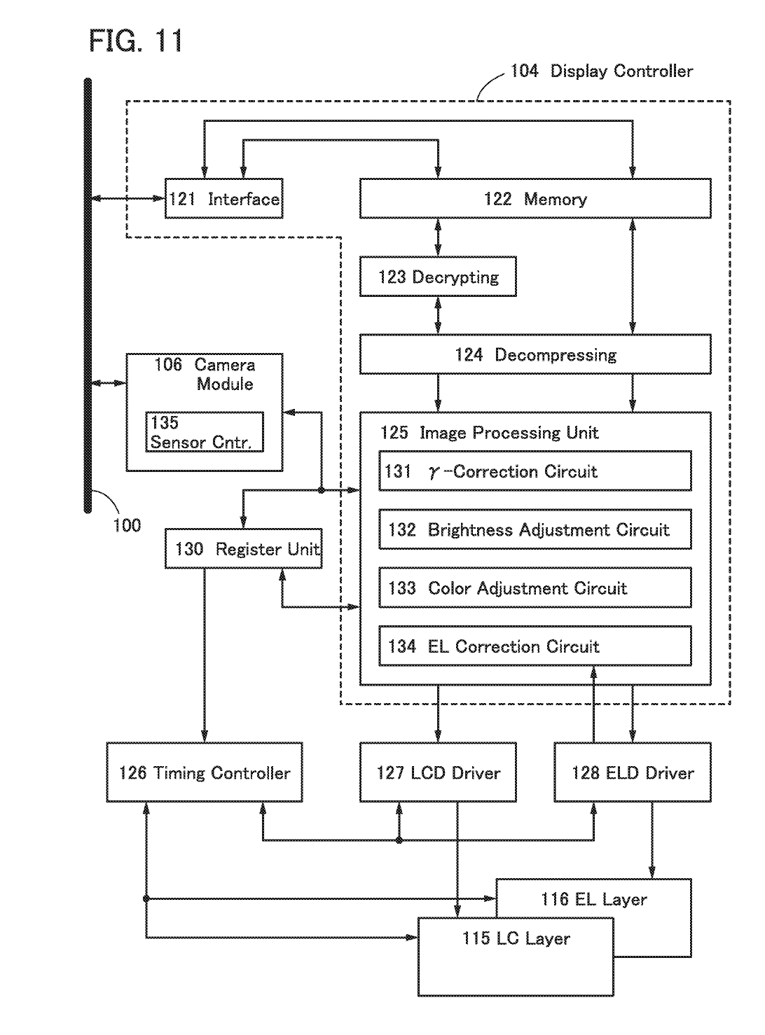

Furthermore, information relating to environmental light may be obtained with an optical sensor, and parameters for toning and dimming may be set. The optical sensor may be replaced with the camera module 106. This example is described with reference to FIG. 11. A system shown in FIG. 11 further includes a register unit 130 as compared with the system in FIG. 10. Note that although not shown in FIG. 11, the touch controller 108 and the touch sensor 113 each operate in a manner similar to that of FIG. 10.

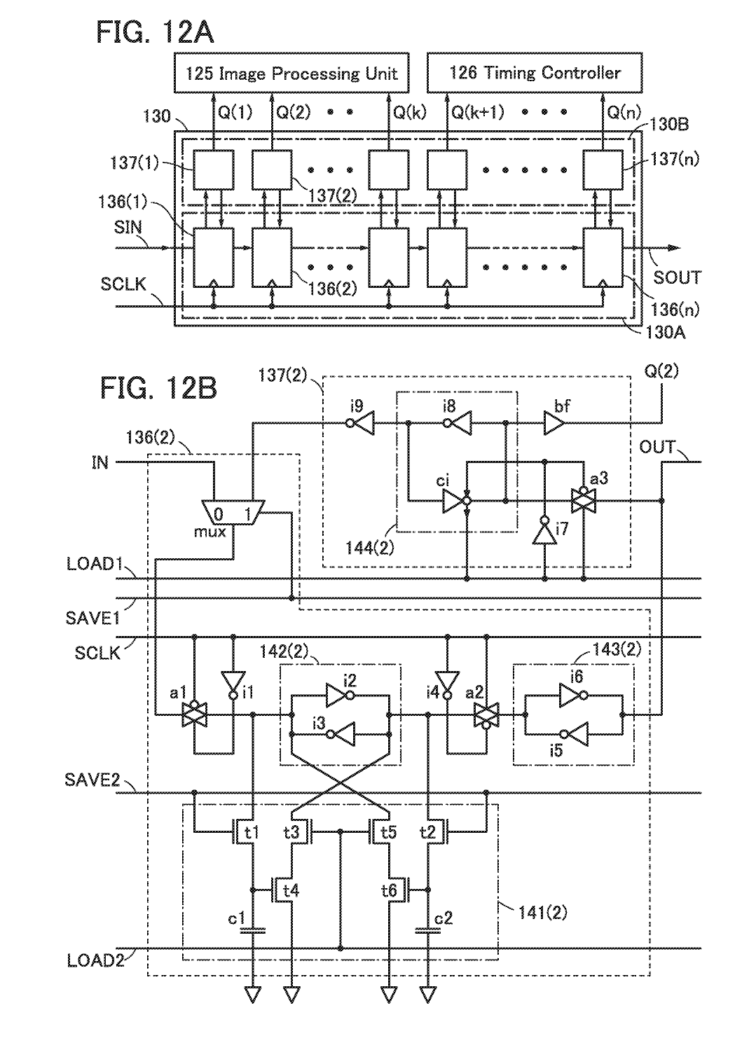

The register unit 130 stores data used for operations of the display controller 104, the timing controller 126, and another circuit. The data stored in the register unit 130 includes a parameter used to perform correction processing in the image processing unit 125, parameters used to generate waveforms of a variety of timing signals in the timing controller 126, and the like. The register unit 130 is provided with a scan chain register portion 130A including a plurality of registers (see FIG. 12A).

As in FIG. 10, the display controller 104 includes the interface 121, the memory 122, the decryption circuit 123, the decompression circuit 124, and the image processing unit 125. The image processing unit 125 includes a gamma correction circuit 131, a dimming circuit 132, a toning circuit 133, and an EL correction circuit 134. The gamma correction circuit 131, the dimming circuit 132, the toning circuit 133, and the EL correction circuit 134 may each include the memory disclosed in United States Published Patent Application No. 2015/0325282.

The EL correction circuit 134 is provided in the case where a current detection circuit that detects a current flowing through the EL layer 116 is provided in the ELD driver 128. The EL correction circuit 134 has a function of adjusting luminance of the EL layer 116 on the basis of a signal transmitted by the current detection circuit of the ELD driver 128.

The camera module 106 includes a sensor controller 135. A camera (not shown) is electrically connected to the sensor controller 135. The camera senses the light intensity and color tone of environmental light and generates a sensing signal.

The sensor controller 135 generates a control signal on the basis of the sensing signal. The control signal generated by the sensor controller 135 is output from the camera module 106 to the image processing unit 125 and the register unit 130, for example. In addition, signals from the image processing unit 125 and the register unit 130 are transmitted to the camera module 106.

For example, in the case where the control signal transmitted by the sensor controller 135 includes information relating to the brightness of environmental light, the image processing unit 125 can separately adjust signals output to the LCD driver 127 and the ELD driver 128, in accordance with the information relating to the brightness of environmental light. This adjustment is called dimming or dimming processing, and executed in the dimming circuit 132.

For example, in the case where the device 14a is used in sunlight in fine weather during the daytime, the EL layer 116 does not need to emit light. Accordingly, the dimming circuit 132 outputs a signal that increases the transmittance of the liquid crystal layer 115 to the LCD driver 127, and outputs a signal that weakens light emission of the EL layer 116 to the ELD driver 128. In contrast, in the case where the device 14a is used during the nighttime or in a dark place, display is performed while the EL layer 116 emits light. Accordingly, the dimming circuit 132 outputs a signal that reduces the transmittance of the liquid crystal layer 115 to the LCD driver 127, and outputs a signal that enhances light emission of the EL layer 116 to the ELD driver 128.

In this manner, the image processing unit 125 can generate image data that is displayed only using the liquid crystal layer 115, image data that is displayed only using the EL layer 116, or image data that is displayed using both the liquid crystal layer 115 and the EL layer 116, in accordance with the intensity of environmental light. The device 14a can perform favorable display in a bright environment and in a dark environment. Furthermore, in a bright environment, power consumption can be reduced by making the EL layer 116 emit no light or reducing the luminance of the EL layer 116.

When display using the liquid crystal layer 115 and display using the EL layer 116 are combined, the color tone can be corrected. In order to correct the color tone, information including color tone of environmental light is added to the control signal transmitted by the sensor controller 135. For example, in the case where the device 14a is used in reddish environment at dusk, display using only the liquid crystal layer 115 lacks the blue constituent (the display seems reddish). When the control signal includes the information that the color tone of environmental light is reddish, the EL layer 116 emits blue light (B) and green light (G) with higher intensity, whereby the color tone can be corrected. This correction is called toning or toning processing, and is executed in the toning circuit 133.

The image processing unit 125 might include another processing circuit such as an RGB-RGBW conversion circuit depending on the specifications of the device 14a. The RGB-RGBW conversion circuit has a function of converting image data of red, green, and blue (RGB) into image signal of red, green, blue, and white (RGBW). That is, in the case where the display unit 114 includes pixels of four colors of RGBW, power consumption can be reduced by displaying a white (W) component in the image data using the white (W) pixel. Note that in the case where the display unit 114 includes pixels of four colors of RGBY (red, green, blue, and yellow), an RGB-RGBY conversion circuit can be used, for example.

Image correction processing such as gamma correction, dimming, or toning corresponds to processing of generating output correction data Y with respect to input image data X. The parameter that the image processing unit 125 uses is a parameter for converting the image data X into the correction data Y.

As a parameter setting method, there are a table method and a function approximation method. In order to freely generate correction data with respect to any image data, the table method is preferably employed. Although the table method needs high-capacity memory to store parameters, correction can be performed with high degree of freedom. In contrast, in the case where the correction data with respect to the image data is empirically determined in advance, it is effective to employ the function approximation method. As the function approximation method, a method of performing linear approximation in every period, a method of performing approximation with a nonlinear function, or the like can be employed, for example. In the function approximation method, correction is performed with low degree of freedom; however, the number of memories for storing parameters that defines a function can be small.

As a parameter used to adjust waveforms of a variety of timing signals in the timing controller 126, a parameter that indicates the number of clock cycles that corresponds to timing at which the parameter becomes “H” (or “L”) with respect to the reference signal is stored.

These parameters for correction can be stored in the register unit 130. Other parameters that can be stored in the register unit 130 include data of the EL correction circuit 134, luminance, color tones, and setting of energy saving (time taken to make display dark or turn off display) which are set by a user, sensitivity of the touch sensor 113, and the like.

In the case where transmitted image data does not change, power supply to part of the display controller 104 (and/or part of the periphery circuits) can be stopped. Such a selective stop of power supply is called power gating. Specifically, power supply to, for example, the memory 122, the decryption circuit 123, the decompression circuit 124, the image processing unit 125, the timing controller 126, the LCD driver 127, the ELD driver 128, and the register unit 130 can be stopped. The stop of power supply is executed by instruction of the processor 101, for example.

The above circuits are the circuits relating to image data and the circuits for driving the display unit 114; therefore, power supply can be temporarily stopped in the case where the image data is not changed. Note that even when the image data is not changed, the period of time during which power supply is stopped may be determined in consideration of a period of time during which a transistor used in the display unit 114 can hold data (a period of time during which idling stop can be performed, see United States Published Patent Application No. 2014/0368488) and a time of inversion driving that is performed to prevent image burn-in of the display by the liquid crystal layer 115.

Note that it is possible that image data is stored in the memory 122 and the image data is supplied to the LCD driver 127 during the inversion driving. Thus, inversion driving can be conducted without transmission of the image data from the outside of the display controller 104 (e.g., the host). Therefore, the data transmission capacity can be reduced and the total power consumption of the device 14a can be reduced.

A specific circuit configuration of the register unit 130 is described below. FIG. 12A is a block diagram showing a structure example of the register unit 130. The register unit 130 includes a scan chain register portion 130A and a register portion 130B.

The scan chain register portion 130A includes a plurality of nonvolatile registers 136 (here, the number of the nonvolatile registers 136 is n). The register portion 130B includes a plurality of volatile registers 137 (here, the number of the volatile registers 137 is n). The scan chain register is formed by the plurality of nonvolatile registers 136.

The first-stage volatile register 137 to the k-th-stage volatile register 137 are configured to output output data Q(1) to output data Q(k) to the image processing unit 125. The (k+1)-th-stage volatile register 137 to the n-th-stage volatile register 137 are configured to output output data Q(k+1) to output data Q(n) to the timing controller 126.

Scan input data SIN is sequentially input to the first-stage nonvolatile register 136(1) in the register unit 130. The scan input data SIN is sequentially transferred to a second-stage nonvolatile register 136 and subsequent-stage nonvolatile registers 136 in accordance with a scan clock signal SCLK. The n-th-stage nonvolatile register 136(n) outputs scan output data SOUT.

The nonvolatile register 136 does not lose data even when power supply is stopped. Here, the nonvolatile register 136 is provided with a retention circuit including an oxide semiconductor (OS) transistor in order to have non-volatility.

The volatile register 137 is a volatile register. There is no particular limitation on the circuit configuration of the volatile register 137, and a latch circuit, a flip-flop circuit, or the like is used as long as data can be stored. Although the volatile register 137 is not necessarily completely volatile, but preferably can operate at a higher speed. The image processing unit 125 and the timing controller 126 access the register portion 130B and take data from the corresponding volatile register 137. Alternatively, the processing contents of the image processing unit 125 and the timing controller 126 are controlled in accordance with data supplied from the register portion 130B.

To update data stored in the register unit 130, first, data in the scan chain register portion 130A is changed. After data of each nonvolatile register 136 in the scan chain register portion 130A is rewritten, the data of each nonvolatile register 136 is loaded into the corresponding volatile register 137 in the register portion 130B at the same time.

Accordingly, the image processing unit 125, the timing controller 126, and the like can perform various kinds of processing using the data collectively updated. The operation can be stable because simultaneity can be maintained in updating data. With the register portion 130B and the scan chain register portion 130A, data in the scan chain register portion 130A can be updated even during the operation of the image processing unit 125 and the timing controller 126.

At the time of the power gating, power supply is stopped after data is stored in the retention circuit of the nonvolatile register 136. After the power supply is restarted, normal operation is restarted after data in the nonvolatile register 136 is loaded in the volatile register 137. Note that in the case where the data stored in the nonvolatile register 136 and the data stored in the volatile register 137 do not match each other, it is preferable to store the data of the volatile register 137 in the nonvolatile register 136 and then store the data again in the retention circuit of the nonvolatile register 136.

### <Circuit Configuration of Nonvolatile Register and Volatile Register>

FIG. 12B shows an example of a circuit configuration of the nonvolatile register 136 and the volatile register 137. In FIG. 12B, the second-stage nonvolatile register 136(2) in the scan chain register portion 130A and the volatile register 137(2) that corresponds to the nonvolatile register 136(2) are shown. The nonvolatile register 136(1), the nonvolatile register 136(3) to the nonvolatile register 136(n), the volatile register 137(1), and the volatile register 137(3) to the volatile register 137(n) have configurations similar to the configuration of the second-stage nonvolatile register 136(2) and the volatile register 137(2).

The nonvolatile register 136(2) includes a selector mux, a retention circuit 141(2), an inverter loop 142(2), and an inverter loop 143(2).

A signal SAVE2 and a signal LOAD2 are input to the retention circuit 141(2). The retention circuit 141(2) includes a transistor t1, a transistor t2, a transistor t3, a transistor t4, a transistor t5, a transistor t6, a capacitor c1, and a capacitor c2. The transistor t1 and the transistor t2 are OS transistors.

A 3-transistor gain cell is formed by the transistor t1, the transistor t3, the transistor t4, and the capacitor c1. Similarly, a 3-transistor gain cell is formed by the transistor t2, the transistor t5, the transistor t6, and the capacitor c2. Complementary data retained in the inverter loop 142(2) is transferred to the retention circuit 141(2), and then stored in the two gain cells. Since the transistor t1 and the transistor t2 are OS transistors, the retention circuit 141(2) can retain data for a long time even when power supply is stopped.

The retention circuit 141(2) stores complementary data retained in the inverter loop 142(2) in accordance with the signal SAVE2 and loads the retained data in the inverter loop 142(2) in accordance with the signal LOAD2.

The inverter loop 142(2) includes an inverter i2 and an inverter i3, and the inverter loop 143(2) includes an inverter i5 and an inverter i6.

An output terminal of the selector mux is electrically connected to a first terminal of the inverter loop 142(2) through an analog switch a1. A first terminal of the inverter loop 143(2) is electrically connected to a second terminal of the inverter loop 142(2) through an analog switch a2. An input terminal of the volatile register 137(2) is electrically connected to a second terminal of the inverter loop 143(2). Note that a signal of the second terminal of the inverter loop 143(2) is input to a selector mux in the next-stage nonvolatile register 136(3) as a signal OUT.

The conduction states of the analog switch a1 and the analog switch a2 are controlled by the scan clock signal SCLK. In addition to the scan clock signal SCLK, a signal that has passed through an inverter it is input to the analog switch a1 and a signal that has passed through an inverter i4 is input to the analog switch a2.

For example, when the scan clock signal SCLK is high, the analog switch a1 is turned off and the analog switch a2 is turned on. When the scan clock signal SCLK is low, the analog switch a1 is turned on and the analog switch a2 is turned off. In this manner, the states of the analog switch a1 and the analog switch a2 are opposite to each other.

An output of the volatile register 137(2) is input to one of two input terminals of the selector mux, and a signal IN is input to the other input terminal. The signal IN is a signal retained by the first terminal of the inverter loop 143(2) in the previous-stage nonvolatile register 136(1). Note that the scan input data SIN is input from the outside of the register unit 130 to the input terminal of the first-stage selector mux in the scan chain register portion 130A.

The selector mux is controlled by a signal SAVE1. Specifically, when the signal SAVE1 is high, a signal from the volatile register 137(2) is selected, and when the signal SAVE1 is low, the signal IN (in the case of the first-stage selector mux, the scan input data SIN from the outside) is selected.

The volatile register 137(2) includes an inverter loop 144(2) and an analog switch a3. The inverter loop 144(2) includes an inverter i8 and a clocked inverter ci. The second terminal of the inverter loop 143(2) is electrically connected to a first terminal of the inverter loop 144(2) through the analog switch a3. A signal of the first terminal of the inverter loop 144(2) is output to the image processing unit 125 as output data Q(2) through a buffer bf. The one terminal of the selector mux is electrically connected to a second terminal of the inverter loop 144(2) through an inverter i9.

The conduction state of the analog switch a3 is controlled by a signal LOAD1. The signal LOAD1 and a signal that has passed through an inverter i7 are input to the analog switch a3. As a result, when the signal LOAD1 is high, an output of the nonvolatile register 136(2) (a signal of the second terminal of the inverter loop 143(2)) is input to the inverter loop 144(2).

The transistors other than the transistor t1 and the transistor t2 in the nonvolatile register 136(2) may be silicon (Si) transistors. The transistors in the volatile register 137(2) may be Si transistors.

### <Operation Example of Nonvolatile Register and Volatile Register>

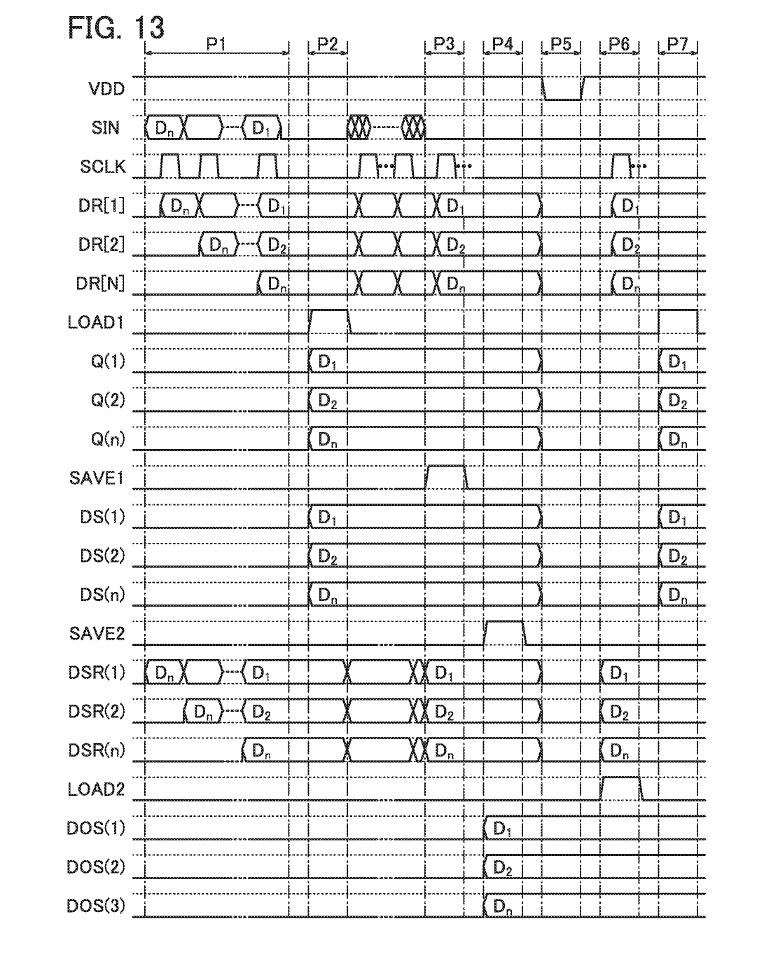

Next, an operation example of the register unit 130 is described with reference to FIG. 13. Here described is the case in which D₁ to Dₙ are stored in an inverter loop 142(1) to an inverter loop 142(n) (i.e., potentials of first terminals of the inverter loop 142(1) to the inverter loop 142(n) correspond to D₁ to Dₙ, respectively). Note that each of D₁ to Dₙ is 1-bit data that corresponds to “0” or “1” (or “H” or “L”, “high level” or “low level”). Note that in this specification, 1-bit data is described as “data”.

In FIG. 13, data DR represents data output by the inverter loop 143 (data corresponding to an output potential of the inverter i5 or a potential of the second terminal of the inverter loop 143); data DS represents data output by the volatile register 137 (data corresponding to an output potential of the inverter i9); data DSR represents data stored in the inverter loop 142 (data corresponding to an output potential of the inverter i3 or data corresponding to a potential of the first terminal of the inverter loop 142); and data DOS represents data stored in the retention circuit 141. The output data Q represents data output by the volatile register 137, and corresponds to parameters for the image processing unit 125 and the timing controller 126. Note that the output data Q is the same as the data DS. The initial values of the data DR, the data DS, the data DSR, the data DOS, and the output data Q are “0” below, but these values are not limited to 0.

First, in a first period P1, the scan input data SIN that consists of D₁ to Dₙ is input in the order from Dₙ to D₁. The scan input data SIN is transmitted to the inverter loop 142(1) to the inverter loop 142(n) in synchronization with the scan clock signal SCLK, and eventually D₁ to Dₙ are stored in the inverter loop 142(1) to the inverter loop 142(n), respectively. As a result, data DSR(1) to data DSR(n) become D₁ to Dₙ, respectively.

Note that, after the scan clock signal SCLK becomes high, data of the inverter loop 142 is input to the inverter loop 143. Accordingly, data DR(1) to data DR(n) also become D₁ to Dₙ, respectively, slightly behind the inverter loop 142(1) to the inverter loop 142(n) (after the scan clock signal SCLK becomes high).

Next, in a second period P2, the signal LOAD1 becomes high. Thus, the data DR(1) to the data DR(n) (D₁ to Dₙ, respectively) are transferred to and stored in the volatile register 137(1) to the volatile register 137(n) at once. As a result, D₁ to Dₙ are output as the output data Q(1) to the output data Q(n), respectively. In this manner, the scan input data SIN is output as the output data Q(1) to the output data Q(n) at once. Therefore, parameters for the image processing unit 125 and the timing controller 126 can be changed at once. In addition, data DS(1) to data DS(n) concurrently become D₁ to Dₙ, respectively.

Next, in a third period P3, the signal SAVE1 becomes high. Thus, the selector mux inputs an output of the volatile register 137 to the inverter loop 142, so that the data DS(1) to the data DS(n) (corresponding to D₁ to Dₙ, respectively) are stored in the inverter loop 142(1) to the inverter loop 142(n). As a result, the data DSR(1) to the data DSR(n) become D₁ to Dₙ, respectively. Furthermore, after the scan clock signal SCLK becomes high, the data DR(1) to the data DR(n) also become D₁ to Dₙ, respectively.

Next, in a fourth period P4, the signal SAVE2 becomes high. Thus, the data DSR(1) to the data DSR(n) (corresponding to D₁ to Dₙ, respectively) are stored in a retention circuit 141(1) to a retention circuit 141 (n). In other words, the data stored in the inverter loop 142 is stored in the retention circuit 141. As a result, data DOS(1) to data DOS(n) become D₁ to Dₙ, respectively. Specifically, the capacitor c1 and the capacitor c2 in FIG. 12B have potentials corresponding to D₁ to Dₙ.

Next, in a fifth period P5, a power supply potential VDD is set low, so that power supply to the register unit 130 is stopped. Thus, data stored in the inverter loop 142, data stored in the inverter loop 143, and data stored in the inverter loop 144 are lost. Note that the data DOS(1) to the data DOS(n) stored in the retention circuits 141(1) to 144(n) are retained even in the period during which power supply to the register unit 130 is stopped. Specifically, the capacitor c1 and the capacitor c2 in FIG. 12B retain potentials corresponding to D₁ to Dₙ.

Next, in a sixth period P6, power supply to the register unit 130 is restarted and the signal LOAD2 becomes high. At this time, the data DOS(1) to the data DOS(n) (corresponding to D₁ to Dₙ, respectively) retained in the retention circuit 141(1) to the retention circuit 141(n) are transferred to and stored in the inverter loop 142(1) to the inverter loop 142(n). That is, data stored in the retention circuit 141 is restored in the inverter loop 142. As a result, the data DR(1) to the data DR(n) become D₁ to Dₙ, respectively.

Next, in a seventh period P7, the signal LOAD1 becomes high. Thus, the data DR(1) to the data DR(n) (corresponding to D₁ to Dₙ, respectively) are transferred to and stored in the volatile register 137(1) to the volatile register 137(n). As a result, D₁ to Dₙ are output as the output data Q(1) to the output data Q(n) (and the data DS(1) to the data DS(n)). That is, data restored in the retention circuit 141 is output to the image processing unit 125 and the timing controller 126 as the output data Q.

Note that as shown in FIG. 13, the scan input data SIN in a period between the second period P2 and the third period P3 is a signal different from D₁ to Dₙ. As a result, data stored in the inverter loop 142 and data stored in the inverter loop 143 are changed. However, for example, data of the inverter loop 143 is transferred to the volatile register 137 only by the signal LOAD1; that is, only by changing the data of the inverter loop 143, the output data Q of the volatile register 137 is not changed.

In the third period P3, the output data Q of the volatile register 137 can be written to the inverter loop 142 (which is the same as an output potential of the inverter i9), and data stored in the volatile register 137 and data stored in the inverter loop 142 can be matched.

Between the second period P2 and the third period P3, for example, different data is being input to the scan chain register portion 130A as the scan input data SIN in order to update the parameters. That is, the data is sequentially input to the inverter loop 142.

Here, in the case where data needs to be stored in the retention circuit 141, first, the signal SAVE1 is set high as in the third period P3. The data stored in the volatile register 137 is transferred to the inverter loop 142 and the output data Q (parameters for the image processing unit 125 and the timing controller 126) of the volatile register 137 is written to the inverter loop 142, so that the data stored in the inverter loop 142 and the output data Q of the volatile register 137 can be matched.

Then, the signal SAVE2 is set high as in the fourth period P4, whereby data stored in the inverter loop 142 (which is the same as the data stored in the volatile register 137) can be stored in the retention circuit 141.

In that case, although data that is being input for updating is discarded, the parameters for the image processing unit 125 and the timing controller 126 can be prevented from becoming unintended values. Furthermore, when power supply is restarted, data restoring can be performed quickly.

As described above, the register unit 130 can change the parameters for the image processing unit 125 and the timing controller 126 in accordance with data sequentially input. At this time, the change in the parameters is conducted at once in synchronization with the signal LOAD1. In addition, the register unit 130 can retain the stored data in the period during which power supply is stopped.

Furthermore, operation examples of the register unit 130 before shipment, at boot-up of the device 14a, and at normal operation will be described separately.

### <Before Shipment>

Parameters relating to specifications and the like of the device 14a are stored in the register unit 130 before shipment. These parameters include, for example, the number of pixels, the number of touch sensors, and parameters used to generate timing signals in the timing controller 126. In addition, the parameters include correction data of the EL correction circuit 134 in the case where the ELD driver 128 is provided with a current detection circuit that detects current flowing through the EL layer 116. A dedicated ROM may be provided and the parameters may be stored in the ROM other than the register unit 130.

### <At Boot-Up>

At boot-up of the device 14a, the parameters set by a user or the like which are transmitted from the host are stored in the register unit 130. These parameters include, for example, luminance and color tones of display, the sensitivity of a touch sensor, energy saving settings (time taken to make display dark or turn off display), and a curve or a table for gamma correction. Note that in storing the parameters in the register unit 130, data corresponding to the parameters is transmitted to the register unit 130 in synchronization with the scan clock signal SCLK.

### <<Normal Operation>>

Normal operation can be classified into a state in which the display unit 114 displays a moving image or the like, a state in which the display unit 114 can perform IDS driving while a still image is being displayed, a state in which the display unit 114 displays no image, and the like. The image processing unit 125, the timing controller 126, and the like are operating in the state of displaying a moving image or the like; however, the image processing unit 125 and the like are not influenced because only the data of the register unit 130 in the scan chain register portion 130A is changed. After the data of the scan chain register portion 130A is changed, the data of the scan chain register portion 130A is loaded in the register portion 130B at once, so that change of the data of the register unit 130 is completed. The operation of the image processing unit 125 and the like is switched to the operation corresponding to the data.

In the state in which the display unit 114 can perform IDS driving while a still image is being displayed, the power gating of the register unit 130 can be performed. In that case, the complementary data retained in the inverter loop 142 is stored in the retention circuit 141 in response to the signal SAVE2 before the power gating in the nonvolatile register 136 included in the scan chain register portion 130A.

Before the power gating is stopped, the data retained in the retention circuit 141 is loaded in the inverter loop 142 in response to the signal LOAD2 and the data in the inverter loop 142 is loaded in the volatile register 137 in response to the signal LOAD1. In this manner, the data of the register unit 130 becomes effective in the same state as that before the power gating. Note that even when the register unit 130 is in a state of power gating, the parameter of the register unit 130 can be changed by stopping the power gating in the case where change of the parameter is requested by the host.

In the state of displaying no image, for example, the power gating of the display controller 104, the register unit 130, the timing controller 126, the LCD driver 127, and the ELD driver 128 can be performed. In that case, the operation of the host might also be stopped. When the power gating is stopped, an image (still image) in a state before the power gating can be displayed without waiting for the resumption of the operation of the host because the memory 122 and the register unit 130 are nonvolatile.

When the register unit 130 changes the data of the scan chain register portion 130A, the image processing unit 125, the timing controller 126, and the like are not influenced. Each nonvolatile register 136 in the scan chain register portion 130A includes the retention circuit 141, which enables smooth start and stop of power gating. In addition, power gating is facilitated in accordance with display operation.

The volatile register 137 is used in a circuit that performs processing in normal operation; in contrast, the nonvolatile register 136 (including OS transistors) is not directly involved in the circuit that performs processing in normal operation. For this reason, direct influence of the OS transistors included in the nonvolatile register 136 on the operation of the display controller 104 is small, and the risk of a reduction in operation speed is low.

Data of parameters is sequentially stored in the scan chain register portion 130A, and while the data is being stored, the newly stored parameter is not reflected in the parameter of the image processing unit 125. The newly stored parameter is reflected after loading at once to the register portion 130B, which follows the data storing, is performed. Thus, even when parameters for toning and dimming are changed in accordance with a change in environmental light, adversely influence such as display image distortion can be prevented.

With the above structure, a display controller can start operation before the processor 101 and the like return from power gating to normal operation. The returning of the processor 101 and the like from power gating takes time, and time it takes for returning of the display controller 104 is sufficiently shorter than it. Since display data has already been stored in the memory 122 (nonvolatile memory), displaying an image can be restarted in a short time. That is, displaying an image can be restarted before the processor 101 and the like return from power gating.

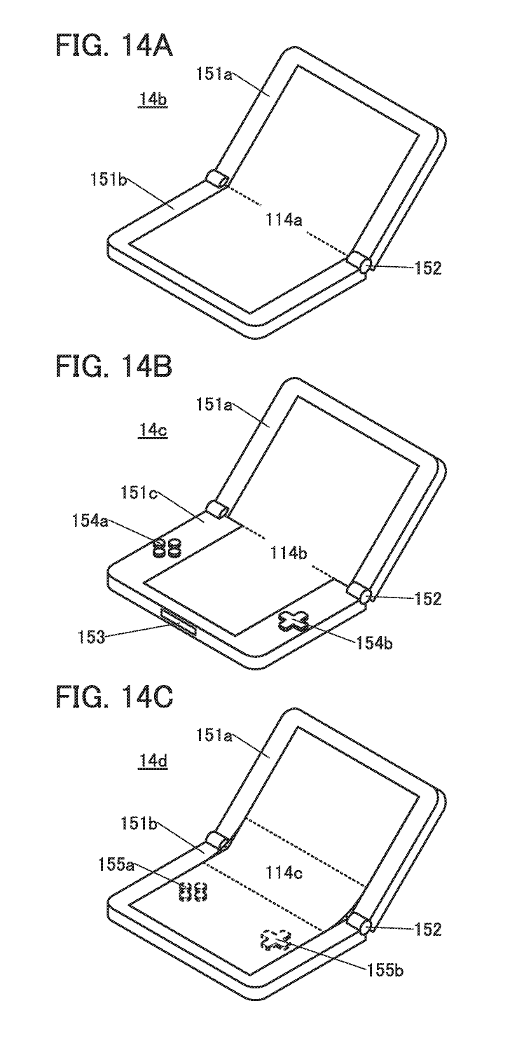

A mobile terminal such as the device 14a can be in various forms. FIGS. 14A to 14C show examples of foldable mobile terminals (devices).

The device 14b in FIG. 14A includes a housing 151a, a housing 151b, a hinge 152, a display unit 114a, and the like. The display unit 114a is fixed to the housing 151a and the housing 151b.

The housing 151a and the housing 151b are rotatably joined to each other with the hinge 152. The device 14b can change its state: i.e., a state in which the housing 151a and the housing 151b are closed (not shown) and a state in which the housing 151a and the housing 151b are opened as shown in FIG. 14A. Thus, the device 14b has high portability when carried and excellent visibility when used because of its large display region. Note that since the display unit 114a is fixed to the housing 151a and the housing 151b as described above, a fold line (a dotted line in FIG. 14A) appears in some cases.

The hinge 152 preferably includes a locking mechanism so that an angle between the housing 151a and the housing 151b does not become larger than a predetermined angle when the housing 151a and the housing 151b are opened. For example, an angle at which they become locked (they are not opened any further) is preferably greater than or equal to 90° and less than 180° and can be typically 90°, 120°, 135°, 150°, or the like. In that case, the convenience, safety, and reliability can be improved.

At least part of the display unit 114 has a function of a touch panel, and can be operated with a finger, a stylus, or the like.

One of the housing 151a and the housing 151b is provided with a wireless communication module, and data can be transmitted and received through a computer network such as the Internet, a local area network (LAN), or Wi-Fi (registered trademark).

FIG. 14B shows the device 14c. The device 14c includes the housing 151a, a housing 151c, a display unit 114b, the hinge 152, operation buttons 154a, an operation button 154b, and the like.

Although the housing 151a and the hinge 152 are the same as those of the device 14b shown in FIG. 14A, a cartridge 153 can be inserted into the housing 151c. The cartridge 153 stores application software such as a game, for example, and a variety of applications can be executed on the device 14c by replacing the cartridge 153.

In the device 14c, the width of the display unit 114b is different between the housing 151a and the housing 151c. Specifically, the width of the display unit 114b of the housing 151c provided with the operation buttons 154a and 154b is smaller than the width of the display unit 114b of the housing 151a. Portions of the display unit 114b can be differently used; for example, a main image is displayed on the display unit 114b of the housing 151a, and an operation image is displayed on the display unit 114b of the housing 151c.

In the device 14d in FIG. 14C, part of a flexible display unit 114c is fixed to the housing 151a and the housing 151b which are joined with the hinge 152. The display unit 114c is not fixed to a connection portion between the housing 151a and the housing 151b and the vicinity thereof. Accordingly, in a state in which the device 14d is opened, the display unit 114c forms a gently curved surface without a fold line. Thus, a continuous image can be displayed on a curved surface.

If necessary, software operation buttons 155a and a software operation button 155b can be displayed on the display unit 114c. Furthermore, other information can be displayed instead of displaying the software operation buttons 155a and the software operation button 155b. Displays can be flexibly changed in accordance with an application mode.

As the display unit 114a to the display unit 114c in FIGS. 14A to 14C, the above-described display unit 114 and/or a display unit 214 described in Embodiment 14 can be used.

### Embodiment 6

In this embodiment, a service that is conducted using the technology described in the above embodiments is described. Specifically, an example in which the technology described in the above embodiments is applied to application software utilizing augmented reality (AR) is described.

AR needs technology or a device for superimposing image data of a real space and image data of a virtual space and displaying the superimposed image. The technology and device described in Embodiment 5 can be applied. The image data of a real space is, for example, image data taken with a camera of a mobile terminal (such as the device 14a). The image data of a virtual space is, for example, image data of an item used on application software.

Specific examples of the item are images of characters and detailed information (text). Examples of a method for obtaining the item include a method of taking an image of a mark in a certain place with a camera of a mobile terminal, a method in which an item that appears when a user reaches a particular place is obtained by a predetermined operation with a mobile terminal while obtaining location information with a GPS of the mobile terminal, and a method of buying an item from an online virtual store. By obtaining a new item, application software becomes more convenient, so that a user can obtain a more convenient service.

An information provider or the like may charge a user who obtains an item for the item. In that case, a method in which a user of a mobile terminal pays the price of the item in addition to the monthly usage amount, a method in which a user pays the price of the item with a credit card, a method in which a user pays the price of the item with a prepaid card, or the like can be employed.

For example, an Internet provider may charge the total amount of the Internet usage fee and the price of the item to a user, and the total amount the user pays may be distributed among the Internet provider, an application software provider, an item provider, an operator of an online virtual store, and the like in accordance with their respective contribution or in a predetermined ratio.

In the case of payment with a credit card, a business method in which the price of the item is added to monthly payment of the user of the mobile terminal to a credit-card company, and the item provider, the operator of an online virtual store, and the like receive their respective fees from the credit-card company is possible.

In the case of payment with a prepaid card, the user of the mobile terminal purchases the prepaid card in advance, and inputs a unique number of the prepaid card or the like when purchasing an item. A business method in which balance of the prepaid card is reduced in this manner is possible. The operator of an online virtual store or the like sells prepaid cards, and the sales of the prepaid cards become an income. In addition, when the user of the mobile terminal purchases an item, a company that sells the prepaid card pays the price of the item to a provider of the item.

For example, in the case where image data of a natural image is assumed as the image data of a real space, image data of a character is assumed as the image data of a virtual space, and these images are superimposed (synthesized), the synthesized image data is probably image data that is not suitable for data compression. Therefore, non-compressed image data or almost non-compressed image data is transmitted from the host to the controller, which might increase power consumption. This hampers the service convenience.

Furthermore, it is important to accurately determine whether a user of a mobile terminal validly obtains an item in order to ensure the equitability of application software, that is, the service reliability. For example, a method that surely prevents a user of a mobile terminal from copying data of an item obtained with another mobile terminal by another user and using the copied data is necessary.

According to the technology described in Embodiment 5, in the display unit 114 of the device 14a, for example, the image data of a virtual space is displayed using the liquid crystal layer 115 and the image data of a real space is displayed using the EL layer 116, whereby the image data can be synthesized and displayed.

In that case, the image data of a real space differs from the image data of a virtual space. The image data of a real space is compressed by the host and then transmitted to the display controller 104, and decompressed by the display controller 104 and then displayed using the EL layer 116. The image data of a virtual space is displayed in the following manner: the device 14a obtains compressed and encrypted data of an item from the server 11 on the Internet, the data is decrypted and decompressed by the display controller 104, and then the image data of a virtual space is displayed using the liquid crystal layer 115.

A procedure for obtaining data of an item is described below. FIG. 2 can be referred to as appropriate. First, a user A selects an item that the user wants to obtain (or wants to purchase). The user A inputs the information into the device 14a. The device 14a transmits a data transmission request for the item and unique information of the device 14a (e.g., a manufacturing number or an individual identification number) to the server 11 (see the step S11 of transmitting a serial number in FIG. 2). The data transmission request includes information that identifies the selected item (e.g., an item identification number).

The server 11 receives the data transmission request and the unique information of the device 14a (see the step S12 of receiving a serial number in FIG. 2). The server 11 determines that the device 14a requests the server 11 to obtain a specific item. Then, the server 11 obtains data of an item (including image data) from the database 12 and compresses image data of the item (see the step S13 of compressing data in FIG. 2).

Here, by compressing the image data of the item, the memory 122a that stores image data of an item in the device 14a can be effectively utilized. In addition, as described in Embodiment 1, encryption of only a header of compressed data can provide an effect comparable to encryption of the whole data, which can reduce a load of arithmetic processing of encryption/decryption. However, compression is not necessarily performed.

The server 11 generates the encryption key Key1 from the unique information of the device 14a using a predesignated algorithm (see the step S14 of generating an encryption key in FIG. 2). Furthermore, the server 11 encrypts image data of the item (compressed data in the case where data has been compressed) using the encryption key Key1 (see the step S15 of encrypting data in FIG. 2).

The server 11 transmits accompanying data that is needed to use the compressed and encrypted data and the item on the application software to the device 14a through the Internet (see the step S16 of transmitting data in FIG. 2).

Here, the accompanying data includes a code that specifies a display layer that displays the item. This code is valid only when, for example, the device 14a includes a plurality of display layers as described in Embodiment 5, and otherwise, the code is ignored. In accordance with the code, the device 14a can determine that received data is stored in the memory 122a or the memory 122b.

Alternatively, the code that specifies the display layer that displays the item may be included in the header of the item, in which case the code may be encrypted at the same time as the encryption of the item.

On the other hand, the device 14a generates the decryption key Key4 that corresponds to the encryption key Key1 that is used for encryption in the server 11, from the unique information of the device 14a using the predesignated algorithm (see the step S17 of generating a decryption key in FIG. 2). Note that the algorithm may be the same as or different from the one used to generate the encryption key Key1. In addition, the encryption key Key1 and the decryption key Key4 may be the same (common key cryptosystem) or different.

The device 14a receives encrypted data transmitted by the server 11 or the like (see the step S18 of receiving data in FIG. 2). The device 14a stores the encrypted data in the memory 122a in accordance with the code that specifies the display layer, for example.

Next, the device 14a reads the encryption data from the memory 122a, decrypts it in the decryption circuit 123 using the decryption key Key4 (see the step S19 of decrypting data in FIG. 2), and thus obtains compressed image data of the item. In the case where only the header is encrypted, a load of decryption can be reduced.

Subsequently, the compressed image data of the item is decompressed in the decompression circuit 124a, whereby image data of the item is generated (see the step S20 of decompressing data in FIG. 2). The image data of the item is subjected to image correction, such as gamma correction, toning, and dimming, in the image processing unit 125. Then, the data of the item is transmitted to the LCD driver 127 in accordance with a timing signal generated by the timing controller 126, and displayed using the liquid crystal layer 115.

Meanwhile, the image data of a real space is temporarily stored in the memory 122b from the host, decompressed in the decompression circuit 124b, and subjected to image correction, such as gamma correction, toning, and dimming, in the image processing unit 125. Then, the image data of a real space is transmitted to the ELD driver 128 in accordance with a timing signal generated by the timing controller 126, and displayed using the EL layer 116.

An item that the device 14a obtains cannot be used on a mobile terminal other than the device 14a. For example, a user of a mobile terminal can be prevented from copying data of an item obtained with another mobile terminal by another user and using the copied data.

The encrypted image data of the item stored in the memory 122a may be read if necessary and decryption and decompression may be performed for each reading. The application software installed on the device 14a is preferably set to be saved in the device 14a in a state where the image data of the item is encrypted, in which case even when the image data is leaked from the device 14a by some attack, the possibility that the image data is used by an unauthorized third party is low.

The above-described operations of the device 14a and the server 11 are executed by computer programs installed on the device 14a and the server 11. Such computer programs have computer-readable instructions corresponding to the above steps. The computer programs are retained in a non-transitory computer-readable memory device.

Note that the device 14a having the structure described in Embodiment 5 has the following advantages. First, the liquid crystal layer 115 and the EL layer 116 are complementary used for display in accordance with environmental light, whereby display quality independent of environmental light can be provided even in the case where application software is used in various environments. Secondly, register data setting (including initialization and changes during operation) can be loaded at once after the data is set in a scan chain register, whereby in the case where IDS driving of the liquid crystal layer 115 is executed, supply of power supply voltage to the display controller 104 and the periphery circuit can be easily stopped during a period in which refreshing of display image is stopped or during a period in which next image data is not transmitted, leading to a reduction in power consumption.

In the above structure, if the decryption key Key4 does not correspond to the encryption key Key1, the compressed image data of the item cannot be decrypted correctly. In other words, the image data of the item can be obtained and the item can be used on the application software only with a mobile terminal (the device 14a in the above example) that requests the server 11 to obtain the item.

Even when a third party who does not request the item (i.e., is not charged for the price of the item) obtains the encrypted and compressed image data of the item on the Internet, the third party cannot decrypt it and cannot use the item on the application software.

As described above, whether the item is obtained validly can be determined accurately without hampering the convenience of the application software, whereby unauthorized use can be inhibited and the service reliability can be increased.

### Embodiment 7

In this embodiment, another example in which the technology described in Embodiments 1 to 5 is applied to application software using AR is described.

As pointed out in Embodiment 6, it is important to accurately determine whether a user of a mobile terminal validly obtains an item in order to ensure the equitability of application software, that is, the service reliability. For example, a method that surely prevents a user from obtaining an item in a place where the user should not obtain it and using the item in a place where the user should not use it is necessary.

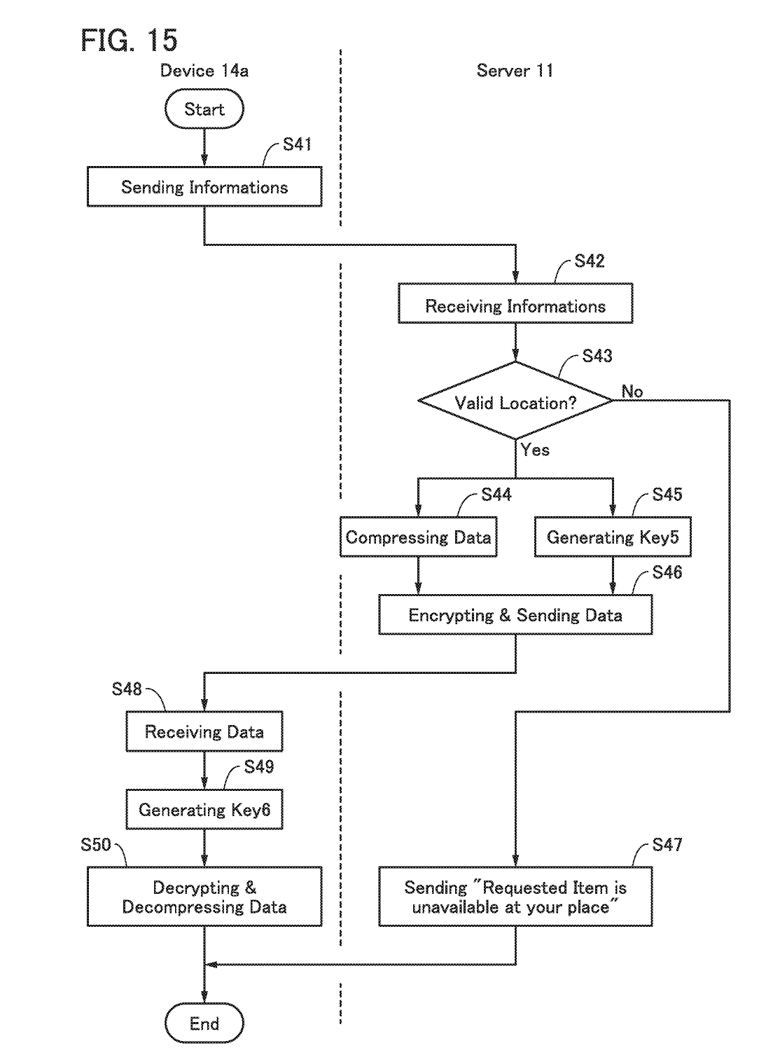

A procedure for obtaining data of an item is described below with reference to FIG. 15. First, a user A selects an item that the user wants to obtain (or wants to purchase). The user A inputs the information into the device 14a. The device 14a transmits a data transmission request for the item, unique information of the device 14a (e.g., a manufacturing number or a serial number (S/N) such as an individual identification number), and location information of the device 14a obtained with a GPS at the time to the server 11 (a step S41 of transmitting information in FIG. 15).

The data transmission request includes information that identifies the selected item (e.g., an item identification number). In addition, the unique information of the device 14a may include the random number described in Embodiment 2 (see the step S31 of generating a random number in FIG. 6).

The information may be encrypted using the encryption key Key3 described in Embodiment 1. In the case where the server 11 retains the encryption key Key1 described in Embodiment 1, the unique information of the device 14a is not necessarily required. The details will be described later.

The location information is, for example, the one acquired using a signal from an artificial satellite, such as GPS, the one determined by a wireless communication base station, the one determined by an IP address, and the one determined by calculation of time and the position of at least one of the sun, stars, planets, and satellites. These have different accuracy and different utilizable conditions, and may be used on the basis of their characteristics.

For example, the location information acquired by a GPS has an accuracy of less than or equal to 10 m, but cannot be used in a place where radio waves of an artificial satellite do not reach, such as an indoor place. The location information determined by a wireless communication base station sometimes has an accuracy of greater than or equal to 1 km, but can identify an approximate position of a place as long as radio waves of wireless communication can be utilized in the place. The location information determined by an IP address has a worse accuracy, but is effective when wireless communication cannot be utilized.

According to these characteristics, for example, the area in which an item can be obtained or an area in which the item can be used is a radius of less than or equal to 10 m from a predetermined point, the location information acquired by a GPS is obtained; in the case of a radius of less than or equal to 10 km from a predetermined point, location information determined by a wireless communication base station is obtained; in the case where the device is used in a particular country, the location information determined by an IP address may be obtained.

The server 11 receives the data transmission request and the unique information and the location information of the device 14a (a step S42 of receiving information in

FIG. 15). In the case where the data is encrypted using the encryption key Key3, the data is decrypted using the corresponding decryption key Key2 (see Embodiment 1). The server 11 determines that the device 14a requests the server 11 to obtain a specific item.

The server 11 verifies whether an item requested can be obtained in a place where the device 14a exists (a step S43 of location verification in FIG. 15). For the verification, the location information transmitted by the device 14a is used.

When it is verified that the item requested can be obtained in the place where the device 14a exists, the server 11 obtains data of the item (including image data) from the database 12 and compresses the image data of the item (a step S44 of compressing data in FIG. 15).

The server 11 generates the encryption key Key5 from the unique information and the location information of the device 14a using a predesignated algorithm (see a step S45 of generating an encryption key in FIG. 15). Here, the encryption key Key5 is different from the encryption key Key1 described in Embodiment 1 in that the encryption key Key5 is generated using the location information of the device 14a.

The encryption key Key5 is generated using the location information of the device 14a. Since the device 14a is not in a fixed place, the location information of the device 14a does not need to be retained for a long time and may be used only once. Furthermore, in the above description, in the case where the unique information of the device 14a is not transmitted in the step S41 of transmitting information, the encryption key Key5 reflects the location information but does not reflect the unique information of the device 14a. Consequently, the server 11 performs encryption using the encryption key Key5 with respect to a mobile terminal whose location is the same as that of the device 14a.

The server 11 encrypts the image data of the item (compressed data in the case where data has been compressed) using the encryption key Key5, and transmits the encrypted data, accompanying data needed to use the item on the application software, and the like to the device 14a through the Internet (a step S46 of encrypting and transmitting data in FIG. 15). The accompanying data and the like may be encrypted using the encryption key Key1. In particular, in the above description, in the case where the unique information of the device 14a is not transmitted in the step S41 of transmitting information, by encryption of the accompanying data and the like using the encryption key Key1, use of the image data of the item with a device other than the device 14a can be prevented or can be made difficult.

Note that when the item requested cannot be obtained in the place where the device 14a exists in the step S43 of location verification, a message “Requested item is unavailable at your place” is transmitted to the device 14a (a step S47 of transmitting failure notice in FIG. 15), and the procedure is completed. Note that the message transmitted in the step S47 of transmitting failure notice may be encrypted using the encryption key Key1 or the encryption key Key5.

The device 14a receives encrypted data transmitted by the server 11 or the like (a step S48 of receiving data in FIG. 15). The device 14a stores the encrypted data in the memory 122a in accordance with the code that specifies the display layer, for example.

In the case where the item is used after this step, the device 14a generates the decryption key Key6 that corresponds to the encryption key Key5 that is used for encryption in the server 11, from the unique information of the device 14a and the location information at the time, using the predesignated algorithm (see a step S49 of generating a decryption key in FIG. 15).

Here, the decryption key Key6 is different from the decryption key Key4 described in Embodiment 1 in that the decryption key Key6 is generated using the location information of the device 14 at the time of using the item. Since the device 14a is not in a fixed place, the location information of the device 14a does not need to be retained for a long time and may be used only once.

Note that the algorithm used in the step S49 of generating a decryption key may be the same as or different from the one used to generate the encryption key Key5. In addition, the encryption key Key5 and the decryption key Key6 may be the same (common key cryptosystem) or different.

In the above description, in the case where the unique information of the device 14a is not transmitted to the server 11 in the step S41 of transmitting information, the decryption key Key6 reflects the location information of the device 14a but does not reflect the unique information of the device 14a. Accordingly, a mobile terminal other than the device 14a can generate the decryption key Key6 as long as the location of the mobile terminal is the same as that of the device 14a.

Next, the device 14a reads the encryption data from the memory 122a using the decryption key Key6, decrypts it in the decryption circuit 123, and decompresses it in the decompression circuit 124a, thereby generating image data of the item (a step S50 of decrypting and decompressing data in FIG. 15). At this time, in the case where part of data received (the accompanying data or the like) is encrypted using the encryption key Key1, it is decrypted using the decryption key Key4.

Here, in the case where the decryption key Key6 reflects only the location information of the device 14a, a mobile terminal other than the device 14a can decrypt encrypted image data of the item as long as the location of the mobile terminal is the same as that of the device 14a. However, since the accompanying data or the like is encrypted using the encryption key Key1 that reflects the unique information of the device 14a, decryption cannot be performed with a mobile terminal other than the device 14a. As a result, use of the image data of the item with a device other than the device 14a is impossible or difficult.

For example, in the case where the server 11 is requested to transmit an item by a plurality of mobile terminals which are in a place where the item can be used, the server 11 may encrypt the item (image data of the item) using an encryption key that reflects only the location information, and may attach the copies to accompanying data encrypted using the respective unique information (i.e., the encryption key Key1) of the mobile terminals. Consequently, a load of the server 11 can be reduced.

The image data of the item is subjected to image correction, such as gamma correction, toning, and dimming, in the image processing unit 125. Then, the data of the item is transmitted to the LCD driver 127 in accordance with a timing signal generated by the timing controller 126, and displayed using the liquid crystal layer 115.

Meanwhile, the image data of a real space is temporarily stored in the memory 122b from the host, decompressed in the decompression circuit 124b, and subjected to image correction, such as gamma correction, toning, and dimming, in the image processing unit 125. Then, the image data of a real space is transmitted to the ELD driver 128 in accordance with a timing signal generated by the timing controller 126, and displayed using the EL layer 116.

Note that, for example, in the case where the location of the device 14a in the step S41 of transmitting information is largely different from the location of the device 14a when the item is used (in the step S49 of generating a decryption key), the location information used for generation of the encryption key Key5 and the location information used for generation of the decryption key Key6 are different; thus, the decryption key Key6 does not correspond to the encryption key Key5. Accordingly, the encrypted data stored in the memory 122a cannot be decrypted using the decryption key Key6.

For example, at the next time when the item is used, the user A who operates the device 14a goes back to a place near the location of the device 14a when the step S41 of transmitting information is executed, the location information used for generation of the encryption key Key5 is substantially equal to the location information used for generation of the decryption key Key6; therefore, the encrypted data stored in the memory 122a can be decrypted using the decryption key Key6.

The item obtained by the device 14a cannot be used on the application software in a place other than the predetermined place, which increases the service reliability. Specifically, whether the item is obtained in a valid place and whether the item is used in a valid place can be determined accurately without hampering the convenience of a user. For example, the above-described technology can be applied to application software for a local mascot, which can be obtained and used in a limited area.

In the above structure, if the decryption key Key6 does not correspond to the encryption key Key5, the compressed image data of the item cannot be decrypted correctly. Alternatively, in the case where the accompanying data is encrypted using the encryption key Key1, it is necessary to use the decryption key Key4 in order to decrypt the data correctly. In other words, the image data of the item can be obtained and the item can be used on the application software only with a mobile terminal (the device 14a in the above example) that requests the server 11 to obtain the item.

### Embodiment 8

In this embodiment, an example in which the server 11 transmits an item that can be used in only a particular place, regardless of places where the item is obtained and purchased, is described. The device 14a does not necessarily transmit its location information to the server 11. Description is made with reference to FIG. 15.

First, a user A selects an item that the user wants to obtain (or wants to purchase). The user A inputs the information into the device 14a. The device 14a transmits a data transmission request for an item to the server 11 (see the step S41 of transmitting information in FIG. 15). The information may be encrypted using the encryption key Key3 described in Embodiment 1.

The server 11 receives the data transmission request (the step S42 of receiving information in FIG. 15). In the case where the received data is encrypted using the encryption key Key3, the data is decrypted using the corresponding decryption key Key2 (see Embodiment 1). The server 11 determines that the device 14a requests the server 11 to obtain a specific item.

The server 11 obtains data of a requested item (including image data) from the database 12 and compresses image data of the item (see the step S44 of compressing data in FIG. 15).

The server 11 generates the encryption key Key5 from the information of location where the item can be used using a predesignated algorithm (see the step S45 of generating an encryption key in FIG. 15).

The server 11 encrypts the image data of the item (compressed data in the case where data has been compressed) using the encryption key Key5, and transmits the encrypted data, accompanying data needed to use the item on the application software, and the like to the device 14a through the Internet (see the step S46 of encrypting and transmitting data in FIG. 15). The accompanying data and the like are encrypted using the encryption key Key1.

In that case, the encryption key Key5 reflects the location information but does not reflect the unique information of the device 14a. Consequently, the server 11 encrypts the item using the encryption key Key5 with respect to a mobile terminal whose location is the same as that of the device 14a. However, by encryption of the accompanying data and the like using the encryption key Key1, use of the image data of the item with a device other than the device 14a can be prevented or can be made difficult.

The device 14a receives encrypted data transmitted by the server 11 or the like (see the step S48 of receiving data in FIG. 15). The device 14a stores the encrypted data in the memory 122a in accordance with the code that specifies the display layer, for example.

In the case where the item is used after this step, the device 14a generates the decryption key Key6 that corresponds to the encryption key Key5 that is used for encryption in the server 11, from the unique information of the device 14a and the location information at the time, using the predesignated algorithm (see a step S49 of generating a decryption key in FIG. 15).

Here, the decryption key Key6 is different from the decryption key Key4 described in Embodiment 1 in that the decryption key Key6 is generated using the location information of the device 14 at the time of using the item. Since the device 14a is not in a fixed place, the location information of the device 14a does not need to be retained for a long time and may be used only once.

Note that the algorithm used in the step S49 of generating a decryption key may be the same as or different from the one used to generate the encryption key Key5. In addition, the encryption key Key5 and the decryption key Key6 may be the same (common key cryptosystem) or different.

In the above description, the decryption key Key6 reflects the location information of the device 14a but does not reflect the unique information of the device 14a. Accordingly, a mobile terminal other than the device 14a can generate the decryption key Key6 as long as the location of the mobile terminal is the same as that of the device 14a.

Next, the device 14a reads the encryption data from the memory 122a using the decryption key Key6, decrypts it in the decryption circuit 123, and decompresses it in the decompression circuit 124a, thereby generating image data of the item (the step S50 of decrypting and decompressing data in FIG. 15). At this time, in the case where part of data received (the accompanying data or the like) is encrypted using the encryption key Key1, it is decrypted using the decryption key Key4.

Here, in the case where the decryption key Key6 reflects only the location information of the device 14a, a mobile terminal other than the device 14a can decrypt encrypted image data of the item as long as the location of the mobile terminal is the same as that of the device 14a. However, since the accompanying data or the like is encrypted using the encryption key Key1 that reflects the unique information of the device 14a, decryption cannot be performed with a mobile terminal other than the device 14a. As a result, use of the image data of the item with a device other than the device 14a is impossible or difficult.

For example, the server 11 prepares in advance image data of the item which is encrypted (compressed) using the encryption key Key5 that reflects only the information of location where the item can be used. In the case where transmission of an item is requested, the server 11 may attach the copies to accompanying data encrypted using the respective unique information (i.e., the encryption key Key1) of the mobile terminals. Consequently, a load of the server 11 can be reduced.

### Embodiment 9

In this embodiment, another example in which the technology described in the above embodiments is applied to application software using AR is described.

As pointed out in Embodiment 6 and Embodiment 7, it is important to accurately determine whether a user of a mobile terminal validly obtains an item in order to ensure the equitability of application software, that is, the service reliability. For example, a method that surely prevents a user from obtaining an item in a time when the user should not obtain it and using the item in a time when the user should not use it is necessary.

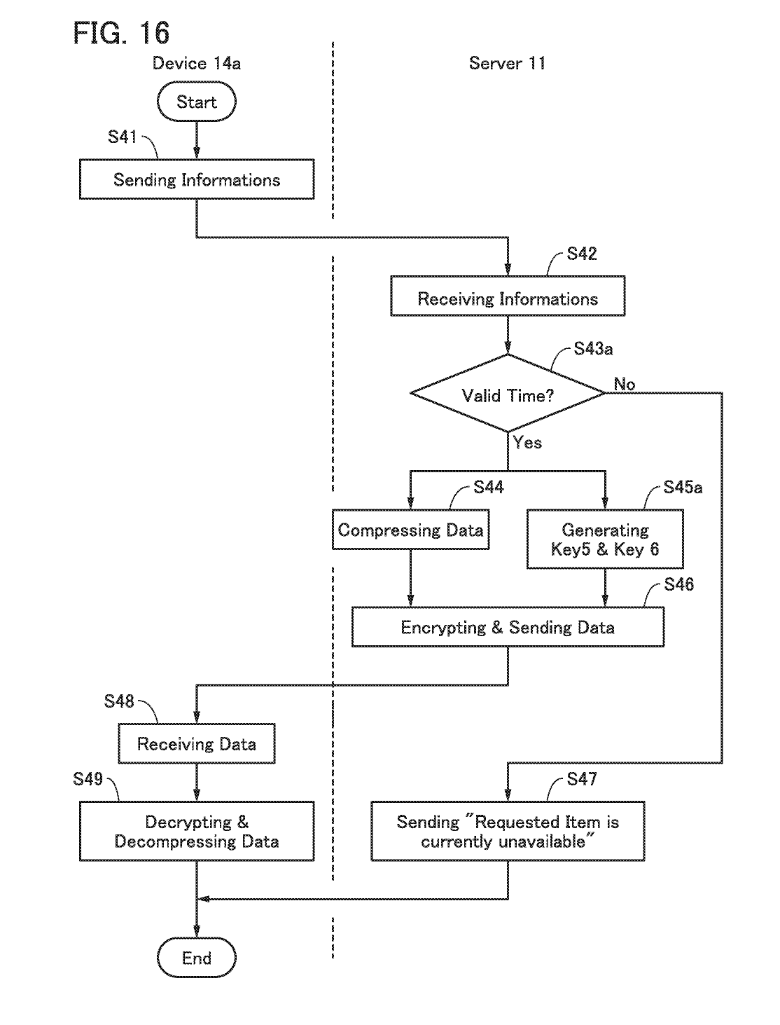

A procedure for obtaining data of an item is described below with reference to FIG. 16. First, a user A selects an item that the user wants to obtain (or wants to purchase). The user A inputs the information into the device 14a. The device 14a transmits a data transmission request for the item, unique information of the device 14a (e.g., a manufacturing number or a serial number (S/N) such as an individual identification number), and time information of the device 14a (when the item is purchased, the time information corresponds to the time of the purchase) to the server 11 (see the step S41 of transmitting information in FIG. 16).

The data transmission request includes information that identifies the selected item (e.g., an item identification number). In addition, the unique information of the device 14a may include the random number described in Embodiment 2 (see the step S31 of generating a random number in FIG. 6).

The information may be encrypted using the encryption key Key3 described in Embodiment 1. In the case where the server 11 retains the encryption key Key1 described in Embodiment 1, the unique information of the device 14a is not necessarily required. The details will be described later.

The server 11 receives the data transmission request and the unique information and the time information of the device 14a (a step S42 of receiving information in FIG. 16). In the case where the received data is encrypted using the encryption key Key3, the data is decrypted using the corresponding decryption key Key2 (see Embodiment 1). The server 11 determines that the device 14a requests the server 11 to obtain a specific item.

The server 11 verifies whether the item requested can be obtained at the time (a step S43a of time verification in FIG. 16). For example, when the item requested is available within a minute from a certain time, the server 11 verifies whether the time includes a time indicated by time information transmitted by the device 14a. At the step, whether the time information is not falsified and whether the time information transmitted by the device 14a is not separated from time information that the server 11 can obtain from Network Time Protocol (NTP) or the like are verified.

When it is verified that the item requested can be obtained at the time when the device 14a requests transmission of the item (or the time when the server 11 receives the request), the server 11 obtains data of the item (including image data) from the database 12 and compresses the image data of the item (the step S44 of compressing data in FIG. 16).

Here, by compressing the image data of the item, the memory 122a that stores image data of an item in the device 14a can be effectively utilized. In addition, as described in Embodiment 1, encryption of only a header of compressed data can provide an effect comparable to encryption of the whole data, which can reduce a load of arithmetic processing of encryption/decryption. However, compression is not necessarily performed.

The server 11 generates the encryption key Key5 and the decryption key Key6 from the unique information and the time information of the device 14a using a predesignated algorithm (a step S45a of generating an encryption key and a decryption key in FIG. 16).

Here, the encryption key Key5 is different from the encryption key Key1 described in Embodiment 1 in that the encryption key Key5 is generated using the time information of the device 14a. The encryption key Key5 is generated using the time information transmitted by the device 14a. Thus, the encryption key Key5 does not need to be retained for a long time and may be used only once. Furthermore, in the above description, in the case where the unique information of the device 14a is not transmitted in the step S41 of transmitting information, the encryption key Key5 reflects the time information but does not reflect the unique information of the device 14a. Consequently, the server 11 generates the same encryption key Key5 encryption with respect to a mobile terminal whose time information is the same as that of the device 14a.

The decryption key Key6 is different from the decryption key Key4 described in Embodiment 1 in that the decryption key Key6 is generated using the time information transmitted by the device 14a. Note that the algorithm used in generating a decryption key may be the same as or different from the one used to generate the encryption key Key5. In addition, the encryption key Key5 and the decryption key Key6 may be the same (common key cryptosystem) or different.

The server 11 encrypts the image data of the item (compressed data in the case where data has been compressed) using the encryption key Key7, and transmits the encrypted data, accompanying data needed to use the item on the application software, and the like to the device 14a through the Internet (the step S46 of encrypting and transmitting data in FIG. 16).

The accompanying data includes the decryption key Key6, data of a date and time when the decryption key Key6 is generated, and hash values thereof. Note that a hash value is a numerical value that is uniquely determined from an original value. Although the hash value can be calculated from the original data easily, it is impossible to restore the hashed value to the original data in an opposite manner.

The accompanying data and the like may be encrypted using the encryption key Key1. In particular, in the above description, in the case where the unique information of the device 14a is not transmitted in the step S41 of transmitting information, encryption of the accompanying data and the like using the encryption key Key1 is effective because use of the image data of the item with a device other than the device 14a can be prevented or can be made difficult.

Here, the accompanying data includes a code that specifies a display layer that displays the item. This code is valid only when, for example, the device 14a includes a plurality of display layers as described in Embodiment 5, and otherwise, the code is ignored. In accordance with the code, the device 14a can determine that received data is stored in the memory 122a or the memory 122b.

Alternatively, the code that specifies the display layer that displays the item may be included in the header of the item, in which case the code may be encrypted at the same time as the encryption of the item.

Note that when the item requested cannot be obtained in the time when it is requested in the step S43a of time verification, a message “Requested item is currently unavailable” is transmitted to the device 14a (the step S47 of transmitting failure notice in FIG. 16), and the procedure is completed. Note that the message transmitted in the step S47 of transmitting failure notice may be encrypted using the encryption key Key1.

Alternatively, the time of the device 14a and the time of the server 11 may be synchronized with use of NTP, and then the server 11 may request the device 14a to transmit information again.

The device 14a receives encrypted data, accompanying data (including a decryption key), or the like transmitted by the server 11 (the step S48 of receiving data in FIG. 16). The device 14a stores the encrypted data in the memory 122a in accordance with the code that specifies the display layer, for example. The decryption key Key6 and other data may be stored in a designated memory. Note that since the decryption key Key6 is generated using the time information, it does not need to be retained for a long time and may be used only once.

Note that the decryption key Key6 may be determined whether it is valid before stored in a memory. Specifically, since the server 11 transmits the decryption key Key6 and the hash value thereof, the device 14a calculates the hash value of the received decryption key Key6 and determines whether the calculated value matches the hash value transmitted from the server 11. When they match, the decryption key Key6 can be assumed to be correct. When they do not match, it is presumed that the decryption key Key6 is falsified in the middle or that the device 14a fails to receive one or both of the decryption key Key6 and the hash value thereof. The same applies to the data of a date and time when the decryption key Key6 is generated. When the date and time when the decryption key Key6 is generated is within a predetermined limit, it is determined that the decryption key Key6 can be used. Note that in this verification, if decryption key Key6 or the date and time when the decryption key Key6 is generated have a problem, the decryption key Key6 is invalid and an item needs to be obtained again.

In the above description, in the case where the unique information of the device 14a is not transmitted to the server 11 in the step S41 of transmitting information, the decryption key Key6 reflects the time information of the device 14a but does not reflect the unique information of the device 14a. Accordingly, a mobile terminal other than the device 14a can receive the same decryption key Key6 as long as the time information that the mobile terminal transmits is the same or almost the same as that of the device 14a.

Next, the device 14a reads the encryption data from the memory 122a using the decryption key Key6, decrypts it in the decryption circuit 123, and decompresses it in the decompression circuit 124a, thereby generating image data of the item (a step S59 of decrypting and decompressing data in FIG. 16). At this time, in the case where part of data received (the accompanying data or the like) is encrypted using the encryption key Key1, it is decrypted using the decryption key Key4.

Although the decryption key Key6 reflects the time information, when a certain time passes from the encryption using the encryption key Key5, the ding key Key5 and the decryption key Key6 do not correspond to each other; as a result, encrypted data cannot be decrypted using the encryption key Key5. In that case, it is necessary to obtain the item again.

Here, in the case where the decryption key Key6 reflects only the time information of the device 14a, a mobile terminal other than the device 14a can receive the same decryption key Key6 and decrypt encrypted image data of the item as long as the time information that the mobile terminal transmits is the same as that of the device 14a. However, since the accompanying data or the like is encrypted using the encryption key Key1 that reflects the unique information of the device 14a, decryption cannot be performed with a mobile terminal other than the device 14a. As a result, use of the image data of the item with a device other than the device 14a is impossible or difficult.

For example, in the case where the server 11 is requested to transmit an item by a plurality of mobile terminals in a time when the item can be used, the server 11 may encrypt the item (image data of the item) using an encryption key that reflects only the time information, and may attach the copies to accompanying data encrypted using the respective unique information of the mobile terminals. Consequently, a load of the server 11 can be reduced.

The device 14a cannot obtain the item in a time other than the predetermined time, which increases the service reliability. Specifically, whether the item is obtained in a valid time can be determined accurately without hampering the convenience of a user. For example, the technology of one embodiment of the present invention can be applied to application software for a limited-time-only mascot, which can be obtained in a limited time.

The method of limiting time for obtaining an item is described above, and furthermore, the place for obtaining an item can also be limited. Specifically, in the step S41 of transmitting information, the location information of the device 14a may also be transmitted to the server 11. The server 11 generates an encryption key and a decryption key which reflect the location information and the time information, encrypts data using it, and transmits the encrypted data to the device 14a. In the device 14a, the encrypted data may be decrypted using the decryption key that reflects the location information and the time information. When the location and the time are valid, decryption succeeds and the device 14a can obtain the item; otherwise, decryption cannot be performed.

### Embodiment 10

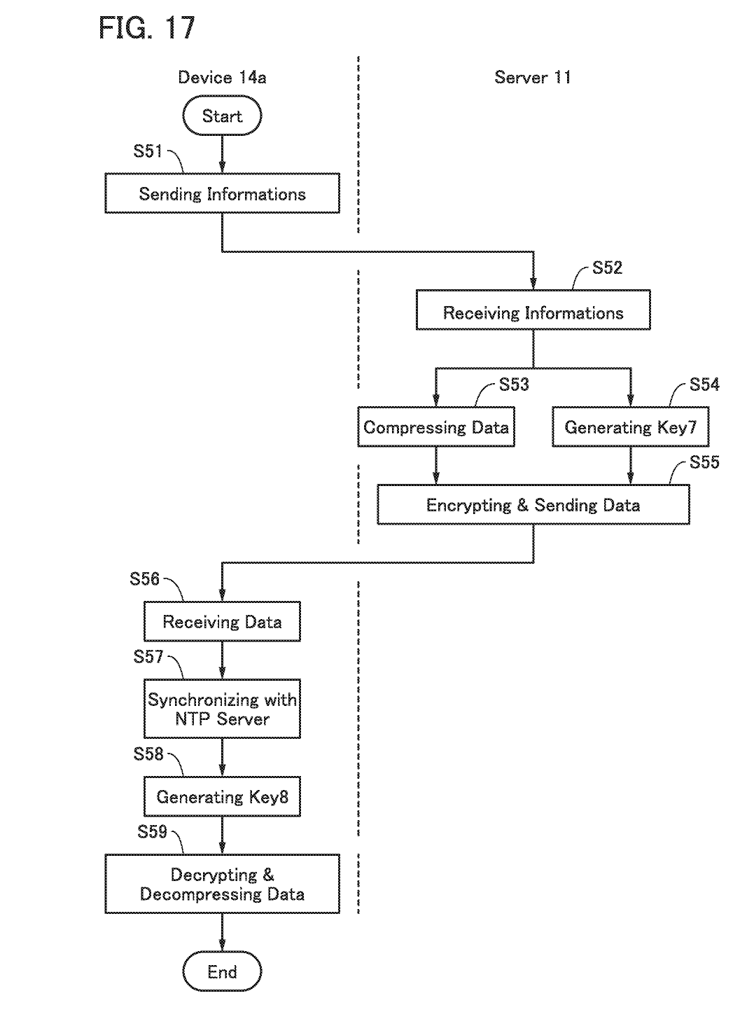

A procedure for obtaining data of an item is described below with reference to FIG. 17. Here, the case in which an item is used in a predetermined future time is described. For example, it is assumed that the item can be used every day from 10:00:00 a.m. to 10:59:59 a.m. The description in Embodiment 9 can be referred to, as appropriate.

First, a user selects an item that the user wants to obtain (or wants to purchase). The user inputs the information into the device 14a. The device 14a transmits a data transmission request for the item to the server 11 (see a step S51 of transmitting information in FIG. 17). Here, the device 14a does not transmit the unique information and the time information, which is different from Embodiment 9.

The server 11 receives the data transmission request and the unique information of the device 14a (a step S52 of receiving information in FIG. 17). The server 11 determines that the device 14a requests the server 11 to obtain a specific item. Then, the server 11 obtains data of an item (including image data) from the database 12 and compresses image data of the item (a step S53 of compressing data in FIG. 17). The server 11 generates the encryption key Key7 on the basis of the time when the item can be used, using a predesignated algorithm (see a step S54 of generating an encryption key in FIG. 17). Here, the encryption key Key7 reflects only time when the item can be used. Therefore, the same encryption key Key7 is used in order to transmit data to a plurality of mobile terminals.

The server 11 encrypts the image data of the item using the encryption key Key7, and transmits the encrypted data, accompanying data needed to use the item on the application software, and the like to the device 14a through the Internet (see a step S55 of encrypting and transmitting data in FIG. 17). The accompanying data and the like are encrypted using the encryption key Key1. As a result, use of the image data of the item with a device other than the device 14a is impossible or difficult.

The device 14a receives encrypted data transmitted by the server 11 or the like (a step S56 of receiving data in FIG. 17). The device 14a stores the received data in the memory 122a in accordance with the code that specifies the display layer, for example.

After that, in the case where the item is used, the application software is operated. The application software synchronizes the device 14a with an NTP server (a step S57 of synchronizing with an NTP server in FIG. 17). Next, the device 14a generates a decryption key Key8 from the time information when the item is used, using a predesignated algorithm (a step S58 of generating a decryption key in FIG. 17). In the case where the time when the decryption key Key8 is generated is a time when the item can be used, the decryption key Key8 corresponds to the encryption key Key7 used for encryption in the server 11, and thus encrypted data can be decrypted.

Next, the device 14a reads the encryption data from the memory 122a using the decryption key Key8, decrypts it in the decryption circuit 123, and decompresses it in the decompression circuit 124a, thereby generating image data of the item (a step S49 of decrypting and decompressing data in FIG. 17). At this time, in the case where part of data received (the accompanying data or the like) is encrypted using the encryption key Key1, it is decrypted using the decryption key Key4.

Consequently, the item obtained by the device 14a cannot be used on the application software in a time other than the predetermined time, which increases the service reliability. Specifically, whether the item is obtained in a valid time can be determined accurately without hampering the convenience of a user. For example, the technology of one embodiment of the present invention can be applied to application software for a limited-time-only local mascot, which can be used in a limited time.

The method of limiting time for using an item is described above, and furthermore, the place for using an item can also be limited. Specifically, in the step S51 of transmitting information, the location information of the device 14a may also be transmitted to the server 11. The server 11 generates the encryption key Key7 which reflects the location information and the time information, encrypts data using it, and transmits the encrypted data to the device 14a. In the device 14a, the decryption key Key8 that reflects the location information and the time information in a time when the item is used may be generated, and the encrypted data may be decrypted using the decryption key Key8. When the location and the time are valid, decryption succeeds and the item can be used on the application software; otherwise, decryption cannot be performed.

### Embodiment 11

In this embodiment, an example in which the technology described in Embodiments 3 to 5 is applied to application software using AR is described.

As pointed out in Embodiments 6 to 9, it is important to accurately determine whether a user of a mobile terminal validly obtains an item in order to ensure the equitability of application software, that is, the service reliability. For example, a method that surely prevents a user of a mobile terminal from copying data of an item obtained with another mobile terminal by another user and using the copied data is necessary.

A procedure for obtaining data of an item is described below. FIG. 7 can be referred to as appropriate. First, after the application software is booted up, the device 14a generates the encryption key Key1 and the decryption key Key4 as described in Embodiment 3 (see the step S14a of generating an encryption key and a decryption key in FIG. 7).

Next, a user A selects an item that the user wants to obtain (or wants to purchase). The user A inputs the information into the device 14a. The device 14a transmits a data transmission request for the item and the encryption key Key1 to the server 11 (the step S14b of transmitting an encryption key and a request in FIG. 7). The data transmission request includes information that identifies the selected item (e.g., an item identification number).

The server 11 receives the data transmission request and the encryption key Key1 (the step S14c of receiving an encryption key and a request in FIG. 7). The server 11 determines that the device 14a requests the server 11 to obtain a specific item. Then, the server 11 obtains data of an item (including image data) from the database 12 and compresses image data of the item (see the step S13 of compressing data in FIG. 7).

Furthermore, the server 11 encrypts image data of the item (compressed data in the case where data has been compressed) using the encryption key Key1 (see the step S15 of encrypting data in FIG. 7).

The server 11 transmits accompanying data that is needed to use the compressed and encrypted data and the item on the application software to the device 14a through the Internet (see the step S16 of transmitting data in FIG. 7).

Here, the accompanying data includes a code that specifies a display layer that displays the item. This code is valid only when, for example, the device 14a includes a plurality of display layers as described in Embodiment 5, and otherwise, the code is ignored. In accordance with the code, the device 14a can determine that received data is stored in the memory 122a or the memory 122b.

Alternatively, the code that specifies the display layer that displays the item may be included in the header of the item, in which case the code may be encrypted at the same time as the encryption of the item.

The device 14a receives encrypted data transmitted by the server 11 or the like (see the step S18 of receiving data in FIG. 7). The device 14a stores the encrypted data in the memory 122a in accordance with the code that specifies the display layer, for example.

Next, the device 14a reads the encryption data from the memory 122a, decrypts it in the decryption circuit 123 using the decryption key Key4 (see the step S19 of decrypting data in FIG. 7), and thus obtains compressed image data of the item. In the case where only the header is encrypted, a load of decryption can be reduced.

Subsequently, the compressed image data of the item is decompressed in the decompression circuit 124a, whereby image data of the item is generated (see the step S20 of decompressing data in FIG. 7). The image data of the item is subjected to image correction, such as gamma correction, toning, and dimming, in the image processing unit 125. Then, the data of the item is transmitted to the LCD driver 127 in accordance with a timing signal generated by the timing controller 126, and displayed using the liquid crystal layer 115.

Meanwhile, the image data of a real space is temporarily stored in the memory 122b from the host, decompressed in the decompression circuit 124b, and subjected to image correction, such as gamma correction, toning, and dimming, in the image processing unit 125. Then, the image data of a real space is transmitted to the ELD driver 128 in accordance with a timing signal generated by the timing controller 126, and displayed using the EL layer 116.

The encrypted image data of the item stored in the memory 122a may be read if necessary and decryption and decompression may be performed for each reading. The application software installed on the device 14a is preferably set to be saved in the device 14a in a state where the image data of the item is encrypted, in which case even when the image data is leaked from the device 14a by some attack, the possibility that the image data is used by an unauthorized third party is low.

The above-described operations of the device 14a and the server 11 are executed by computer programs installed on the device 14a and the server 11. Such computer programs have computer-readable instructions corresponding to the above steps. The computer programs are retained in a non-transitory computer-readable memory device.

Note that the device 14a having the structure described in Embodiment 5 has the following advantages. First, the liquid crystal layer 115 and the EL layer 116 are complementary used for display in accordance with environmental light, whereby display quality independent of environmental light can be provided even in the case where application software is used in various environments. Secondly, register data setting (including initialization and changes during operation) can be loaded at once after the data is set in a scan chain register, whereby in the case where IDS driving of the liquid crystal layer 115 is executed, supply of power supply voltage to the display controller 104 and the periphery circuit can be easily stopped during a period in which refreshing of display image is stopped or during a period in which next image data is not transmitted, leading to a reduction in power consumption.

In the above structure, if the decryption key Key4 does not correspond to the encryption key Key1, the compressed image data of the item cannot be decrypted correctly. In other words, the image data of the item can be obtained and the item can be used on the application software only with a mobile terminal (the device 14a in the above example) that requests the server 11 to obtain the item.

Even when a third party who does not request the item (i.e., is not charged for the price of the item) obtains the encrypted and compressed image data of the item on the Internet, the third party cannot decrypt it and cannot use the item on the application software.

As described above, whether the item is obtained validly can be determined accurately without hampering the convenience of the application software, whereby unauthorized use can be inhibited and the service reliability can be increased.

### Embodiment 12

In this embodiment, a method that surely prevents a user from obtaining an item in a place where the user should not obtain it and using the item in a place where the user should not use it is described with reference to FIG. 15.

A procedure for obtaining data of an item is described below with reference to FIG. 15. First, a user A selects an item that the user wants to obtain (or wants to purchase). The user A inputs the information into the device 14a. The device 14a transmits a data transmission request for the item and location information of the device 14a obtained with a GPS at the time to the server 11 (see the step S41 of transmitting information in FIG. 15). The information may be encrypted using the encryption key Key3 described in Embodiment 1.

The location information is, for example, the one acquired using a signal from an artificial satellite, such as GPS, the one determined by a wireless communication base station, the one determined by an IP address, and the one determined by calculation of time and the position of at least one of the sun, stars, planets, and satellites. These have different accuracy and different utilizable conditions, and may be used on the basis of their characteristics.

For example, the location information acquired by a GPS has an accuracy of less than or equal to 10 m, but cannot be used in a place where radio waves of an artificial satellite do not reach, such as an indoor place. The location information determined by a wireless communication base station sometimes has an accuracy of greater than or equal to 1 km, but can identify an approximate position of a place as long as radio waves of wireless communication can be utilized in the place. The location information determined by an IP address has a worse accuracy, but is effective when wireless communication cannot be utilized.

According to these characteristics, for example, the area in which an item can be obtained or an area in which the item can be used is a radius of less than or equal to 10 m from a predetermined point, the location information acquired by a GPS is obtained; in the case of a radius of less than or equal to 10 km from a predetermined point, location information determined by a wireless communication base station is obtained; in the case where the device is used in a particular country, the location information determined by an IP address may be obtained.

The server 11 receives the data transmission request and the location information of the device 14a (the step S42 of receiving information in FIG. 15). In the case where the received data is encrypted using the encryption key Key3, the data is decrypted using the corresponding decryption key Key2 (see Embodiment 1). The server 11 determines that the device 14a requests the server 11 to obtain a specific item.

The server 11 verifies whether an item requested can be obtained in a place where the device 14a exists (the step S43 of location verification in FIG. 15). For the verification, the location information transmitted by the device 14a is used.

When it is verified that the item requested can be obtained in the place where the device 14a exists, the server 11 obtains data of the item (including image data) from the database 12 and compresses the image data of the item (the step S44 of compressing data in FIG. 15).

The server 11 generates the encryption key Key5 from the location information of the device 14a using a predesignated algorithm (see the step S45 of generating an encryption key in FIG. 15). Since the device 14a is not in a fixed place, the location information of the device 14a does not need to be retained for a long time and may be used only once. The encryption key Key5 reflects the location information but does not reflect the other information. Consequently, the server 11 generates the same encryption key Key5 with respect to a mobile terminal whose location is the same as that of the device 14a.

The server 11 encrypts the image data of the item (compressed data in the case where data has been compressed) using the encryption key Key5, and transmits the encrypted data, accompanying data needed to use the item on the application software, and the like to the device 14a through the Internet (the step S46 of encrypting and transmitting data in FIG. 15). The accompanying data and the like are be encrypted using the encryption key Key1. By encryption of the accompanying data and the like using the encryption key Key1, use of the image data of the item (the data itself is encrypted using the encryption key Key5 and thus can be decrypted with a mobile terminal which exists in the same place as the device 14a.) with a device other than the device 14a can be prevented or can be made difficult.

Note that when the item requested cannot be obtained in the place where the device 14a exists in the step S43 of location verification, a message “Requested item is unavailable at your place” is transmitted to the device 14a (the step S47 of transmitting failure notice in FIG. 15), and the procedure is completed. Note that the message transmitted in the step S47 of transmitting failure notice may be encrypted using the encryption key Key1.

The device 14a receives encrypted data transmitted by the server 11 or the like (the step S48 of receiving data in FIG. 15). The device 14a stores the encrypted data in the memory 122a in accordance with the code that specifies the display layer, for example.

In the case where the item is used after this step, the device 14a generates the decryption key Key6 that corresponds to the encryption key Key5 that is used for encryption in the server 11, from the location information of the device 14a at the time, using the predesignated algorithm (see the step S49 of generating a decryption key in FIG. 15).

Here, the decryption key Key6 is different from the decryption key Key4 described in Embodiment 1 in that the decryption key Key6 is generated using the location information of the device 14 at the time of using the item. Since the device 14a is not in a fixed place, the location information of the device 14a does not need to be retained for a long time and may be used only once.

Note that the algorithm used in the step S49 of generating a decryption key may be the same as or different from the one used to generate the encryption key Key5. In addition, the encryption key Key5 and the decryption key Key6 may be the same (common key cryptosystem) or different.

Next, the device 14a reads the encryption data from the memory 122a using the decryption key Key6, decrypts it in the decryption circuit 123, and decompresses it in the decompression circuit 124a, thereby generating image data of the item (a step S50 of decrypting and decompressing data in FIG. 15). At this time, since part of data received (the accompanying data or the like) is encrypted using the encryption key Key1, it is decrypted using the decryption key Key4.

Here, in the case where the decryption key Key6 reflects only the location information of the device 14a, a mobile terminal other than the device 14a can decrypt encrypted image data of the item as long as the location of the mobile terminal is the same as that of the device 14a. However, since the accompanying data or the like is encrypted using the encryption key Key1 that reflects the unique information of the device 14a, decryption cannot be performed with a mobile terminal other than the device 14a. As a result, use of the image data of the item with a device other than the device 14a is impossible or difficult.

For example, in the case where the server 11 is requested to transmit an item by a plurality of mobile terminals which are in a place where the item can be used, the server 11 may encrypt the item (image data of the item) using an encryption key that reflects only the location information, and may attach the copies to accompanying data encrypted using the respective unique information (i.e., the encryption key Key1) of the mobile terminals. Consequently, a load of the server 11 can be reduced.

Note that, for example, in the case where the location of the device 14a in the step S41 of transmitting information is largely different from the location of the device 14a when the item is used (in the step S49 of generating a decryption key), the location information used for generation of the encryption key Key5 and the location information used for generation of the decryption key Key6 are different; thus, the decryption key Key6 does not correspond to the encryption key Key5. Accordingly, the encrypted data stored in the memory 122a cannot be decrypted using the decryption key Key6.

For example, at the next time when the item is used, the user A who operates the device 14a goes back to a place near the location of the device 14a when the step S41 of transmitting information is executed, the location information used for generation of the encryption key Key5 is substantially equal to the location information used for generation of the decryption key Key6; therefore, the encrypted data stored in the memory 122a can be decrypted using the decryption key Key6.

The item obtained by the device 14a cannot be used on the application software in a place other than the predetermined place, which increases the service reliability. Specifically, whether the item is obtained in a valid place and whether the item is used in a valid place can be determined accurately without hampering the convenience of a user. For example, the technology of one embodiment of the present invention can be applied to application software for a local mascot, which can be obtained and used in a limited area.

### Embodiment 13

A procedure for obtaining data of an item is described below with reference to FIG. 17. Here, the case in which an item is used in a predetermined future time is described. For example, it is assumed that the item can be used every day from 10:00:00 a.m. to 10:59:59 a.m. The description in Embodiments 1 to 12 can be referred to, as appropriate.

First, a user selects an item that the user wants to obtain (or wants to purchase). The user inputs the information into the device 14a. The device 14a transmits a data transmission request for the item to the server 11 (see the step S51 of transmitting information in FIG. 17).

The server 11 receives the data transmission request and the unique information of the device 14a (the step S52 of receiving information in FIG. 17). The server 11 determines that the device 14a requests the server 11 to obtain a specific item. Then, the server 11 obtains data of an item (including image data) from the database 12 and compresses image data of the item (the step S53 of compressing data in FIG. 17). The server 11 generates the encryption key Key7 on the basis of the time when the item can be used, using a predesignated algorithm (see the step S54 of generating an encryption key in FIG. 17). Here, the encryption key Key7 reflects only time when the item can be used. Therefore, the same encryption key Key7 is used in order to transmit data to a plurality of mobile terminals.

The server 11 encrypts the image data of the item using the encryption key Key7, and transmits the encrypted data, accompanying data needed to use the item on the application software, and the like to the device 14a through the Internet (see the step S55 of encrypting and transmitting data in FIG. 17). The accompanying data and the like are encrypted using the encryption key Key1. As a result, use of the image data of the item with a device other than the device 14a is impossible or difficult.

The device 14a receives encrypted data transmitted by the server 11 or the like (the step S56 of receiving data in FIG. 17). The device 14a stores the received data in the memory 122a in accordance with the code that specifies the display layer, for example.

After that, in the case where the user A uses the item, the application software is operated. The application software synchronizes the device 14a with an NTP server (the step S57 of synchronizing with an NTP server in FIG. 17). Next, the device 14a generates a decryption key Key8 from the time information obtained from the NTP server, using a predesignated algorithm (the step S58 of generating a decryption key in FIG. 17). In the case where the time when the decryption key Key8 is generated is a time when the item can be used, the decryption key Key8 corresponds to the encryption key Key7 used for encryption in the server 11, and thus encrypted data can be decrypted.

Next, the device 14a reads the encryption data from the memory 122a using the decryption key Key8, decrypts it in the decryption circuit 123, and decompresses it in the decompression circuit 124a, thereby generating image data of the item (a step S59 of decrypting and decompressing data in FIG. 17). At this time, since part of data received (the accompanying data or the like) is encrypted using the encryption key Key1, it is decrypted using the decryption key Key4.

Consequently, the item obtained by the device 14a cannot be used on the application software in a time other than the predetermined time, which increases the service reliability. Specifically, whether the item is obtained in a valid time can be determined accurately without hampering the convenience of a user. For example, the technology of one embodiment of the present invention can be applied to application software for a limited-time-only local mascot, which can be used in a limited time.

The method of limiting time for using an item is described above, and furthermore, the place for obtaining an item can also be limited. Specifically, in the step S51 of transmitting information, the location information of the device 14a may also be transmitted to the server 11. The server 11 generates the encryption key Key7 which reflects the location information and the time information, encrypts data using it, and transmits the encrypted data to the device 14a. In the device 14a, the decryption key Key8 that reflects the location information and the time information may be generated, and the encrypted data may be decrypted using the decryption key Key8. When the location and the time are valid, decryption succeeds and the item can be obtained and used on the application software; otherwise, decryption cannot be performed.

Similarly, in order to limit the place and time for using the item, the encryption key Key7 that reflects the location information and the time information, which correspond to the position where the item can be used and the time when the item can be used, may be generated in the step S54 of generating an encryption key, data may be encrypted using the encryption key Key7, and the encrypted data may be transmitted to the device 14a. The device 14a generates the decryption key Key8 that reflects the location information and the time information when the device is used. When the decryption key Key8 corresponds to the encryption key Key7, decryption succeeds and the item can be used on the application software; otherwise, decryption cannot be performed.

### Embodiment 14

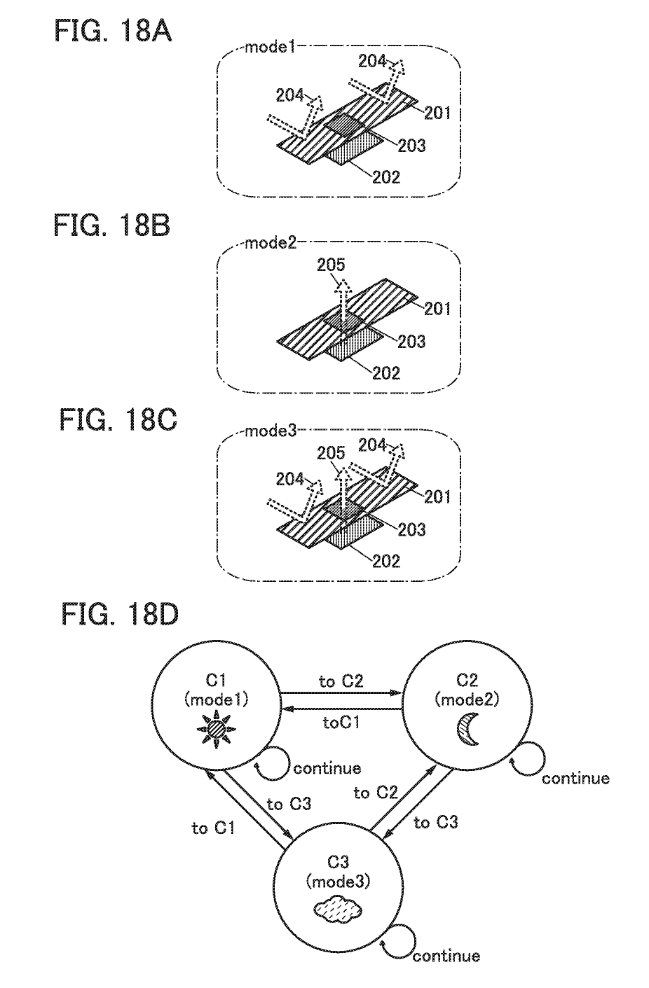

In this embodiment, a display device which can be used as the above-described display unit 114 is described with reference to FIGS. 18A to 18D, FIGS. 19A to 19C, FIG. 20, FIG. 21, FIG. 22, and FIG. 23. The display device of this embodiment includes a first display element reflecting visible light and a second display element emitting visible light.

For example, the display unit 114 includes first display elements arranged in a matrix in the liquid crystal layer 115 or near the liquid crystal layer 115, and includes second display elements arranged in a matrix in the EL layer 116 or near the EL layer 116.

The display device of this embodiment has a function of displaying an image using one or both of light reflected by the first display element and light emitted from the second display element.

As the first display element, an element which displays an image by reflecting environmental light can be used. Such an element does not include a light source and thus power consumption in display can be significantly reduced.

As the first display element, a reflective liquid crystal element can be typically used. As the first display element, other than a microelectromechanical systems (MEMS) shutter element or an optical interference type MEMS element, an element using a microcapsule method, an electrophoretic method, an electrowetting method, or the like can also be used.

As the second display element, a light-emitting element is preferably used. Since the luminance and the chromaticity of light emitted from such a display element are hardly affected by environmental light, a clear image that has high color reproducibility (wide color gamut) and a high contrast can be displayed.

As the second display element, a self-luminous light-emitting element such as an organic light-emitting diode (OLED), a light-emitting diode (LED), a quantum-dot light-emitting diode (QLED), and a semiconductor laser can be used. Note that it is preferable to use, but not limited to, a self-luminous light-emitting element as the second display element; however, a transmissive liquid crystal element combining a light source, such as a backlight or a sidelight, and a liquid crystal element can be used, for example.

The display device of this embodiment has a first mode in which an image is displayed using the first display element, a second mode in which an image is displayed using the second display element, and a third mode in which an image is displayed using both the first display element and the second display element. The display device of this embodiment can be switched between the first mode, the second mode, and the third mode automatically or manually. Details of the first to third modes will be described below.

### First Mode

In the first mode, an image is displayed using the first display element and environmental light. Since a light source is unnecessary in the first mode, power consumed in this mode is extremely low. When sufficient environmental light enters the display device (e.g., in a bright environment), for example, an image can be displayed by using light reflected by the first display element. The first mode is effective in the case where environmental light is white light or light near white light and is sufficiently strong, for example. The first mode is suitable for displaying text. Furthermore, the first mode enables eye-friendly display owing to the use of reflected environmental light, which leads to an effect of easing eyestrain. Note that the first mode may be referred to as reflective display mode (reflection mode) because display is performed using reflected light.

### Second Mode

In the second mode, an image is displayed utilizing light emitted from the second display element. Thus, an extremely vivid image (with high contrast and excellent color reproducibility) can be displayed regardless of the illuminance and the chromaticity of environmental light. The second mode is effective in the case of extremely low illuminance, such as in a night environment or in a dark room, for example. When a bright image is displayed in a dark environment, a user may feel that the image is too bright. To prevent this, an image with reduced luminance is preferably displayed in the second mode. Thus, not only a reduction in the luminance but also low power consumption can be achieved. The second mode is suitable for displaying a vivid (still and moving) image or the like. Note that the second mode may be referred to as emission display mode (emission mode) because display is performed using light emission, that is, emitted light.

### Third Mode

In the third mode, display is performed utilizing both light reflected by the first display element and light emitted from the second display element. Note that display in which the first display element and the second display element are combined can be performed by driving the first display element and the second display element independently from each other during the same period. Note that in this specification and the like, display in which the first display element and the second display element are combined, i.e., the third mode, can be referred to as a hybrid display mode (HB display mode). Alternatively, the third mode may be referred to as a display mode in which an emission display mode and a reflective display mode are combined (ER-Hybrid mode).

By performing display in the third mode, a clearer image than in the first mode can be displayed and power consumption can be lower than in the second mode. For example, the third mode is effective when the illuminance is relatively low such as under indoor illumination or in the morning or evening hours, or when the environmental light does not represent a white chromaticity. With the use of the combination of reflected light and emitted light, an image that makes a viewer feel like looking at a painting can be displayed.

### Specific Example of First to Third Modes

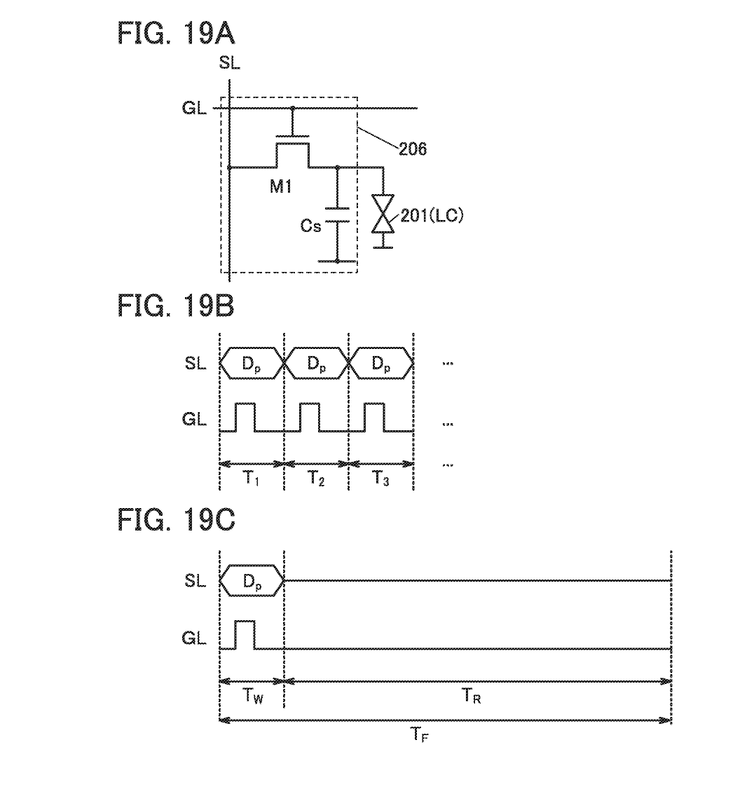

Here, a specific example of the case where the above-described first to third modes are employed is described with reference to FIGS. 18A to 18D and FIGS. 19A to 19C.

Note that the case where the first to third modes are switched automatically depending on the illuminance is described below. In the case where the modes are switched automatically depending on the illuminance, an illuminance sensor or the like is provided in the display device and the display mode can be switched in response to data from the illuminance sensor, for example.

FIGS. 18A to 18C are schematic diagrams of a pixel for describing display modes that are possible for the display device in this embodiment.

In FIGS. 18A to 18C, a first display element 201, a second display element 202, an opening portion 203, reflected light 204 that is reflected by the first display element 201, and transmitted light 205 emitted from the second display element 202 through the opening portion 203 are illustrated. Note that FIG. 18A, FIG. 18B, and FIG. 18C are diagrams illustrating a first mode (mode 1), a second mode (mode 2), and a third mode (mode 3), respectively.

FIGS. 18A to 18C illustrate the case where a reflective liquid crystal element is used as the first display element 201 and a self-luminous OLED is used as the second display element 202.

In the first mode illustrated in FIG. 18A, grayscale display can be performed by driving the reflective liquid crystal element that is the first display element 201 to adjust the intensity of reflected light. For example, as illustrated in FIG. 18A, the intensity of the reflected light 204 reflected by the reflective electrode in the reflective liquid crystal element that is the first display element 201 is adjusted with the liquid crystal layer. In this manner, grayscale can be performed.

In the second mode illustrated in FIG. 18B, grayscale can be expressed by adjusting the emission intensity of the self-luminous OLED that is the second display element 202. Note that light emitted from the second display element 202 passes through the opening portion 203 and is extracted to the outside as the transmitted light 205.

The third mode shown in FIG. 18C is a display mode in which the first mode and the second mode which are described above are combined. For example, as shown in FIG. 18C, grayscale is expressed by adjusting the intensity of the reflected light 204 reflected by the reflective electrode in the reflective liquid crystal element that is the first display element 201, with the liquid crystal layer. In a period during which the first display element 201 is driven, grayscale is expressed by adjusting the intensity of the self-luminous OLED that is the second display element 202, i.e., the intensity of the transmitted light 205.

### State Transition of First to Third Modes

Next, a state transition of the first to third modes is described with reference to FIG. 18D. FIG. 18D is a state transition diagram of the first mode, the second mode, and the third mode. In FIG. 18D, a state C1, a state C2, and a state C3 correspond to the first mode, the second mode, and the third mode, respectively.

As shown in FIG. 18D, any of the display modes can be selected with illuminance in the states C1 to C3. For example, under a high illuminance such as in outdoor environments, the state can be brought into the state C1. In the case where the illuminance decreases as from outdoors to indoors, the state C1 transitions to the state C2. In the case where the illuminance is low even outdoors and grayscale display with reflected light is not sufficient, the state C1 transitions to the state C3. Needless to say, transition from the state C3 to the state C1, transition from the state C2 to the state C3, transition from the state C3 to the state C2, or transition from the state C2 to the state C1 also occurs.

In FIG. 18D, symbols of the sun, the moon, and a cloud are illustrated as images representing the first mode, the second mode, and the third mode, respectively.

As illustrated in FIG. 18D, in the case where the illuminance does not change or slightly changes in the states C1 to C3, the present state may be maintained without transitioning to another state.

The above structure of switching the display mode in accordance with illuminance contributes to a reduction in the frequency of grayscale display with the intensity of light emitted from the light-emitting element, which requires a relatively high power consumption. Accordingly, the power consumption of the display device can be reduced. In the display device, the operation mode can be further switched in accordance with the amount of remaining battery power, the contents to be displayed, or the illuminance of the surrounding environment. Although the case where the display mode is automatically switched with illuminance is described above as an example, one embodiment of the present invention is not limited thereto, and a user may switch the display mode manually.

### <Operation Mode>

Next, an operation mode which can be employed in the first display element is described with reference to FIGS. 19A to 19C.

A normal driving mode (Normal mode) with a normal frame frequency (typically, higher than or equal to 60 Hz and lower than or equal to 240 Hz) and an idling stop (IDS) driving mode with a low frame frequency will be described below.

Note that the idling stop (IDS) driving mode refers to a driving method in which after image data is written, rewriting of image data is stopped. This increases the interval between writing of image data and subsequent writing of image data, thereby reducing the power that would be consumed by writing of image data in that interval. The idling stop (IDS) driving mode can be performed at a frame frequency which is 1/100 to 1/10 of the normal driving mode, for example.

FIGS. 19A to 19C are a circuit diagram and timing charts illustrating the normal driving mode and the idling stop (IDS) driving mode. Note that in FIG. 19A, the first display element 201 (here, a liquid crystal element) and a pixel circuit 206 electrically connected to the first display element 201 are illustrated. In the pixel circuit 206 illustrated in FIG. 19A, a signal line SL, a gate line GL, a transistor M1 connected to the signal line SL and the gate line GL, and a capacitor Cs connected to the transistor M1 are illustrated.

A transistor including a metal oxide in a semiconductor layer is preferably used as the transistor M1. A metal oxide having at least one of an amplification function, a rectification function, and a switching function can be referred to as a metal oxide semiconductor or an oxide semiconductor (abbreviated to an OS). As a typical example of a transistor, a transistor including an oxide semiconductor (OS transistor) is described. The OS transistor has an extremely low leakage current in a non-conduction state (off-state current), so that charge can be retained in a pixel electrode of a liquid crystal element when the OS transistor is turned off

FIG. 19B is a timing chart showing waveforms of signals supplied to the signal line SL and the gate line GL in the normal driving mode. In the normal driving mode, a normal frame frequency (e.g., 60 Hz) is used for operation. In the case where one frame period is divided into a first subframe T₁, a second subframe T₂, and a third subframe T₃, a scanning signal is supplied to the gate line GL in each frame period and data D_{P} is written from the signal line SL. This operation is performed both to write the same data D_{P} in the first subframe T₁ to the third subframe T₃ and to write different data in the first subframe T₁ to the third subframe T₃.

FIG. 19C is a timing chart showing waveforms of signals supplied to the signal line SL and the gate line GL in the idling stop (IDS) driving mode. In the idling stop (IDS) driving, a low frame frequency (e.g., 1 Hz) is used for operation. One frame period is denoted by a period T_{F} and includes a data writing period T_{W} and a data retention period T_{R}. In the idling stop (IDS) driving mode, a scanning signal is supplied to the gate line GL and the data D_{P} of the signal line SL is written in the period T_{W}, the gate line GL is fixed to a low-level voltage in the period T_{RET}, and the transistor M1 is turned off so that the written data D_{P} is retained.

The idling stop (IDS) driving mode is effective in combination with the aforementioned first mode or third mode, in which case power consumption can be further reduced.

As described above, the display device of this embodiment can display an image by switching between the first to third modes. Thus, an all-weather display device or a highly convenient display device with high visibility regardless of the ambient brightness can be fabricated.

The display device of this embodiment preferably includes a plurality of first pixels including first display elements and a plurality of second pixels including second display elements. The first pixels and the second pixels are preferably arranged in matrices.

Each of the first pixels and the second pixels can include one or more sub-pixels. The pixel can include, for example, one sub-pixel (e.g., a white (W) sub-pixel), three sub-pixels (e.g., red (R), green (G), and blue (B) sub-pixels), or four sub-pixels (e.g., red (R), green (G), blue (B), and white (W) sub-pixels, or red (R), green (G), blue (B), and yellow (Y) sub-pixels). Note that color elements included in the first and second pixels are not limited to the above, and may be combined with another color such as cyan (C), magenta (M), or the like as necessary.

The display device of this embodiment can be configured to display a full color image using either the first pixels or the second pixels. Alternatively, the display device of this embodiment can be configured to display a black-and-white image or a grayscale image using the first pixels and can display a full-color image using the second pixels. The first pixels that can be used for displaying a black-and-white image or a grayscale image are suitable for displaying information that need not be displayed in color such as text information.

### <Schematic Perspective View of Display Device>

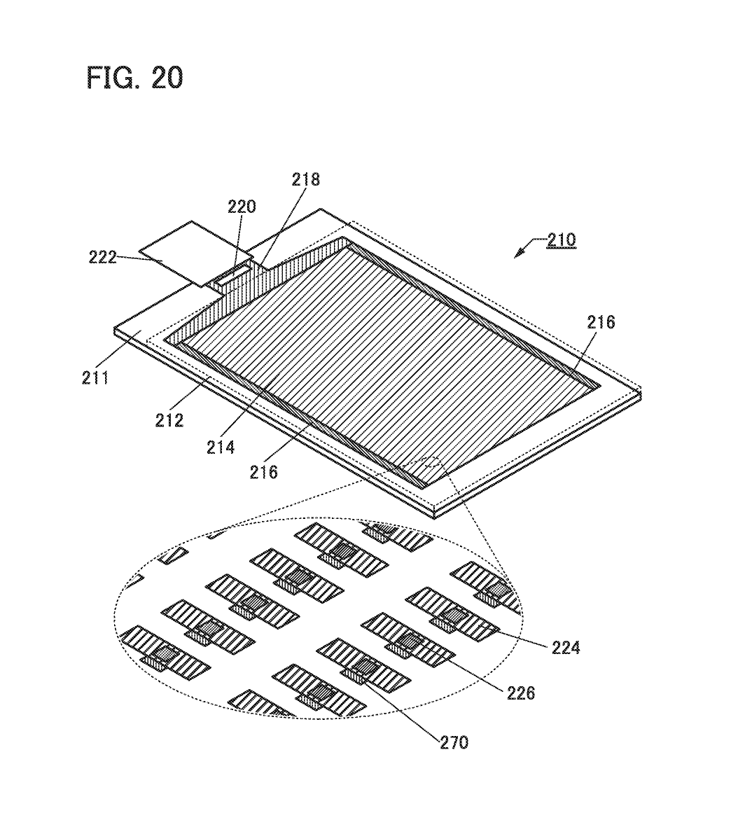

Next, a display device of this embodiment is described with reference to FIG. 20. FIG. 20 is a schematic perspective view of a display device 210. The display device 210 is included in, for example, the device 14a.

In the display device 210, a substrate 211 and a substrate 212 are attached to each other. In FIG. 20, the substrate 212 is denoted by a dashed line.

The display device 210 includes the display unit 214, a circuit 216, a wiring 218, and the like. FIG. 20 illustrates an example in which the display device 210 is provided with an IC 220 and an FPC 222. Thus, the structure illustrated in FIG. 20 can be regarded as a display module including the display device 210, the IC 220, and the FPC 222. The display unit 214 corresponds to the display unit 114 in Embodiment 5.

As the circuit 216, for example, a scan line driver circuit can be used.

The wiring 218 has a function of supplying a signal and power to the display unit 214 and the circuit 216. The signal and the power is input to the wiring 218 from the outside through the FPC 222 or from the IC 220.

FIG. 20 illustrates an example in which the IC 220 is provided over the substrate 211 by a chip on glass (COG) method, a chip on film (COF) method, or the like. An IC including a scan line driver circuit, a signal line driver circuit, or the like can be used as the IC 220, for example. Note that the display device 210 is not necessarily provided with the IC 220. The IC 220 may be mounted on the FPC by a COF method or the like.

FIG. 20 also shows an enlarged view of part of the display unit 214. Electrodes 224 included in a plurality of display elements are arranged in a matrix in the display unit 214. The electrodes 224 have a function of reflecting visible light, and serve as reflective electrodes of a liquid crystal element 250 (described later).

Furthermore, as illustrated in FIG. 20, the electrode 224 includes an opening portion 226. Additionally, the display unit 214 includes a light-emitting element 270 that is positioned closer to the substrate 211 than the electrode 224 is. Light from the light-emitting element 270 is emitted to the substrate 212 side through the opening portion 226 in the electrode 224. The area of a light-emitting region in the light-emitting element 270 may be equal to that of the opening portion 226. One of the area of the light-emitting region in the light-emitting element 270 and the area of the opening portion 226 is preferably larger than the other because a margin for misalignment can be increased.

### Structure Example 1

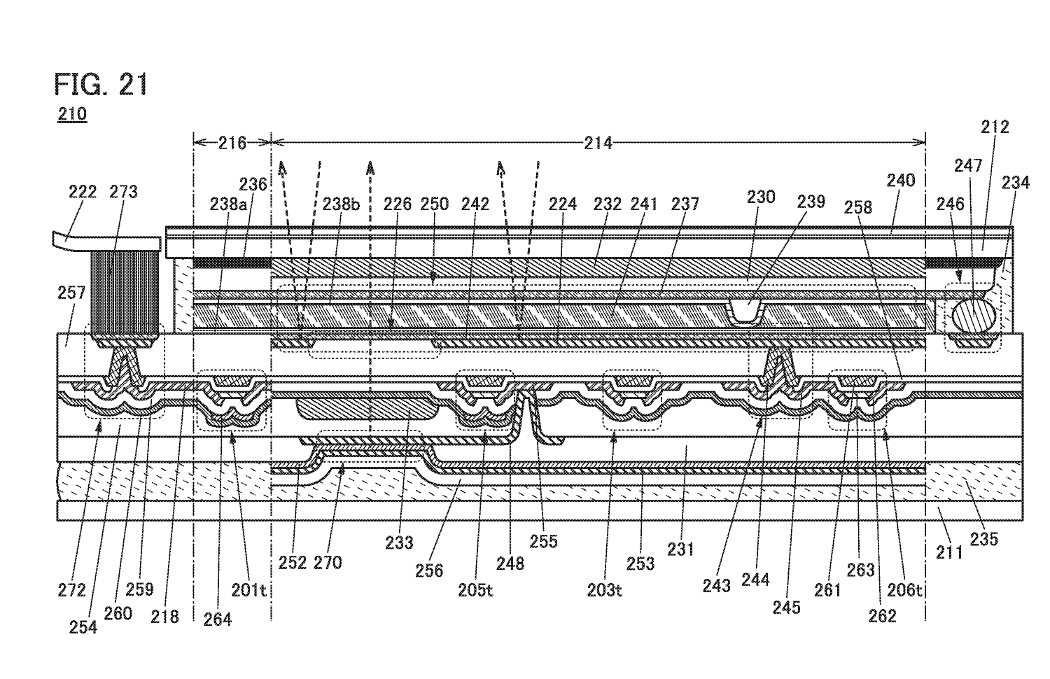

FIG. 21 illustrates an example of cross-sections of part of a region including the FPC 222, part of a region including the circuit 216, and part of a region including the display unit 214 of the display device 210 illustrated in FIG. 20.

The display device 210 illustrated in FIG. 21 includes, between the substrate 211 and the substrate 212, a transistor 201t, a transistor 203t, a transistor 205t, a transistor 206t, the liquid crystal element 250, the light-emitting element 270, an insulating layer 230, an insulating layer 231, a coloring layer 232, a coloring layer 233, and the like. The substrate 212 is bonded to the insulating layer 230 with a bonding layer 234. The substrate 211 is bonded to the insulating layer 231 with a bonding layer 235.

The substrate 212 is provided with the coloring layer 232, a light-blocking layer 236, the insulating layer 230, an electrode 237 functioning as a common electrode of the liquid crystal element 250, an alignment film 238b, an insulating layer 239, and the like. A polarizing plate 240 is provided on an outer surface of the substrate 212. The insulating layer 230 may have a function as a planarization layer. The insulating layer 230 enables the electrode 237 to have an almost flat surface, resulting in a uniform alignment state of a liquid crystal layer 241. The insulating layer 239 serves as a spacer for holding a cell gap of the liquid crystal element 250. In the case where the insulating layer 239 transmits visible light, the insulating layer 239 may be positioned to overlap with a display region of the liquid crystal element 250.

The liquid crystal element 250 is a reflective liquid crystal element. The liquid crystal element 250 has a stacked-layer structure of an electrode 242 functioning as a pixel electrode, the liquid crystal layer 241, and the electrode 237. The electrode 224 that reflects visible light is provided in contact with a surface of the electrode 242 on the substrate 211 side. The electrode 224 includes the opening portion 226. The electrode 242 and the electrode 237 transmit visible light. An alignment film 238a is provided between the liquid crystal layer 241 and the electrode 242. The alignment film 238b is provided between the liquid crystal layer 241 and the electrode 237.

In the liquid crystal element 250, the electrode 224 has a function of reflecting visible light, and the electrode 237 has a function of transmitting visible light. Light entering from the substrate 212 side is polarized by the polarizing plate 240, transmitted through the electrode 237 and the liquid crystal layer 241, and reflected by the electrode 224. Then, the light is transmitted through the liquid crystal layer 241 and the electrode 237 again to reach the polarizing plate 240. In this case, alignment of a liquid crystal can be controlled with a voltage that is applied between the electrode 224 and the electrode 237, and thus optical modulation of light can be controlled. In other words, the intensity of light emitted through the polarizing plate 240 can be controlled. Light excluding light in a particular wavelength region is absorbed by the coloring layer 232, and thus, emitted light is red light, for example.

As illustrated in FIG. 21, the electrode 242 that transmits visible light is preferably provided in the opening portion 226. Accordingly, the liquid crystal layer 241 is aligned in a region overlapping with the opening portion 226 as well as in the other regions, in which case defective alignment of the liquid crystal is prevented from being caused in the boundary portion of these regions and undesired light leakage can be suppressed.

At a connection portion 243, the electrode 224 is electrically connected to a conductive layer 245 included in the transistor 206t via a conductive layer 244. The transistor 206t has a function of controlling the driving of the liquid crystal element 250.

A connection portion 246 is provided in part of a region where the bonding layer 234 is provided. In the connection portion 246, a conductive layer obtained by processing the same conductive film as the electrode 242 is electrically connected to part of the electrode 237 with a connector 247. Accordingly, a signal or a potential input from the FPC 222 connected to the substrate 211 side can be supplied to the electrode 237 formed on the substrate 212 side through the connection portion 246.

As the connector 247, a conductive particle can be used, for example. As the conductive particle, a particle of an organic resin, silica, or the like coated with a metal material can be used. It is preferable to use nickel or gold as the metal material because contact resistance can be decreased. It is also preferable to use a particle coated with layers of two or more kinds of metal materials, such as a particle coated with nickel and further with gold. A material capable of elastic deformation or plastic deformation is preferably used for the connector 247. As illustrated in FIG. 21, the connector 247 which is the conductive particle has a shape that is vertically crushed in some cases. With the crushed shape, the contact area between the connector 247 and a conductive layer electrically connected to the connector 247 can be increased, thereby reducing contact resistance and suppressing the generation of problems such as disconnection.

The connector 247 is preferably provided so as to be covered with the bonding layer 234. For example, the connector 247 is dispersed in the bonding layer 234 before curing of the bonding layer 234.

The light-emitting element 270 is a bottom-emission light-emitting element. The light-emitting element 270 has a stacked-layer structure in which an electrode 248 serving as a pixel electrode, an EL layer 252, and an electrode 253 serving as a common electrode are stacked in this order from the insulating layer 230 side. The electrode 248 is connected to a conductive layer 255 included in the transistor 205t through an opening provided in an insulating layer 254. The transistor 205t has a function of controlling the driving of the light-emitting element 270. The insulating layer 231 covers an end portion of the electrode 248. The electrode 253 includes a material that reflects visible light, and the electrode 248 includes a material that transmits visible light. An insulating layer 256 is provided to cover the electrode 253. Light is emitted from the light-emitting element 270 to the substrate 212 side through the coloring layer 233, the insulating layer 230, the opening portion 226, and the like.

The liquid crystal element 250 and the light-emitting element 270 can exhibit various colors when the color of the coloring layer varies among pixels. The display device 210 can perform color display using the liquid crystal element 250. The display device 210 can perform color display using the light-emitting element 270.

The transistor 201t, the transistor 203t, the transistor 205t, and the transistor 206t are formed on a plane of an insulating layer 257 on the substrate 211 side. These transistors can be fabricated using the same process.

A circuit electrically connected to the liquid crystal element 250 and a circuit electrically connected to the light-emitting element 270 are preferably formed on the same plane. In that case, the thickness of the display device can be smaller than that in the case where the two circuits are formed on different planes. Furthermore, since two transistors can be formed in the same process, a manufacturing process can be simplified as compared to the case where two transistors are formed on different planes.

The pixel electrode of the liquid crystal element 250 is positioned on the opposite side of a gate insulating layer included in the transistor from the pixel electrode of the light-emitting element 270.

The transistor 203t is a transistor for controlling whether the pixel is selected or not (such a transistor is also referred to as a switching transistor or a selection transistor). The transistor 205t is a transistor (also referred to as a driving transistor) for controlling current flowing to the light-emitting element 270. Note that as a material used for a channel formation region in the transistor, a metal oxide is preferably used.

Insulating layers such as an insulating layer 258, an insulating layer 259, an insulating layer 260, and the like are provided on the substrate 211 side of the insulating layer 257. Part of the insulating layer 258 functions as a gate insulating layer of each transistor. The insulating layer 259 is provided to cover the transistor 206t and the like. The insulating layer 260 is provided to cover the transistor 205t and the like. The insulating layer 254 functions as a planarization layer. Note that the number of insulating layers covering the transistor is not limited and may be one or two or more.

A material through which impurities such as water or hydrogen do not easily diffuse is preferably used for at least one of the insulating layers that cover the transistors. This is because such an insulating layer can serve as a barrier film. Such a structure can effectively suppress diffusion of the impurities into the transistors from the outside, and a highly reliable display device can be achieved.

The transistors 201t, 203t, 205t, and 206t include a conductive layer 261 functioning as a gate, the insulating layer 258 functioning as a gate insulating layer, the conductive layer 245 and a conductive layer 262 functioning as a source and a drain, and a semiconductor layer 263. Here, a plurality of layers obtained by processing the same conductive film are shown with the same hatching pattern.

The transistors 201t and 205t each include a conductive layer 264 functioning as a gate in addition to the components of the transistor 203t or 206t.

The structure in which the semiconductor layer where a channel is formed is provided between two gates is used as an example of the transistors 201t and 205t. Such a structure enables the control of the threshold voltage of a transistor. In that case, the two gates may be connected to each other and supplied with the same signal to operate the transistor. Such transistors can have a higher field-effect mobility and thus have higher on-state current than other transistors. Consequently, a circuit capable of high-speed operation can be obtained. Furthermore, the area occupied by a circuit portion can be reduced. The use of the transistor having high on-state current can reduce signal delay in wirings and can reduce display unevenness even in a display device in which the number of wirings is increased because of increase in size or definition.

Alternatively, by supplying a potential for controlling the threshold voltage to one of the two gates and a potential for driving to the other, the threshold voltage of the transistors can be controlled.

Note that the structure of the transistors included in the display device is not limited. The transistor included in the circuit 216 and the transistor included in the display unit 214 may have the same structure or different structures. A plurality of transistors included in the circuit 216 may have the same structure or a combination of two or more kinds of structures. Similarly, a plurality of transistors included in the display unit 214 may have the same structure or a combination of two or more kinds of structures.

A connection portion 272 is provided in a region where the substrates 211 and 212 do not overlap with each other. In the connection portion 272, the wiring 218 is electrically connected to the FPC 222 via a connection layer 273. The connection portion 272 has a similar structure to the connection portion 243. On the top surface of the connection portion 272, a conductive layer obtained by processing the same conductive film as the electrode 242 is exposed. Thus, the connection portion 272 and the FPC 222 can be electrically connected to each other through the connection layer 273.

As the polarizing plate 240 provided on the outer surface of the substrate 212, a linear polarizing plate or a circularly polarizing plate can be used. An example of a circularly polarizing plate is a stack including a linear polarizing plate and a quarter-wave retardation plate. Such a structure can reduce reflection of environmental light. The cell gap, alignment, drive voltage, and the like of the liquid crystal element used as the liquid crystal element 250 are controlled depending on the kind of the polarizing plate so that desirable contrast is obtained.

Note that a variety of optical members can be arranged on the outer surface of the substrate 212. Examples of the optical members include a polarizing plate, a retardation plate, a light diffusion layer (e.g., a diffusion film), an anti-reflective layer, and a light-condensing film. Furthermore, an antistatic film preventing the attachment of dust, a water repellent film suppressing the attachment of stain, a hard coat film suppressing generation of a scratch caused by the use, or the like may be arranged on the outer surface of the substrate 212.

For each of the substrates 211 and 212, glass, quartz, ceramic, sapphire, an organic resin, or the like can be used. When the substrates 211 and 212 are formed using a flexible material, the flexibility of the display device can be increased.

A liquid crystal element having, for example, a vertical alignment (VA) mode can be used as the liquid crystal element 250. Examples of the vertical alignment mode include a multi-domain vertical alignment (MVA) mode, a patterned vertical alignment (PVA) mode, and an advanced super view (ASV) mode.

Liquid crystal elements using a variety of modes can be used as the liquid crystal element 250. For example, a liquid crystal element using, instead of a vertical alignment (VA) mode, a twisted nematic (TN) mode, an in-plane switching (IPS) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, or the like can be used.

The liquid crystal element controls the transmission or non-transmission of light utilizing an optical modulation action of a liquid crystal. The optical modulation action of the liquid crystal is controlled by an electric field (including a horizontal electric field, a vertical electric field, and an oblique electric field) applied to the liquid crystal. As the liquid crystal used for the liquid crystal element, a thermotropic liquid crystal, a low-molecular liquid crystal, a high-molecular liquid crystal, a polymer dispersed liquid crystal (PDLC), a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

As the liquid crystal material, either of a positive liquid crystal and a negative liquid crystal may be used, and an appropriate liquid crystal material can be used depending on the mode or design to be used.

In addition, to control the alignment of the liquid crystal, an alignment film can be provided. In the case where a horizontal electric field mode is employed, a liquid crystal exhibiting a blue phase for which an alignment film is unnecessary may be used. A blue phase is one of liquid crystal phases, which is generated just before a cholesteric phase changes into an isotropic phase while temperature of cholesteric liquid crystal is increased. Since the blue phase appears only in a narrow temperature range, a liquid crystal composition in which a chiral material is mixed to account for several weight percent or more is used for the liquid crystal in order to widen the temperature range. The liquid crystal composition which includes liquid crystal exhibiting a blue phase and a chiral material has a short response time and optical isotropy, which makes the alignment process unneeded. In addition, the liquid crystal composition which includes liquid crystal exhibiting a blue phase and a chiral material has a small viewing angle dependence. An alignment film does not need to be provided and rubbing treatment is thus not necessary; accordingly, electrostatic discharge damage caused by the rubbing treatment can be prevented and defects and damage of the liquid crystal display device in the manufacturing process can be reduced.

In the case where a reflective liquid crystal element is used, the polarizing plate 240 is provided on the display surface side. In addition, a light diffusion plate is preferably provided on the display surface to improve visibility.

A front light may be provided on the outer side of the polarizing plate 240. As the front light, an edge-light front light is preferably used. A front light including a light-emitting diode (LED) is preferably used to reduce power consumption.

### Structure Example 2

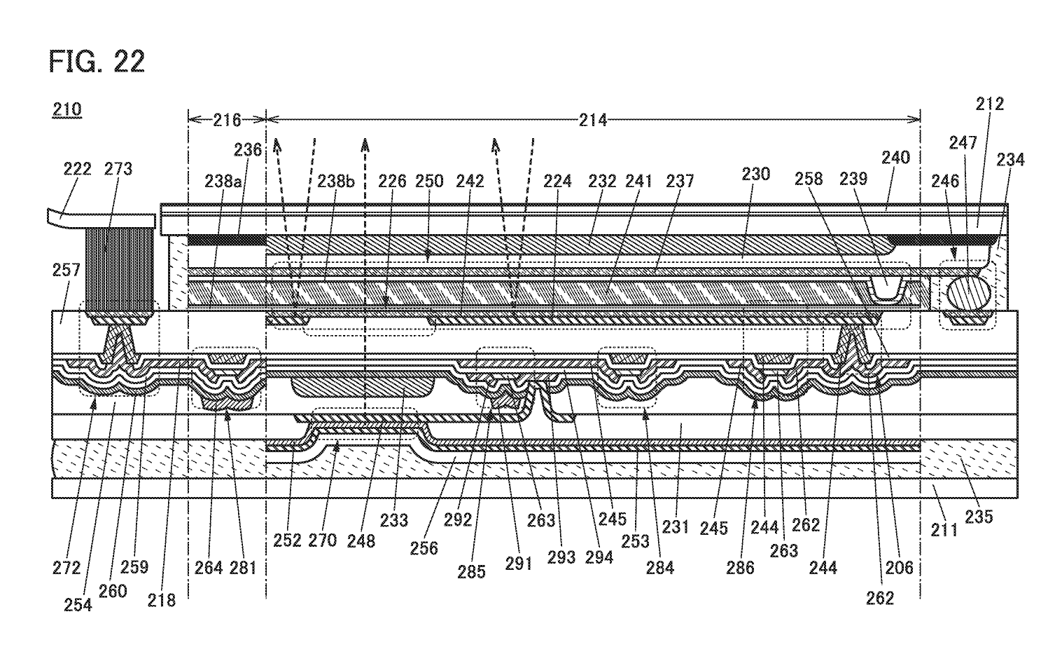

Next, a different mode of the display device 210 shown in FIG. 21 will be described with reference to FIG. 22.

The display device 210 illustrated in FIG. 22 includes a transistor 281, a transistor 284, a transistor 285, and a transistor 286 instead of the transistor 201t, the transistor 203t, the transistor 205t, and the transistor 206t. Components other than the transistors have basically the same structures as those in the display device 210 shown in FIG. 21. However, part of the components have different structures; thus, description of portions which are similar is omitted, while different structures will be described below.

The positions of the insulating layer 239, the connection portion 243, and the like in FIG. 22 are different from those in FIG. 21. The insulating layer 239 is provided so as to overlap with an end portion of the coloring layer 232. Furthermore, the insulating layer 239 is provided so as to overlap with an end portion of the light-blocking layer 236. As in this structure, the insulating layer 239 may be provided in a region not overlapping with a display region (or in a region overlapping with the light-blocking layer 236).

A plurality transistors included in the display device may partly overlap with each other like the transistor 284 and the transistor 285. In that case, the area occupied by a pixel circuit can be reduced, leading to an increase in resolution. Furthermore, the light-emitting area of the light-emitting element 270 can be increased, leading to an improvement in aperture ratio. The light-emitting element 270 with a high aperture ratio requires low current density to obtain necessary luminance; thus, the reliability is improved.

Each of the transistors 281, 284, and 286 includes the conductive layer 244, the insulating layer 258, the semiconductor layer 263, the conductive layer 245, and the conductive layer 262. The conductive layer 244 overlaps with the semiconductor layer 263 with the insulating layer 258 positioned therebetween. The conductive layer 262 is electrically connected to the semiconductor layer 263. The transistor 281 includes the conductive layer 264.

The transistor 285 includes the conductive layer 245, the insulating layer 259, the semiconductor layer 263, a conductive layer 291, the insulating layer 259, the insulating layer 260, a conductive layer 292, and a conductive layer 293. The conductive layer 291 overlaps with the semiconductor layer 263 with an insulating layer 290 and the insulating layer 260 positioned therebetween. The conductive layer 292 and the conductive layer 293 are electrically connected to the semiconductor layer 263.

The conductive layer 245 functions as a gate. An insulating layer 294 functions as a gate insulating layer. The conductive layer 292 functions as one of a source and a drain. The conductive layer 245 included in the transistor 286 functions as the other of the source and the drain.

### Structure Example 3

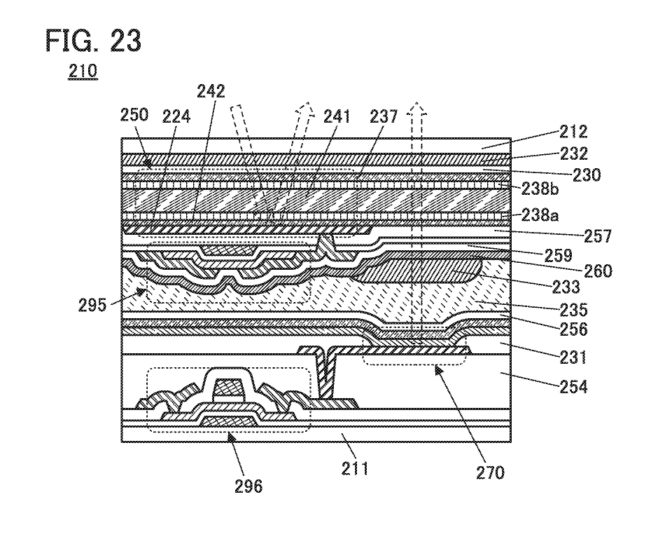

Next, a different mode of the display device 210 shown in FIG. 21 and FIG. 22 will be described with reference to FIG. 23. FIG. 23 is a cross-sectional view of a display unit of the display device 210.

The display device 210 illustrated in FIG. 23 includes, between the substrate 211 and the substrate 212, a transistor 295, a transistor 296, the liquid crystal element 250, the light-emitting element 270, the insulating layer 230, the coloring layer 232, the coloring layer 233, and the like.

In the liquid crystal element 250, the electrode 224 reflects environmental light to the substrate 212 side. The light-emitting element 270 emits light to the substrate 212 side. For the structures of the liquid crystal element 250 and the light-emitting element 270, Structure example 1 can be referred to.

The transistor 295 is covered with the insulating layer 259 and the insulating layer 260. The insulating layer 256 and the coloring layer 233 are bonded to each other with the bonding layer 235.

Furthermore, the transistor 296 has a different structure than the ones in the above-described Structure examples 1 and 2. Specifically, the transistor 296 is a dual-gate transistor. Note that the gate electrode below the transistor 296 may not be provided, and a top gate transistor may be used.

In the display device 210 illustrated in FIG. 23, the transistor 295 for driving the liquid crystal element 250 and the transistor 296 for driving the light-emitting element 270 are formed over different planes; thus, each of the transistors can be easily formed using a structure and a material suitable for driving the corresponding display element.

This application is based on Japanese Patent Application Serial No. 2016-193839 filed with Japan Patent Office on Sep. 30, 2016, Japanese Patent Application Serial No. 2016-193843 filed with Japan Patent Office on Sep. 30, 2016, Japanese Patent Application Serial No. 2016-193849 filed with Japan Patent Office on Sep. 30, 2016, and Japanese Patent Application Serial No. 2016-193850 filed with Japan Patent Office on Sep. 30, 2016, the entire contents of which are hereby incorporated by reference.

What is claimed is:

1. A data transmission method comprising:
generating encrypted data using an encryption key that is generated using unique information of a mobile terminal; and
transmitting the encrypted data to the mobile terminal.

2. The data transmission method according to claim 1,
wherein the mobile terminal comprises a stacked structure of a first display layer and a second display layer,
wherein first data is displayed using one of the first display layer and the second display layer in a first period,
wherein second data is displayed using the other of the first display layer and the second display layer in the first period, and
wherein the first data is generated in such a manner that the encrypted data is decrypted in the mobile terminal, and is different from the second data.

3. The data transmission method according to claim 2,
wherein the encrypted data or data accompanying the encrypted data includes a code for selecting which of the first display layer and the second display layer displays the first data.

4. The data transmission method according to claim 1,
wherein a user of the mobile terminal is charged in accordance with the encrypted data.

5. The data transmission method according to claim 1,
wherein the encryption key is generated in the mobile terminal.

6. The data transmission method according to claim 1,
wherein the mobile terminal comprises a controller, a register unit, a memory, and an image processing unit,
wherein the memory is configured to store image data,
wherein the image processing unit is configured to process the image data,
wherein the register unit is configured to store a parameter for processing in the image processing unit,
wherein the memory is configured to retain the image data while power supply to the memory is stopped,
wherein the register unit is configured to retain the parameter while power supply to the register unit is stopped, and
wherein the controller is configured to control power supply to the register unit, the memory, and the image processing unit.

7. A data transmission method comprising:
generating encrypted data using an encryption key that is generated using location information of a mobile terminal; and
transmitting the encrypted data to the mobile terminal,
wherein the mobile terminal comprises a stacked structure of a first display layer and a second display layer,
wherein first data is displayed using one of the first display layer and the second display layer in a first period,
wherein second data is displayed using the other of the first display layer and the second display layer in the first period, and
wherein the first data is generated in such a manner that the encrypted data is decrypted in the mobile terminal, and is different from the second data.

8. The data transmission method according to claim 7,
wherein the encrypted data or data accompanying the encrypted data includes a code for selecting which of the first display layer and the second display layer displays the first data.

9. The data transmission method according to claim 7,
wherein a user of the mobile terminal is charged in accordance with the encrypted data.

10. The data transmission method according to claim 7,
wherein the mobile terminal comprises a controller, a register unit, a memory, and an image processing unit,
wherein the memory is configured to store image data,
wherein the image processing unit is configured to process the image data,
wherein the register unit is configured to store a parameter for processing in the image processing unit,
wherein the memory is configured to retain the image data while power supply to the memory is stopped,
wherein the register unit is configured to retain the parameter while power supply to the register unit is stopped, and
wherein the controller is configured to control power supply to the register unit, the memory, and the image processing unit.

11. A data transmission method comprising:
generating encrypted data using an encryption key that is generated using time information obtained by a server; and
transmitting the encrypted data to a mobile terminal,
wherein the mobile terminal comprises a stacked structure of a first display layer and a second display layer,
wherein first data is displayed using one of the first display layer and the second display layer in a first period,
wherein second data is displayed using the other of the first display layer and the second display layer in the first period, and
wherein the first data is generated in such a manner that the encrypted data is decrypted in the mobile terminal, and is different from the second data.

12. The data transmission method according to claim 11,
wherein the encrypted data or data accompanying the encrypted data includes a code for selecting which of the first display layer and the second display layer displays the first data.

13. The data transmission method according to claim 11,
wherein a user of the mobile terminal is charged in accordance with the encrypted data.

14. The data transmission method according to claim 11,
wherein the mobile terminal comprises a controller, a register unit, a memory, and an image processing unit,
wherein the memory is configured to store image data,
wherein the image processing unit is configured to process the image data,
wherein the register unit is configured to store a parameter for processing in the image processing unit,
wherein the memory is configured to retain the image data while power supply to the memory is stopped,
wherein the register unit is configured to retain the parameter while power supply to the register unit is stopped, and
wherein the controller is configured to control power supply to the register unit, the memory, and the image processing unit.

15. A data transmission method comprising:
receiving an encryption key from a mobile terminal;
generating encrypted data using the encryption key; and
transmitting the encrypted data to the mobile terminal,
wherein the mobile terminal comprises a stacked structure of a first display layer and a second display layer,
wherein first data is displayed using one of the first display layer and the second display layer in a first period,
wherein second data is displayed using the other of the first display layer and the second display layer in the first period, and
wherein the first data is generated in such a manner that the encrypted data is decrypted in the mobile terminal, and is different from the second data.

16. The data transmission method according to claim 15,
wherein the encryption key reflects unique information of the mobile terminal.

17. The data transmission method according to claim 15,
wherein the encrypted data or data accompanying the encrypted data includes a code for selecting which of the first display layer and the second display layer displays the first data.

18. The data transmission method according to claim 15,
wherein a user of the mobile terminal is charged in accordance with the encrypted data.

19. The data transmission method according to claim 15,
wherein the mobile terminal comprises a controller, a register unit, a memory, and an image processing unit,
wherein the memory is configured to store image data,
wherein the image processing unit is configured to process the image data,
wherein the register unit is configured to store a parameter for processing in the image processing unit,
wherein the memory is configured to retain the image data while power supply to the memory is stopped,
wherein the register unit is configured to retain the parameter while power supply to the register unit is stopped, and
wherein the controller is configured to control power supply to the register unit, the memory, and the image processing unit.
